(19) United States
(12) Patent Application Publication
(10) Pub. No.: US 2024/0284301 A1
(43) Pub. Date: Aug. 22, 2024

(54) SEAMLESS TRANSITIONS FOR EXTENDED PERSONAL AREA NETWORK (XPAN) COVERAGE

(71) Applicant: QUALCOMM Incorporated, San Diego, CA (US)

(72) Inventors: Ahmed Ragab ELSHERIF, San Jose, CA (US); Joel LINSKY, San Diego, CA (US); Srinivas KATAR, Fremont, CA (US); Vincent Knowles JONES, Redwood City, CA (US)

(21) Appl. No.: 18/581,259

(22) Filed: Feb. 19, 2024

Related U.S. Application Data
(60) Provisional application No. 63/486,211, filed on Feb. 21, 2023.

(51) Int. Cl. H04W 40/12; H04W 48/16; H04W 48/20

(52) U.S. Cl. CPC H04W 40/12; H04W 48/16; H04W 48/20

(57) ABSTRACT

Methods, systems, and devices for wireless communications are described. Techniques described herein provide for extending the range of a personal audio device connected to a personal wireless communication device via enabling the personal audio device to connect to and communicate with the personal wireless communication device via an access point (AP). An AP may have a larger range than a personal wireless communication device, and accordingly, an AP may be used to stream audio or voice calls to the personal audio device when the direct link quality between the personal audio device and the personal wireless communication device is below a threshold. To reduce latency and packet loss associated with transitions between communicating with the personal wireless communication device directly and via the AP or transitions between multiple APs, the personal audio device may be configured to establish a new wireless communication connection before breaking a current wireless communication connection.

### CROSS REFERENCE

The present Application for Patent claims the benefit of U.S. Provisional Patent Application No. 63/486,211 by ELSHERIF et al., entitled “SEAMLESS TRANSITIONS FOR EXTENDED PERSONAL AUDIO NETWORK (XPAN) COVERAGE,” filed Feb. 21, 2023, assigned to the assignee hereof, and expressly incorporated by reference herein.

### TECHNICAL FIELD

This disclosure relates generally to wireless communication, and more specifically, to seamless transitions for extended personal area network (XPAN) coverage.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

The described techniques relate to improved methods, systems, devices, or apparatuses that support seamless transitions for extended personal area network (XPAN) coverage. Generally, the described techniques provide for extending the range of a personal audio device connected to a personal wireless communication device such as a handset device via enabling the personal audio device to connect to and communicate with the personal wireless communication device via an access point (AP). An AP may have a larger range than a personal wireless communication device, and accordingly, an AP may be used to stream audio or voice calls to the personal audio device when the direct link quality between the personal audio device and the personal wireless communication device is below a threshold. Communicating between the personal wireless communication device and the personal audio device through an AP increases latency as compared to direct peer to peer (P2P) communications between the wireless device and the personal audio device, and accordingly, the personal audio device may be biased to communicate with the wireless device via a direct XPAN link (such as a P2P wireless communication link) when possible. To reduce latency associated with transitions between communicating with the personal wireless communication device directly and via the AP, before breaking a P2P link with the wireless device, the personal audio device may associate with an AP and receive an internet protocol (IP) address from the AP, which the personal audio device then shares with the personal wireless communication device. Once the personal audio device is connected with the AP, the personal audio device may transmit a disassociation message to the personal wireless communication device, and may communicate with the personal wireless communication device via the connection with the AP. When communicating with a personal wireless communication device via an AP, the personal audio device may transition back to a direct P2P wireless communications link with the wireless device if the personal audio device determines that a link quality of the P2P wireless communication link satisfies a utility function. Additionally, or alternatively, when communicating with a personal wireless communication device via a first AP, the personal audio device may transition to a connection with a second AP, for example based on a link quality of the link with the second AP being stronger than a link quality of the link with the first AP.

A method for wireless communications at a first wireless communication device may include receiving, while in communication with a second wireless communication device on a P2P wireless communication link and from an AP associated with the second wireless communication device, an IP address for the first wireless communication device for a second wireless communication link between the first wireless communication device and the AP, responsive to a first link quality of the P2P wireless communication link falling below a first threshold, communicating a roaming indication with the second wireless communication device on the P2P wireless communication link, and responsive to the roaming indication, communicating data with the second wireless communication device via the second wireless communication link, and the AP.

In some embodiments, a first wireless communication device may include a processing system that includes one or more processors and one or more memories coupled with the one or more processors, the processing system configured to cause the first wireless communication device to receive, while in communication with a second wireless communication device on a P2P wireless communication link and from an AP associated with the second wireless communication device, an IP address for the first wireless communication device for a second wireless communication link between the first wireless communication device and the AP, responsive to a first link quality of the P2P wireless communication link falling below a first threshold, communicating a roaming indication with the second wireless communication device on the P2P wireless communication link, and responsive to the roaming indication, communicating data with the second wireless communication device via the second wireless communication link, and the AP.

In some embodiments, an apparatus for wireless communications at a first wireless communication device may include means for receiving, while in communication with a second wireless communication device on a P2P wireless communication link and from an AP associated with the second wireless communication device, an IP address for the first wireless communication device for a second wireless communication link between the first wireless communication device and the AP, means for responsive to a first link quality of the P2P wireless communication link falling below a first threshold, communicating a roaming indication with the second wireless communication device on the P2P wireless communication link, and means for responsive to the roaming indication, communicating data with the second wireless communication device via the second wireless communication link, and the AP.

In some embodiments, a non-transitory computer-readable medium may store code for wireless communications at a first wireless communication device, and the code may include instructions executable by a processor to receive, while in communication with a second wireless communication device on a P2P wireless communication link and from an AP associated with the second wireless communication device, an IP address for the first wireless communication device for a second wireless communication link between the first wireless communication device and the AP, responsive to a first link quality of the P2P wireless communication link falling below a first threshold, communicating a roaming indication with the second wireless communication device on the P2P wireless communication link, and responsive to the roaming indication, communicating data with the second wireless communication device via the second wireless communication link, and the AP.

Some examples of the method, apparatuses, and non-transitory computer-readable medium described herein may further include operations, features, means, or instructions for, responsive to the first link quality dropping below a second threshold, performing an association procedure with the AP to receive the IP address.

Some examples of the method, apparatuses, and non-transitory computer-readable medium described herein may further include operations, features, means, or instructions for receiving, from the second wireless communication device on the P2P wireless communication link, a message indicating that the first link quality dropped below the second threshold.

Some examples of the method, apparatuses, and non-transitory computer-readable medium described herein may further include operations, features, means, or instructions for receiving, with the message, an indication of a serving AP for the second wireless communication device.

Some examples of the method, apparatuses, and non-transitory computer-readable medium described herein may further include operations, features, means, or instructions for, responsive to the first link quality dropping below the second threshold, transmitting, to the second wireless communication device on the P2P wireless communication link, a request for channel scan results associated with the second wireless communication link, receiving, from the second wireless communication device on the P2P wireless communication link in response to the request, a channel scan result associated with the second wireless communication link, and responsive to the channel scan result indicating a second link quality of the second wireless communication link satisfies a third threshold, performing the association procedure with the AP to receive the IP address.

Some examples of the method, apparatuses, and non-transitory computer-readable medium described herein may further include operations, features, means, or instructions for receiving, from the second wireless communication device on the P2P wireless communication link in response to the request, a set of channel scan results for a set of wireless communication links corresponding to a set of Aps, the set of Aps including the AP and selecting the AP from the set of Aps in response to the set of channel scan results.

Some examples of the method, apparatuses, and non-transitory computer-readable medium described herein may further include operations, features, means, or instructions for, responsive to the first link quality dropping below the second threshold, receiving a beacon from the AP on the second wireless communication link, determining a second link quality of the second wireless communication link using the beacon, and responsive to the second link quality satisfying a third threshold, performing the association procedure with the AP to receive the IP address.

Some examples of the method, apparatuses, and non-transitory computer-readable medium described herein may further include operations, features, means, or instructions for, responsive to the first link quality dropping below the second threshold, transmitting a probe request to the AP, responsive to the probe request, receiving, from the AP, a probe response, determining a second link quality of the second wireless communication link using the probe response, and responsive to the second link quality satisfying a third threshold, performing the association procedure with the AP to receive the IP address.

Some examples of the method, apparatuses, and non-transitory computer-readable medium described herein may further include operations, features, means, or instructions for transmitting an indication of the IP address or a medium access control address of the first wireless communication device to the second wireless communication device on the P2P wireless communication link.

Some examples of the method, apparatuses, and non-transitory computer-readable medium described herein may further include operations, features, means, or instructions for, responsive to the first link quality dropping below the second threshold, transmitting, to a third wireless communication device on a Bluetooth wireless communication link between the first wireless communication device and the third wireless communication device, an indication of the AP.

Some examples of the method, apparatuses, and non-transitory computer-readable medium described herein may further include operations, features, means, or instructions for, communicating, with the second wireless communication device on the P2P wireless communication link, a disassociation message in response to the roaming indication.

Some examples of the method, apparatuses, and non-transitory computer-readable medium described herein may further include operations, features, means, or instructions for determining, in accordance with a utility function, that a second link quality of the second wireless communication link may be better than the first link quality and performing an association procedure with the AP to receive the IP address in response to the determination that the second link quality may be better than the first link quality.

In some examples of the method, apparatuses, and non-transitory computer-readable medium described herein, the utility function includes at least one of a channel type for each of the P2P wireless communication link and the second wireless communication link, a received signal strength indicator value for each of the P2P wireless communication link and the second wireless communication link, and a bias factor for the P2P wireless communication link.

Some examples of the method, apparatuses, and non-transitory computer-readable medium described herein may further include operations, features, means, or instructions for switching a channel of the P2P wireless communication link to a same channel as the second wireless communication link in response to the association procedure.

A method for wireless communications at a second wireless communication device may include receiving, while in communication with a first wireless communication device on a P2P wireless communication link, and while in communication with an AP on a third wireless communication link, an IP address from the first wireless communications device for the first wireless communication device for a second wireless communication link between the first wireless communication device and the AP, responsive to a link quality of the P2P wireless communication link between the first wireless communication device and the second wireless communication device falling below a first threshold, communicating a roaming indication with the first wireless communication device on the P2P wireless communication link, and responsive to the roaming indication, communicating data with the first wireless communication device via the third wireless communication link and the AP using the IP address for the first wireless communication device.

In some embodiments, a second wireless communication device may include a processing system that includes one or more processors and one or more memories coupled with the one or more processors, the processing system configured to cause the second wireless communication device to receive, while in communication with a first wireless communication device on a P2P wireless communication link, and while in communication with an AP on a third wireless communication link, an IP address from the first wireless communications device for the first wireless communication device for a second wireless communication link between the first wireless communication device and the AP, responsive to a link quality of the P2P wireless communication link between the first wireless communication device and the second wireless communication device falling below a first threshold, communicating a roaming indication with the first wireless communication device on the P2P wireless communication link, and responsive to the roaming indication, communicating data with the first wireless communication device via the third wireless communication link and the AP using the IP address for the first wireless communication device.

In some embodiments, an apparatus for wireless communications at a second wireless communication device may include means for receiving, while in communication with a first wireless communication device on a P2P wireless communication link, and while in communication with an AP on a third wireless communication link, an IP address from the first wireless communications device for the first wireless communication device for a second wireless communication link between the first wireless communication device and the AP, means for responsive to a link quality of the P2P wireless communication link between the first wireless communication device and the second wireless communication device falling below a first threshold, communicating a roaming indication with the first wireless communication device on the P2P wireless communication link, and means for responsive to the roaming indication, communicating data with the first wireless communication device via the third wireless communication link and the AP using the IP address for the first wireless communication device.

In some embodiments, a non-transitory computer-readable medium may store code for wireless communications at a second wireless communication device, and the code may include instructions executable by a processor to receive, while in communication with a first wireless communication device on a P2P wireless communication link, and while in communication with an AP on a third wireless communication link, an IP address from the first wireless communications device for the first wireless communication device for a second wireless communication link between the first wireless communication device and the AP, responsive to a link quality of the P2P wireless communication link between the first wireless communication device and the second wireless communication device falling below a first threshold, communicating a roaming indication with the first wireless communication device on the P2P wireless communication link, and responsive to the roaming indication, communicating data with the first wireless communication device via the third wireless communication link and the AP using the IP address for the first wireless communication device.

Some examples of the method, apparatuses, and non-transitory computer-readable medium described herein may further include operations, features, means, or instructions for transmitting, to the first wireless communication device on the P2P wireless communication link, a message indicating that the first link quality dropped below a second threshold, reception of the IP address being responsive to the message.

Some examples of the method, apparatuses, and non-transitory computer-readable medium described herein may further include operations, features, means, or instructions for transmitting, with the message, an indication of a serving AP for the second wireless communication device.

Some examples of the method, apparatuses, and non-transitory computer-readable medium described herein may further include operations, features, means, or instructions for, responsive to the first link quality dropping below a second threshold, receiving, from the first wireless communication device on the P2P wireless communication link, a request for channel scan results associated with the second wireless communication link and transmitting, to the first wireless communication device on the P2P wireless communication link in response to the request, a channel scan result associated with the second wireless communication link, reception of the IP address being responsive to the channel scan result indicating a second link quality of the second wireless communication link satisfies a third threshold.

Some examples of the method, apparatuses, and non-transitory computer-readable medium described herein may further include operations, features, means, or instructions for transmitting, to the first wireless communication device on the P2P wireless communication link in response to the request, a set of channel scan results for a set of wireless communication links corresponding to a set of Aps, the set of Aps including the AP.

Some examples of the method, apparatuses, and non-transitory computer-readable medium described herein may further include operations, features, means, or instructions for, communicating, with the first wireless communication device on the P2P wireless communication link, a disassociation message in response to the roaming indication.

Some examples of the method, apparatuses, and non-transitory computer-readable medium described herein may further include operations, features, means, or instructions for switching a channel of the P2P wireless communication link to a same channel as the second wireless communication link in response reception of the IP address.

In some embodiments, a method for wireless communications at a first wireless communication device may include receiving, while in communication with a second wireless communication device on a P2P wireless communication link and from the second wireless communication device, an indication of an IP address for the first wireless communication device for a second wireless communication link between the first wireless communication device and an AP associated with the second wireless communication device, responsive to a first link quality of the P2P wireless communication link falling below a first threshold, communicating a roaming indication with the second wireless communication device on the P2P wireless communication link, and responsive to the roaming indication, communicating data with the second wireless communication device via the second wireless communication link, and the AP.

In some embodiments, a first wireless communication device may include a processing system that includes one or more processors and one or more memories coupled with the one or more processors, the processing system configured to cause the first wireless communication device to receive, while in communication with a second wireless communication device on a P2P wireless communication link and from the second wireless communication device, an indication of an IP address for the first wireless communication device for a second wireless communication link between the first wireless communication device and an AP associated with the second wireless communication device, responsive to a first link quality of the P2P wireless communication link falling below a first threshold, communicating a roaming indication with the second wireless communication device on the P2P wireless communication link, and responsive to the roaming indication, communicating data with the second wireless communication device via the second wireless communication link, and the AP.

In some embodiments, an apparatus for wireless communications at a first wireless communication device may include means for receiving, while in communication with a second wireless communication device on a P2P wireless communication link and from the second wireless communication device, an indication of an IP address for the first wireless communication device for a second wireless communication link between the first wireless communication device and an AP associated with the second wireless communication device, means for responsive to a first link quality of the P2P wireless communication link falling below a first threshold, communicating a roaming indication with the second wireless communication device on the P2P wireless communication link, and means for responsive to the roaming indication, communicating data with the second wireless communication device via the second wireless communication link, and the AP.

In some embodiments, a non-transitory computer-readable medium may store code for wireless communications at a first wireless communication device, and the code may include instructions executable by a processor to receive, while in communication with a second wireless communication device on a P2P wireless communication link and from the second wireless communication device, an indication of an IP address for the first wireless communication device for a second wireless communication link between the first wireless communication device and an AP associated with the second wireless communication device, responsive to a first link quality of the P2P wireless communication link falling below a first threshold, communicating a roaming indication with the second wireless communication device on the P2P wireless communication link, and responsive to the roaming indication, communicating data with the second wireless communication device via the second wireless communication link, and the AP.

Some examples of the method, apparatuses, and non-transitory computer-readable medium described herein may further include operations, features, means, or instructions for receiving, from the second wireless communication device on the P2P wireless communication link, a message indicating that the first link quality dropped below the second threshold.

Some examples of the method, apparatuses, and non-transitory computer-readable medium described herein may further include operations, features, means, or instructions for receiving, with the message, an indication of a serving AP for the second wireless communication device.

Some examples of the method, apparatuses, and non-transitory computer-readable medium described herein may further include operations, features, means, or instructions for, communicating, with the second wireless communication device on the P2P wireless communication link, a disassociation message in response to the roaming indication.

Some examples of the method, apparatuses, and non-transitory computer-readable medium described herein may further include operations, features, means, or instructions for determining, in accordance with a utility function, that a second link quality of the second wireless communication link may be better than the first link quality, transmission of the roaming indication being responsive to the determination that the second link quality may be better than the first link quality.

In some examples of the method, apparatuses, and non-transitory computer-readable medium described herein, the utility function includes at least one of a channel type for each of the P2P wireless communication link and the second wireless communication link, a received signal strength indicator value for each of the P2P wireless communication link and the second wireless communication link, an a bias factor for the P2P wireless communication link.

In some embodiments, a method for wireless communications at a second device may include performing, while in communication with a first wireless communication device on a P2P wireless communication link, and while in communication with an AP on a third wireless communication link, an association procedure with an AP using a medium access control address for the first wireless communication device to receive an IP address for the first wireless communication device for a second wireless communication link between the first wireless communication device and the AP, transmitting, to the first wireless device on the P2P wireless communication link, the IP address, responsive to a link quality of a P2P wireless communication link between the first wireless communication device and the second wireless communication device falling below a first threshold, communicating a roaming indication with the first wireless communication device on the P2P wireless communication link, and responsive to the roaming indication, communicating data with the first wireless communication device via the third wireless communication link and the AP using the IP address for the first wireless communication device.

In some embodiments, a second wireless communication device may include a processing system that includes one or more processors and one or more memories coupled with the one or more processors, the processing system configured to cause the second wireless communication device to perform, while in communication with a first wireless communication device on a P2P wireless communication link, and while in communication with an AP on a third wireless communication link, an association procedure with an AP using a medium access control address for the first wireless communication device to receive an IP address for the first wireless communication device for a second wireless communication link between the first wireless communication device and the AP, transmit, to the first wireless device on the P2P wireless communication link, the IP address, responsive to a link quality of a P2P wireless communication link between the first wireless communication device and the second wireless communication device falling below a first threshold, communicating a roaming indication with the first wireless communication device on the P2P wireless communication link, and responsive to the roaming indication, communicating data with the first wireless communication device via the third wireless communication link and the AP using the IP address for the first wireless communication device.

In some embodiments, an apparatus for wireless communications at a second wireless communication device may include means for performing, while in communication with a first wireless communication device on a P2P wireless communication link, and while in communication with an AP on a third wireless communication link, an association procedure with an AP using a medium access control address for the first wireless communication device to receive an IP address for the first wireless communication device for a second wireless communication link between the first wireless communication device and the AP, means for transmitting, to the first wireless device on the P2P wireless communication link, the IP address, means for responsive to a link quality of a P2P wireless communication link between the first wireless communication device and the second wireless communication device falling below a first threshold, communicating a roaming indication with the first wireless communication device on the P2P wireless communication link, and means for responsive to the roaming indication, communicating data with the first wireless communication device via the third wireless communication link and the AP using the IP address for the first wireless communication device.

In some embodiments, a non-transitory computer-readable medium may store code for wireless communications at a second wireless communication device, and the code may include instructions executable by a processor to perform, while in communication with a first wireless communication device on a P2P wireless communication link, and while in communication with an AP on a third wireless communication link, an association procedure with an AP using a medium access control address for the first wireless communication device to receive an IP address for the first wireless communication device for a second wireless communication link between the first wireless communication device and the AP, transmit, to the first wireless device on the P2P wireless communication link, the IP address, responsive to a link quality of a P2P wireless communication link between the first wireless communication device and the second wireless communication device falling below a first threshold, communicating a roaming indication with the first wireless communication device on the P2P wireless communication link, and responsive to the roaming indication, communicating data with the first wireless communication device via the third wireless communication link and the AP using the IP address for the first wireless communication device.

Some examples of the method, apparatuses, and non-transitory computer-readable medium described herein may further include operations, features, means, or instructions for transmitting, to the first wireless communication device on the P2P wireless communication link, a message indicating that the first link quality dropped below the second threshold.

Some examples of the method, apparatuses, and non-transitory computer-readable medium described herein may further include operations, features, means, or instructions for transmitting, with the message, an indication of a serving AP for the second wireless communication device.

Some examples of the method, apparatuses, and non-transitory computer-readable medium described herein may further include operations, features, means, or instructions for, communicating, with the first wireless communication device on the P2P wireless communication link, a disassociation message in response to the roaming indication.

In some embodiments, a method for wireless communications at a first wireless communication device may include receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link, responsive to a first link quality of the P2P wireless communication link satisfying a first threshold, the first link quality detected using the beacon or the probe response, performing an association procedure with the second wireless communication device for the P2P wireless communication link, transmitting, in response to the association procedure, a disassociation message to the AP for the second wireless communication link, and communicating data with the second wireless communication device on the P2P wireless communication link.

In some embodiments, a first wireless communication device may include a processing system that includes one or more processors and one or more memories coupled with the one or more processors, the processing system configured to cause the first wireless communication device to receive, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link, responsive to a first link quality of the P2P wireless communication link satisfying a first threshold, the first link quality detected using the beacon or the probe response, performing an association procedure with the second wireless communication device for the P2P wireless communication link, transmit, in response to the association procedure, a disassociation message to the AP for the second wireless communication link, and communicate data with the second wireless communication device on the P2P wireless communication link.

In some embodiments, an apparatus for wireless communications at a first wireless communication device may include means for receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link, means for responsive to a first link quality of the P2P wireless communication link satisfying a first threshold, the first link quality detected using the beacon or the probe response, performing an association procedure with the second wireless communication device for the P2P wireless communication link, means for transmitting, in response to the association procedure, a disassociation message to the AP for the second wireless communication link, and means for communicating data with the second wireless communication device on the P2P wireless communication link.

In some embodiments, a non-transitory computer-readable medium may store code for wireless communications at a first wireless communication device, and code may include instructions executable by a processor to receive, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link, responsive to a first link quality of the P2P wireless communication link satisfying a first threshold, the first link quality detected using the beacon or the probe response, performing an association procedure with the second wireless communication device for the P2P wireless communication link, transmit, in response to the association procedure, a disassociation message to the AP for the second wireless communication link, and communicate data with the second wireless communication device on the P2P wireless communication link.

Some examples of the method, apparatuses, and non-transitory computer-readable medium described herein may further include operations, features, means, or instructions for, responsive to a second link quality of the second wireless communication link falling below a second threshold, monitoring for the beacon on the P2P wireless communication link.

Some examples of the method, apparatuses, and non-transitory computer-readable medium described herein may further include operations, features, means, or instructions for, responsive to a second link quality of the second wireless communication link falling below a second threshold, transmitting via the second wireless communication link and the AP, a probe request, reception of the probe response being responsive to the probe request.

Some examples of the method, apparatuses, and non-transitory computer-readable medium described herein may further include operations, features, means, or instructions for, periodically monitoring for beacons from the second wireless communication device while in communication with the second wireless communication device via the second wireless communication link and via the AP and the third wireless communication link, reception of the beacon responsive to the periodic monitoring.

Some examples of the method, apparatuses, and non-transitory computer-readable medium described herein may further include operations, features, means, or instructions for, responsive to a second link quality of the second wireless communication link falling below a second threshold, transmitting, to the second wireless communication device via the second wireless communication link and the AP, an indication that the second link quality may have dropped below the second threshold and receiving, from the second wireless communication device via the AP and the second wireless communication link in response to the indication, scheduling information for the beacon, reception of the beacon being in accordance with the scheduling information.

Some examples of the method, apparatuses, and non-transitory computer-readable medium described herein may further include operations, features, means, or instructions for, responsive to a second link quality of the second wireless communication link falling below a second threshold, and further responsive to a determination that the second wireless communication device may be within range of a Bluetooth wireless communication link between the first wireless communication device and the second wireless communication device, transmitting, to the second wireless communication device and on the Bluetooth wireless communication link, a request to connect with the second wireless communication device and receiving, from the second wireless communication device on the Bluetooth wireless communication link, scheduling information for the beacon, reception of the beacon being in accordance with the scheduling information.

Some examples of the method, apparatuses, and non-transitory computer-readable medium described herein may further include operations, features, means, or instructions for, responsive to a second link quality of the second wireless communication link falling below a second threshold, and further responsive to a determination that the second wireless communication device may be within range of a Bluetooth wireless communication link between the first wireless communication device and the second wireless communication device, transmitting, to the second wireless communication device and on the second wireless communication link, a probe request, reception of the probe response being responsive to the probe request.

In some examples of the method, apparatuses, and non-transitory computer-readable medium described herein, the first link quality of the P2P wireless communication link satisfying the first threshold may include operations, features, means, or instructions for determining, in accordance with a utility function, that the first link quality may be better than a second link quality of the second wireless communication link.

In some examples of the method, apparatuses, and non-transitory computer-readable medium described herein, the utility function includes at least one of a channel type for each of the P2P wireless communication link and the second wireless communication link, a received signal strength indicator value for each of the P2P wireless communication link and the second wireless communication link, and a bias factor for the P2P wireless communication link.

In some examples of the method, apparatuses, and non-transitory computer-readable medium described herein, transmitting the disassociation message may include operations, features, means, or instructions for transmitting the disassociation message in response to a second link quality of the second wireless communication link falling below a second threshold.

Some examples of the method, apparatuses, and non-transitory computer-readable medium described herein may further include operations, features, means, or instructions for, responsive to the first link quality satisfying the first threshold, transmitting, to a third wireless communication device on a Bluetooth wireless communication link between the first wireless communication device and the third wireless communication device, an indication for the third wireless communication device to perform a second association procedure with the second wireless communication device.

In some embodiments, a method for wireless communications at a second wireless communication device may include transmitting, while in communication with a first wireless communication device via a third wireless communication link between the second wireless communication device and an AP and via the AP and a second wireless communication link between the first wireless communication device and the AP, a beacon or a probe response on a P2P wireless communication link, responsive to a link quality of the P2P wireless communication link satisfying a threshold, performing an association procedure with the first wireless communication device for the P2P wireless communication link, and communicating data with the first wireless communication device on the P2P wireless communication link.

In some embodiments, a second wireless communication device may include a processing system that includes one or more processors and one or more memories coupled with the one or more processors, the processing system configured to cause the second wireless communication device to transmit, while in communication with a first wireless communication device via a third wireless communication link between the second wireless communication device and an AP and via the AP and a second wireless communication link between the first wireless communication device and the AP, a beacon or a probe response on a P2P wireless communication link, responsive to a link quality of the P2P wireless communication link satisfying a threshold, performing an association procedure with the first wireless communication device for the P2P wireless communication link, and communicate data with the first wireless communication device on the P2P wireless communication link.

In some embodiments, an apparatus for wireless communications at a second wireless communication device may include means for transmitting, while in communication with a first wireless communication device via a third wireless communication link between the second wireless communication device and an AP and via the AP and a second wireless communication link between the first wireless communication device and the AP, a beacon or a probe response on a P2P wireless communication link, means for responsive to a link quality of the P2P wireless communication link satisfying a threshold, performing an association procedure with the first wireless communication device for the P2P wireless communication link, and means for communicating data with the first wireless communication device on the P2P wireless communication link.

In some embodiments, a non-transitory computer-readable medium may store code for wireless communications at a second wireless communication device, and the code may include instructions executable by a processor to transmit, while in communication with a first wireless communication device via a third wireless communication link between the second wireless communication device and an AP and via the AP and a second wireless communication link between the first wireless communication device and the AP, a beacon or a probe response on a P2P wireless communication link, responsive to a link quality of the P2P wireless communication link satisfying a threshold, performing an association procedure with the first wireless communication device for the P2P wireless communication link, and communicate data with the first wireless communication device on the P2P wireless communication link.

Some examples of the method, apparatuses, and non-transitory computer-readable medium described herein may further include operations, features, means, or instructions for, responsive to a second link quality of the second wireless communication link falling below a second threshold, receiving, from the first wireless communication device via the second wireless communication link and the AP, an indication that the second link quality may have dropped below the second threshold and transmitting, to the first wireless communication device via the AP and the second wireless communication link in response to the indication, scheduling information for the beacon, transmission of the beacon being in accordance with the scheduling information.

Some examples of the method, apparatuses, and non-transitory computer-readable medium described herein may further include operations, features, means, or instructions for, responsive to a second link quality of the second wireless communication link falling below a second threshold, receiving, via the second wireless communication link and the AP, a probe request, transmission of the probe response being responsive to the probe request.

Some examples of the method, apparatuses, and non-transitory computer-readable medium described herein may further include operations, features, means, or instructions for, responsive to a second link quality of the second wireless communication link falling below a second threshold, and further responsive to a determination that the second wireless communication device may be within range of a Bluetooth wireless communication link between the first wireless communication device and the second wireless communication device, receiving, from the first wireless communication device and on the Bluetooth wireless communication link, a request to connect with the second wireless communication device and transmitting, to the first wireless communication device on the Bluetooth wireless communication link, scheduling information for the beacon, transmission of the beacon being in accordance with the scheduling information.

Some examples of the method, apparatuses, and non-transitory computer-readable medium described herein may further include operations, features, means, or instructions for, responsive to a second link quality of the second wireless communication link falling below a second threshold, and further responsive to a determination that the second wireless communication device may be within range of a Bluetooth wireless communication link between the first wireless communication device and the second wireless communication device, receiving, from the first wireless communication device and on the second wireless communication link, a probe request, transmission of the probe response being responsive to the probe request.

In some embodiments, a method for wireless communications at a first wireless communication device may include responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link, responsive to a second link quality of the second wireless communication link being higher than the first link quality, performing an association procedure with the second AP to receive an IP address for the first wireless communication device for the second wireless communication link, transmitting, in response to the association procedure and to the second wireless communication device, an indication of the IP address via the first wireless communication link and the first AP, transmitting, in response to transmission of the IP address, a disassociation message to the first AP for the first wireless communication link, and responsive to transmission of the disassociation IP message, communicating data with the second wireless communication device via the second wireless communication link, and the second AP.

In some embodiments, a first wireless communication device may include a processing system that includes one or more processors and one or more memories coupled with the one or more processors, the processing system configured to cause the first wireless communication device to cause the apparatus to responsive to a first link quality of a first wireless communication link between the first wireless communication device and a first AP fall below a threshold while in communication with a second wireless communication device via the first wireless communication link and the first AP, receiving a beacon or a probe response from a second AP on a second wireless communication link, responsive to a second link quality of the second wireless communication link be higher than the first link quality, performing an association procedure with the second AP to receive an IP address for the first wireless communication device for the second wireless communication link, transmit, in response to the association procedure and to the second wireless communication device, an indication of the IP address via the first wireless communication link and the first AP, transmit, in response to transmission of the IP address, a disassociation message to the first AP for the first wireless communication link, and responsive to transmission of the disassociation IP message, communicate data with the second wireless communication device via the second wireless communication link, and the second AP.

In some embodiments, an apparatus for wireless communications at a first wireless communication device may include means for responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link, means for responsive to a second link quality of the second wireless communication link being higher than the first link quality, performing an association procedure with the second AP to receive an IP address for the first wireless communication device for the second wireless communication link, means for transmitting, in response to the association procedure and to the second wireless communication device, an indication of the IP address via the first wireless communication link and the first AP, means for transmitting, in response to transmission of the IP address, a disassociation message to the first AP for the first wireless communication link, and means for responsive to transmission of the disassociation IP message, communicating data with the second wireless communication device via the second wireless communication link, and the second AP.

In some embodiments, a non-transitory computer-readable medium may store code for wireless communications at a first wireless communication device, and the code may include instructions executable by a processor to responsive to a first link quality of a first wireless communication link between the first wireless communication device and a first AP fall below a threshold while in communication with a second wireless communication device via the first wireless communication link and the first AP, receiving a beacon or a probe response from a second AP on a second wireless communication link, responsive to a second link quality of the second wireless communication link be higher than the first link quality, performing an association procedure with the second AP to receive an IP address for the first wireless communication device for the second wireless communication link, transmit, in response to the association procedure and to the second wireless communication device, an indication of the IP address via the first wireless communication link and the first AP, transmit, in response to transmission of the IP address, a disassociation message to the first AP for the first wireless communication link, and responsive to transmission of the disassociation IP message, communicate data with the second wireless communication device via the second wireless communication link, and the second AP.

In some examples of the method, apparatuses, and non-transitory computer-readable medium described herein, receiving the beacon may include operations, features, means, or instructions for receiving a set of beacons from a set of Aps, the set of Aps including the second AP and the set of beacons including the beacon.

Some examples of the method, apparatuses, and non-transitory computer-readable medium described herein may further include operations, features, means, or instructions for selecting the second AP from the set of Aps based on respective link qualities for respective wireless communication links with the set of Aps determined using the set of beacons.

Some examples of the method, apparatuses, and non-transitory computer-readable medium described herein may further include operations, features, means, or instructions for, responsive to the first link quality of the first wireless communication link falling below the threshold, transmitting a probe request to the second AP, reception of the probe response being responsive to the probe request.

Some examples of the method, apparatuses, and non-transitory computer-readable medium described herein may further include operations, features, means, or instructions for, responsive to the first link quality falling below the threshold, receiving a second beacon from the second wireless communication device on a third wireless communication link, receiving the beacon being responsive to a third link quality of a wireless communication link between the first wireless communication device and the second wireless communication device determined using the second beacon being below a third threshold.

Some examples of the method, apparatuses, and non-transitory computer-readable medium described herein may further include operations, features, means, or instructions for performing the association procedure in response to a determination that the second link quality of the second wireless communication link may be higher than the first link quality and the third link quality in accordance with a utility function.

In some examples of the method, apparatuses, and non-transitory computer-readable medium described herein, the utility function includes at least one of a channel type for each of the first wireless communication link and the second wireless communication link and a received signal strength indicator value for each of the first wireless communication link and the second wireless communication link.

Some examples of the method, apparatuses, and non-transitory computer-readable medium described herein may further include operations, features, means, or instructions for, responsive to the second link quality of the second wireless communication link being higher than the first link quality, transmitting, to a third wireless communication device on a Bluetooth wireless communication link between the first wireless communication device and the third wireless communication device, an indication for the third wireless communication device to perform a second association procedure with the second AP.

In some embodiments, a method for wireless communications at a second wireless communication device may include receiving, while in communication with a first wireless communication device via a first AP and a first wireless communication link between the first wireless communication device and the first AP and using a first IP address for the first wireless communication device for the first wireless communication link, an indication of a second IP address for the first wireless communication device for a second wireless communication link between the first wireless communication device and a second AP, the indication of the second IP address being received via the first AP and the first wireless communication link, receiving, from the first wireless device via the first AP and the first wireless communication link, a roaming indication, and responsive to the roaming indication, communicating data with the first wireless communication device via the second wireless communication link and the second AP using the second IP address.

In some embodiments, a second wireless communication device may include a processing system that includes one or more processors and one or more memories coupled with the one or more processors, the processing system configured to cause the second wireless communication device to receive, while in communication with a first wireless communication device via a first AP and a first wireless communication link between the first wireless communication device and the first AP and using a first IP address for the first wireless communication device for the first wireless communication link, an indication of a second IP address for the first wireless communication device for a second wireless communication link between the first wireless communication device and a second AP, the indication of the second IP address being received via the first AP and the first wireless communication link, receive, from the first wireless device via the first AP and the first wireless communication link, a roaming indication, and responsive to the roaming indication, communicating data with the first wireless communication device via the second wireless communication link and the second AP using the second IP address.

In some embodiments, an apparatus for wireless communications at a second wireless communication device may include means for receiving, while in communication with a first wireless communication device via a first AP and a first wireless communication link between the first wireless communication device and the first AP and using a first IP address for the first wireless communication device for the first wireless communication link, an indication of a second IP address for the first wireless communication device for a second wireless communication link between the first wireless communication device and a second AP, the indication of the second IP address being received via the first AP and the first wireless communication link, means for receiving, from the first wireless device via the first AP and the first wireless communication link, a roaming indication, and means for responsive to the roaming indication, communicating data with the first wireless communication device via the second wireless communication link and the second AP using the second IP address.

In some embodiments, a non-transitory computer-readable medium may store code for wireless communications at a second wireless communication device, and the code may include instructions executable by a processor to receive, while in communication with a first wireless communication device via a first AP and a first wireless communication link between the first wireless communication device and the first AP and using a first IP address for the first wireless communication device for the first wireless communication link, an indication of a second IP address for the first wireless communication device for a second wireless communication link between the first wireless communication device and a second AP, the indication of the second IP address being received via the first AP and the first wireless communication link, receive, from the first wireless device via the first AP and the first wireless communication link, a roaming indication, and responsive to the roaming indication, communicating data with the first wireless communication device via the second wireless communication link and the second AP using the second IP address.

Some examples of the method, apparatuses, and non-transitory computer-readable medium described herein may further include operations, features, means, or instructions for receiving, from the first wireless device via the first AP and the first wireless communication link, an indication of a medium access control address for the first wireless communication device for the second wireless communication link, communication of data with the first wireless communication device via the second wireless communication link and the second AP further using the medium access control address.

Some examples of the method, apparatuses, and non-transitory computer-readable medium described herein may further include operations, features, means, or instructions for transmitting, to the first wireless device via the first AP and the first wireless communication link, an acknowledgment in response to the roaming indication, communication of data with the first wireless communication device via the second wireless communication link and the second AP being responsive to the acknowledgment.

Some examples of the method, apparatuses, and non-transitory computer-readable medium described herein may further include operations, features, means, or instructions for adjusting at least one of an audio latency or an audio bit rate in response to the roaming indication, communication of data with the first wireless communication device via the second wireless communication link and the second AP using the adjusted audio latency or the adjusted audio bit rate.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIGS. 2a, 2b, 2c, and 2d illustrate examples of extended personal area network (XPAN) scenarios that that include a personal wireless communication device, an access point (AP), an application server, and personal audio devices.

FIG. 3 illustrates an example of a transition in an XPAN scenario between a peer to peer (P2P) wireless connection and a personal audio device-AP connection.

FIG. 4 illustrates an example of a transition in an XPAN scenario between a personal audio device-AP connection and a P2P wireless connection.

FIG. 5 illustrates an example of a transition in an XPAN scenario between a personal audio device-first AP connection and a personal audio device-second AP connection.

FIG. 6 illustrates an example of an XPAN scenario where the personal audio device is within range of the personal wireless communication device but outside of the range of the AP serving the personal wireless communication device.

FIG. 7 illustrates an example of an XPAN scenario where the personal audio device is within the 2.4G range of the personal wireless communication device but outside the 5G/6G range of the personal wireless communication device.

FIG. 8 illustrates an example of an XPAN scenario where the personal wireless communication device is connected to a cellular base station, and the personal audio device is within range of the personal wireless communication device.

FIG. 9a illustrates an example of an XPAN scenario where the personal audio device is within the 5G/6G range of the AP but outside the 2.4G range of the personal wireless communication device.

FIG. 9b illustrates an example of an XPAN scenario where the personal audio device is within the 2.4 G range of the AP but outside the 2.4G range of the personal wireless communication device 2 and the 5G/6G range of the AP.

FIG. 10 illustrates an example of an XPAN scenario where the personal audio device is within the 2.4G range of the personal wireless communication device but outside of the 5G/6G range of the personal wireless communication device.

FIG. 11a illustrates an example of an XPAN scenario where a personal wireless communication device relays audio data through a same basic service set (BSS) to the personal audio device.

FIG. 11b illustrates an example of an XPAN scenario where a personal wireless communication device relays audio data (such as a voice call or an offline stream) through an extended service set (ESS) to the personal audio device, where the personal wireless communication device and the personal audio device are in a same L2/L3 network.

FIG. 12 illustrates an example of an XPAN scenario where a personal wireless communication device relays audio data through a ESS to the personal audio device where the personal wireless communication device and the personal audio device are in different L2/L3 networks.

FIG. 13 illustrates an example of a transition in an XPAN scenario between a P2P wireless connection and a personal audio device-AP connection.

FIG. 14 illustrates an example of a process flow of a transition in an XPAN scenario between a P2P wireless connection and a personal audio device-AP connection.

FIG. 15 illustrates an example of a process flow of a transition in an XPAN scenario between a P2P wireless connection at a first time and a personal audio device-AP connection, where the personal wireless communication device assists in the initiation of the transition.

FIG. 16 illustrates an example of a transition in an XPAN scenario between a P2P wireless connection and a personal audio device-AP connection where the personal wireless communication device performs an association procedure with the AP for the personal audio device.

FIG. 17 illustrates an example of a process flow of a transition in an XPAN scenario between a P2P wireless connection and a personal audio device-AP connection where the personal wireless communication device performs an association procedure with the for the personal audio device.

FIG. 18 illustrates an example of a transition in an XPAN scenario between a personal audio device-AP connection and a P2P wireless connection.

FIG. 19 illustrates an example of a process flow of a transition in an XPAN scenario between a personal audio device-AP connection and a P2P wireless connection.

FIG. 20 illustrates an example of a transition in an XPAN scenario between a personal audio device-first AP connection and a personal audio device-second AP connection.

FIG. 21 illustrates an example of a process flow of a transition in an XPAN scenario between a personal audio device-first AP connection and a personal audio device-second AP connection.

FIGS. 22 and 23 illustrate block diagrams of devices that may support seamless transitions for XPAN coverage.

FIG. 24 illustrates a block diagram of a communications manager that may support seamless transitions for XPAN coverage.

FIG. 25 illustrates a diagram of a system including a device that may supports seamless transitions for XPAN coverage.

FIGS. 26 through 33 illustrate flowcharts showing methods that support seamless transitions for XPAN coverage.

FIG. 34 illustrates an example of a process flow of a transition in an XPAN scenario between a P2P wireless connection and a personal audio device-AP connection.

FIG. 35 illustrates an example of a process flow of a transition in an XPAN scenario between a P2P wireless connection at a first time and a personal audio device-AP connection, where the personal wireless communication device assists in the initiation of the transition.

FIG. 36 illustrates an example of a process flow of a transition in an XPAN scenario between a P2P wireless connection and a personal audio device-AP connection where the personal wireless communication device performs an association procedure with the for the personal audio device.

FIG. 37 illustrates an example of a process flow of a transition in an XPAN scenario between a personal audio device-AP connection and a P2P wireless connection.

FIG. 38 illustrates an example of a process flow of a transition in an XPAN scenario between a personal audio device-first AP connection and a personal audio device-second AP connection.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or Fifth Generation (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

A wireless communication device, such as a station (STA) in a wireless local area network (WLAN), may communicate with an access point (AP) via a channel, such as a 2.4 gigahertz (GHz) (also referred to as 2 GHz), 5 GHz, or 6 GHz wireless communication link. The wireless communication device may also communicate with wireless communication devices such as personal audio devices, in an extended personal area network (XPAN) via peer to peer (P2P) wireless communication links, such as 2.4 GHz, 5 GHz or 6 GHz wireless communication links. For example, a personal wireless communication device such as a handset or desktop computer may communicate with a personal audio device such as earbuds or a headset. A personal audio device may also be an STA. The communication links of the XPAN may be 2.4 GHz, 5 GHz, or 6 GHz wireless communication links for reduced latency and/or high throughput applications, such as streaming audio for gaming applications, music, or voice calls.

In XPAN, audio is streamed from a personal wireless communication device to a personal audio device(s) using a Wi-Fi link (such as a 2.4 GHz, 5 GHz or 6 GHz wireless communication links) between the personal wireless communication device and the personal audio device while the personal wireless communication device is in communication with an AP over an infra Wi-Fi link. The physical range of the XPAN Wi-Fi link between the personal wireless communication device and the personal audio device(s) may be limited, and accordingly, the link quality may deteriorate, which may affect the audio streaming quality, if the user of the personal audio device moves away from the personal wireless communication device.

The range of a personal audio device connected to a personal wireless communication device may be extended via enabling the personal audio device to connect to and communicate with the personal wireless communication device via an AP. An AP may have a larger range than a personal wireless communication device, and accordingly, an AP may be used to stream audio to the personal audio device when the direct P2P link quality between the personal audio device and the personal wireless communication device is below a threshold. Communicating between the personal wireless communication device and the personal audio device through an AP increases latency as compared to direct P2P communications between the personal wireless communication device and the personal audio device, and accordingly, the personal audio device may be biased to communicate with the personal wireless communication device via a direct XPAN link (such as a P2P wireless communication link) when possible. To reduce latency and packet loss associated with transitions between communicating with the personal wireless communication device directly and via the AP, before breaking a P2P link with the wireless communication device, the personal audio device may associate with an AP and receive an IP address from the AP, which the personal audio device may then share with the personal wireless communication device. Once the personal audio device is connected with the AP, the personal audio device may transmit a disassociation message to the personal wireless communication device, and may communicate with the personal wireless communication device via the connection with the AP. Such seamless transitions reduce latency and avoid packet loss, as compared to transitions where a prior wireless communication link is broken before establishment of a new wireless communication link. When communicating with personal wireless communication device via an AP, the personal audio device may transition back to a direct P2P wireless communications link with the personal wireless communication device if the personal audio device determines that a link quality of the P2P wireless communication link satisfies a utility function. Additionally, or alternatively, when communicating with personal wireless communication device via a first AP, the personal audio device may transition to a connection with a second AP, for example, based on a link quality of the link with the second AP being stronger than a link quality of the link with the first AP.

Particular aspects of the subject matter described in this disclosure can be implemented to realize one or more of the following potential advantages. In some examples, the range of XPAN communications may be extended by enabling a personal audio device and a personal wireless communication device to communicate via one or more APs. Accordingly, XPAN range may be increased to whole building or whole office scenarios, for example, in scenarios where a building or office is served by a mesh network of APs. Additionally, or alternatively, latency associated with transitions may be reduced via establishing new wireless links prior to breaking existing wireless links. For example, before breaking a P2P link with a personal wireless communication device, a personal audio device may associate with and establish a wireless communication link with an AP. Once the personal audio device is connected with the AP, the personal audio device may transmit a disassociation message to the personal wireless communication device and may communicate with personal wireless communication device via the connection with the AP. Similarly, before breaking a connection with an AP to connect with the personal wireless communication device via a P2P wireless communication link or to connect with a different AP, the personal audio device associates with and establishes communications with the personal wireless communication device or the different AP, thereby reducing latency associated with such transitions. Additionally, or alternatively, as communications between the personal wireless communication device and the personal audio device through an AP (or through multiple APs) increases latency as compared to direct P2P communications between the personal wireless communication device and the personal audio device, the personal audio device may be biased to communicate with the personal wireless communication device via a direct XPAN link when possible.

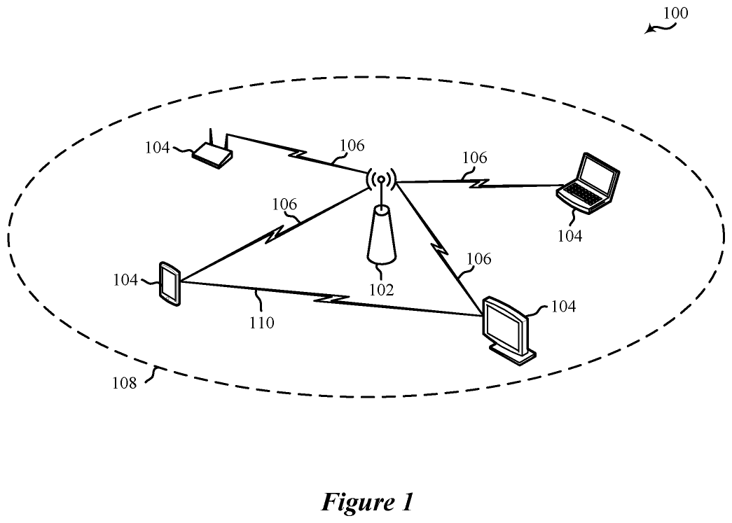

FIG. 1 shows a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, Fifth Generation NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, wireless headsets, wireless earbuds, display devices (for example, TVs (including smart TVs), computer monitors, navigation systems, among others), music or other audio or stereo devices, remote control devices (“remotes”), printers, kitchen appliances (including smart refrigerators) or other household appliances, smart speaker devices, connected exercise equipment, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, an STA 104 listens for beacons, which are transmitted by respective APs 102 at a periodic time interval referred to as the target beacon transmission time (TBTT) (measured in time units (TUs) where one TU may be equal to 1024 microseconds (ps)). To perform active scanning, an STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, an STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, an STA 104 can be covered by more than one AP 102 and can associate with different APs 102 at different times for different transmissions. Additionally, after association with an AP 102, an STA 104 also may periodically scan its surroundings to find a more suitable AP 102 with which to associate. For example, an STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such an STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2, 2.4, 5, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

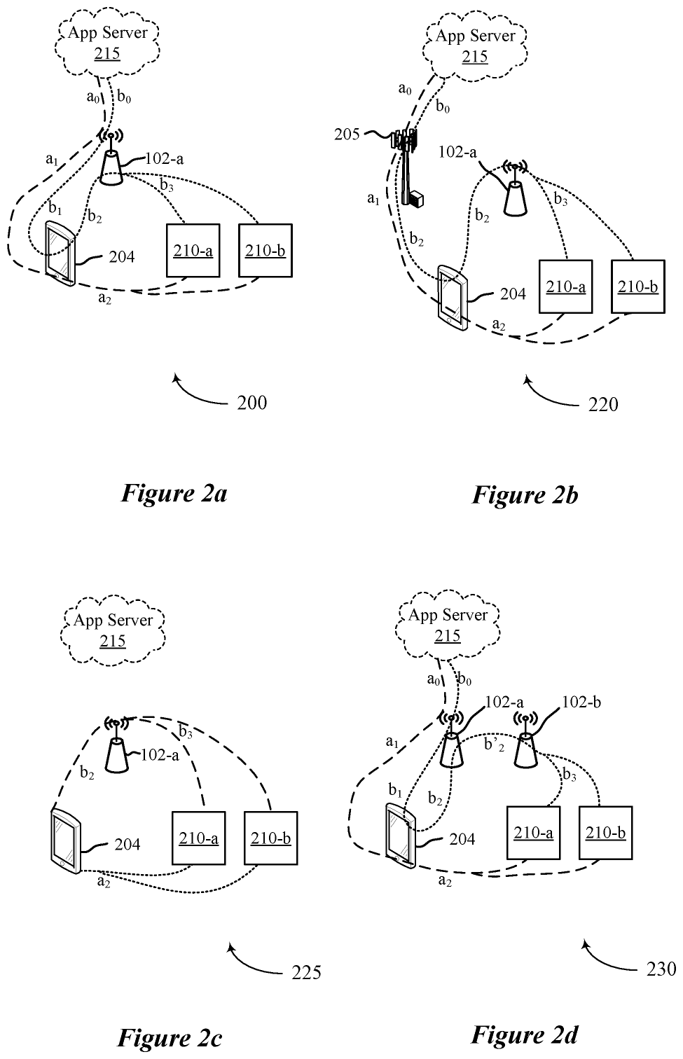

FIGS. 2a, 2b, 2c, and 2d illustrate an example of XPAN scenarios 200, 220, 225, and 230, respectively, that include a personal wireless communication device 204, an AP 102-a, an AP 102-b, an application server 215, and personal audio devices 210-a and 210-b. A personal wireless communication device 204 may be an station 104 as described with reference to FIG. 1. For example, a personal wireless communication device 204 may be a handset, a laptop computer, or a desktop computer. The personal audio devices 210-a and 210-b may be another example of an STA 104 as described with reference to FIG. 1. For example, the personal audio devices 210-a and 210-b may be earbuds, headsets, or headphones. The AP 102-a and the AP 102-b may be examples of an AP 102 as described with reference to FIG. 1.

XPAN may be applied in use cases of streaming lossless audio or voice calls to personal audio devices such as personal audio devices 210-a and 210-b. For example, in XPAN scenarios, the personal audio devices 210-a and 210-b may be cloud connected earbuds/headsets/headphones. As described herein, XPAN may enable whole/home building coverage for audio streaming. In a whole home/building coverage scenario, a user may leave a personal wireless communication device 204 behind and walk around with personal audio devices 210-a and 210-b while the personal audio devices 210-a and 210-b are still connected to the network, enabling uninterrupted listening to audio such as music, podcasts, or audio books, or enabling uninterrupted voice calls. The techniques described herein enable seamless transitions between wireless communication links for XPAN. Example supported audio formats may include 48K/96K/192K lossless or lossy audio streaming, voice calls, music, and voice assistant. For example, in an office environment a user may be at a cubicle while on a conference call and may walk to a break room while leaving the personal wireless communication device 204 at her desk without disruption of the conference call.

In the example XPAN scenarios 200, 220, 225, and 230 of FIGS. 2a, 2b, 2c, and 2d, an application may run on the personal wireless communication device 204 that streams audio (such as for music, video, podcasts, audio books, or voice calls). The data for the application may be served to the personal wireless communication device 204 from an application server 215. Two routes, shown as “a” and “b,” for streaming audio from the personal wireless communication device 204 to the personal audio devices 210-a and 210-b are possible. In a first example, shown as the “a” route, audio data may be streamed over a P2P wireless communication link between the personal wireless communication device 204 and the personal audio devices 210-a and 210-b. In a second example, shown as the “b” route, audio data may be streamed from the personal wireless communication device 204 to the AP 102-a and then from the AP 102-a to the personal audio devices 210-a and 210-b. The “b” route has a higher latency due to the multiple links as compared to the P2P link of the “a” route, but the “b” route may have a larger range, as an AP 102-a may have a larger transmission range than a personal wireless communication device 204.

In the example XPAN scenario 200, in a first route, labeled “a,” audio data is streamed from the application server 215 to the AP 102-a via a wireless communication link a₀, from the AP 102-a to the personal wireless communication device 204 via a wireless communication link a₁, and from the personal wireless communication device 204 to the personal audio devices 210-a and 210-b via a P2P wireless communication link a₂. In a second route, labeled “b,” audio data is streamed from the application server 215 to the AP 102-a via a wireless communication link b₀, from the AP 102-a to the personal wireless communication device 204 via a wireless communication link b₁, from the personal wireless communication device 204 back to the AP 102-a via a wireless communication link b₂, and from the AP 102-a to the personal audio devices 210-a and 210-b via a wireless communication link b₃. The example XPAN scenario 200 shows an online streaming/voice over internet protocol (IP)/voice assistant scenario where the application server 215 serves audio data to an application running on the personal wireless communication device 204 via the AP 102-a.

In the example XPAN scenario 220, in a first route, labeled “a,” audio data is streamed from the application server 215 to a mobile communications base station 205 via a wireless communication link a₀, from the mobile communications base station 205 to the personal wireless communication device 204 via a wireless communication link a₁ (such as, a long term evolution (LTE) link, a Fifth Generation link, or a New Radio (NR) link), and from the personal wireless communication device 204 to the personal audio devices 210-a and 210-b via a P2P wireless communication link a₂. In a second route, labeled “b,” audio data is streamed from the application server 215 to the mobile communications base station 205 via a wireless communication link b₀, from the mobile communications base station 205 to the personal wireless communication device 204 via a wireless communication link b₁ (such as a LTE, Fifth Generation, or NR link), from the personal wireless communication device 204 to the AP 102-a via a wireless communication link b₂, and from the AP 102-a to the personal audio devices 210-a and 210-b via a wireless communication link b₃. The example XPAN scenario 220 shows an example of a voice call with cellular backhaul (such as without Wi-Fi calling).

The example XPAN scenario 225 shows an example of offline streaming of audio from the personal wireless communication device 204 to the personal audio devices 210-a and 210-b. For example, audio data stored in local memory of the personal wireless communication device 204 may be streamed to the personal audio devices 210-a and 210-b without being served by an application server 215. In a first route, labeled “a,” audio data is streamed from the personal wireless communication device 204 to the personal audio devices 210-a and 210-b via a P2P wireless communication link a₂. In a second route, labeled “b,” audio data is streamed from the personal wireless communication device 204 to the AP 102-a via a wireless communication link b₂, and from the AP 102-a to the personal audio devices 210-a and 210-b via a wireless communication link b₃.

As described herein, in the example XPAN scenarios 200, 220, and 225, the “b” routes have a higher latency due to the multiple links as compared to the P2P link of the “a” routes, but the “b” routes may have a larger range, as an AP 102-a may have a larger range transmission range than a personal wireless communication device 204. Accordingly, roaming methods and techniques may be implemented for seamless bi-directional transitions between P2P connections (the “a” route) and direct connection to the AP 102-a (the “b” route) for whole home/office/building coverage for personal audio devices 210-a and 210-b without service interruption. Example transitions include: 1) personal audio device-personal wireless communication device to personal audio device-AP; 2) personal audio device-AP to personal audio device-personal wireless communication device; and 3) personal audio device-first AP to personal audio device-second AP. Described techniques may ensure a make-before-break transition and may reduce scanning overhead at the personal audio devices 210-a and 210-b to reduce power consumption at the personal audio devices 210-a and 210-b.

In the example XPAN scenario 230, in a first route, labeled “a,” audio data is streamed from the application server 215 to the AP 102-a via a wireless communication link a₀, from the AP 102-a to the personal wireless communication device 204 via a wireless communication link a₁, and from the personal wireless communication device 204 to the personal audio devices 210-a and 210-b via a P2P wireless communication link a₂. In a second route, labeled “b,” audio data is streamed from the application server 215 to the AP 102-a via a wireless communication link b₀, from the AP 102-a to the personal wireless communication device 204 via a wireless communication link b₁, from the personal wireless communication device 204 back to the AP 102-a via a wireless communication link b₂, from the AP 102-a to the AP 102-b via a wireless communication link b′₂, and from the AP 102-b to the personal audio devices 210-a and 210-b via a wireless communication link b₃. The example XPAN scenario 230 shows an online streaming/voice over internet protocol (IP)/voice assistant scenario where the application server 215 serves audio data to an application running on the personal wireless communication device 204 via the AP 102-a, where the personal audio devices 210-a and 210-b are connected to a different AP (the AP 102-b) than the personal wireless communication device 204 (the AP 102-a). For example, the AP 102-a and the AP 102-b may be part of a mesh network or a range extended network.

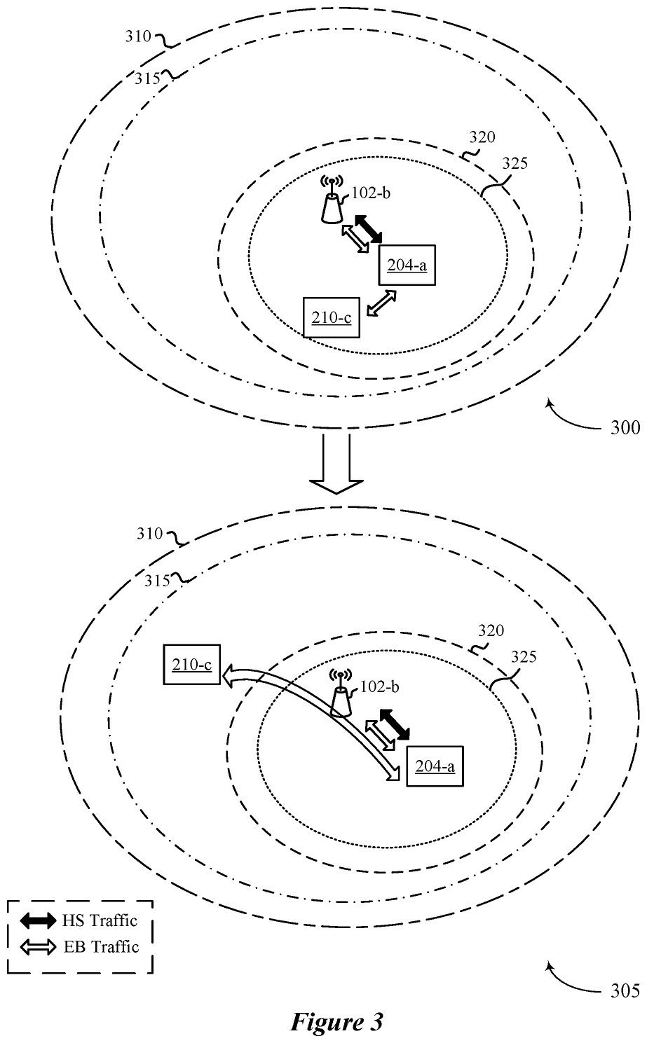

FIG. 3 illustrates an example in an XPAN scenario of a transition between a P2P wireless connection at a first time 300 and a personal audio device-AP connection at a second time 305. The example XPAN scenario illustrated in FIG. 3 includes an AP 102-b, which may be an example of an AP 102 as described herein, a personal wireless communication device 204-a, which may be an example of a personal wireless communication device 204 as described herein, and a personal audio device 210-c, which may be an example of a personal audio device 210-a or 210-b as described herein. For example, FIG. 3 may illustrate a scenario in which a user of XPAN enabled earbuds (personal audio device 210-c) moves out of the range of the personal wireless communication device 204-a. For example, a user of XPAN enabled earbuds may walk away from their desk while leaving their phone (personal wireless communication device 204-a) at their desk.

The AP 102-b may have a 2.4G range 310 and a 5G/6G range 315. As used herein, 2.4G refers to the 2.4 GHz radio frequency band, 5G refers to the 5 GHz radio frequency band, and 6G refers to the 6 GHz radio frequency band. The 2.4G range 310 may be larger than the 5G/6G range 315. The personal wireless communication device 204-a may have a 2.4G range 320 and a 5G/6G range 325. The 2.4G range 320 may be larger than the 5G/6G range 325. The AP 102-b has a larger range than the personal wireless communication device 204-a, for example, the 5G/6G range 315 of the AP 102-b is larger than the 2.4G range 320 of the personal wireless communication device 204-a.

Accordingly, at the first time 300, when the personal audio device 210-c is within the 5G/6G range of the personal wireless communication device 204-a, the personal wireless communication device 204-a and the personal audio device 210-c may communicate audio data (shown as EB traffic) via a direct P2P wireless communication link. The personal wireless communication device 204-a may communicate audio data for relaying onto or from the personal audio device 210-c (shown as EB traffic) and other data specific to the personal wireless communication device 204-a (shown as HS traffic) with the AP 102-b.

At the second time 305, when the personal audio device 210-c is outside of the range of the personal wireless communication device 204-a (both the 2.4G range 320 and the 5G/6G range 325), the personal audio device 210-c and the personal wireless communication device 204-a may communicate audio data via the AP 102-b. Accordingly, between the first time 300 and the second time 305, the personal audio device 210-c may transition from a personal audio device-personal wireless communication device connection scenario to a personal audio device-AP connection scenario.

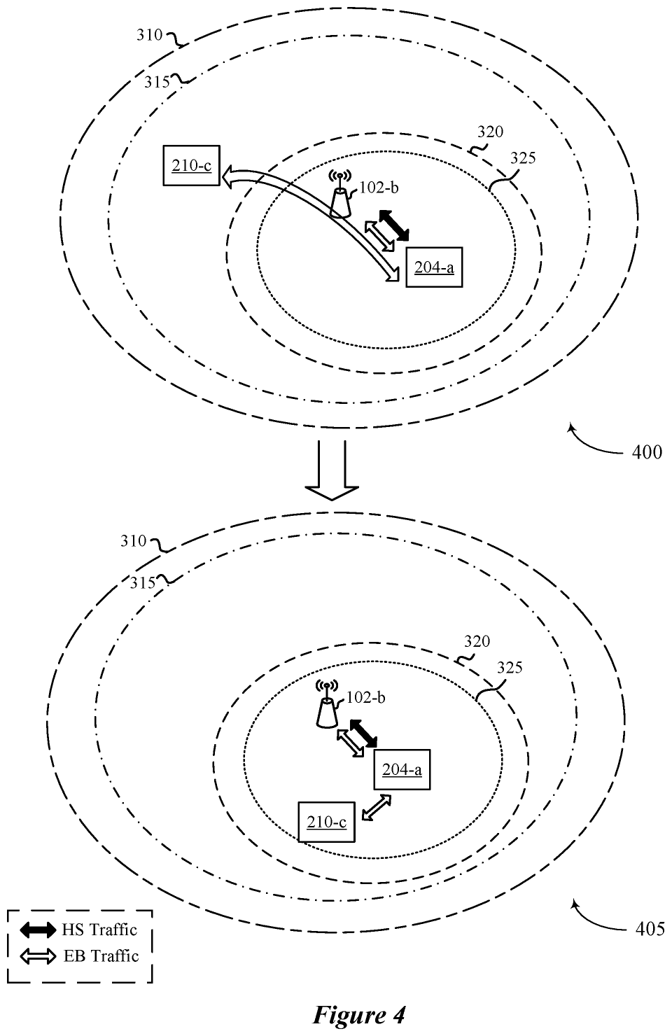

FIG. 4 illustrates an example in an XPAN scenario of a transition between a personal audio device-AP connection at a first time 400 and a P2P wireless connection at a second time 405. The example XPAN scenario illustrated in FIG. 4 includes the AP 102-b, the personal wireless communication device 204-a, and the personal audio device 210-c described with reference to FIG. 3. For example, FIG. 4 may illustrate a scenario in which a user of XPAN enabled earbuds (personal audio device 210-c) moves back within the range of the personal wireless communication device 204-a. For example, a user of XPAN enabled earbuds may return to their desk on which they left their phone (personal wireless communication device 204-a).

At the first time 400, which may correspond to the second time 305 of FIG. 3, the personal audio device 210-c is outside of the range of the personal wireless communication device 204-a (both the 2.4G range 320 and the 5G/6G range 325), and the personal audio device 210-c and the personal wireless communication device 204-a may communicate audio data via the AP 102-b. Between the first time 400 and the second time 405, a user of the personal audio device 210-c moves into the 5G/6G range of the personal wireless communication device 204-a.

As a direct P2P wireless communication link between the personal audio device 210-c and the personal wireless communication device 204-a has a lower latency than communications via the AP 102-b, at the second time 405, when the personal audio device 210-c is within the 5G/6G range of the personal wireless communication device 204-a, the personal wireless communication device 204-a and the personal audio device 210-c may communicate audio data (shown as EB traffic) via the direct P2P wireless communication link. Accordingly, between the first time 400 and the second time 405, the personal audio device 210-c may transition from a personal audio device-AP connection scenario to a personal audio device-personal wireless communication device connection scenario.

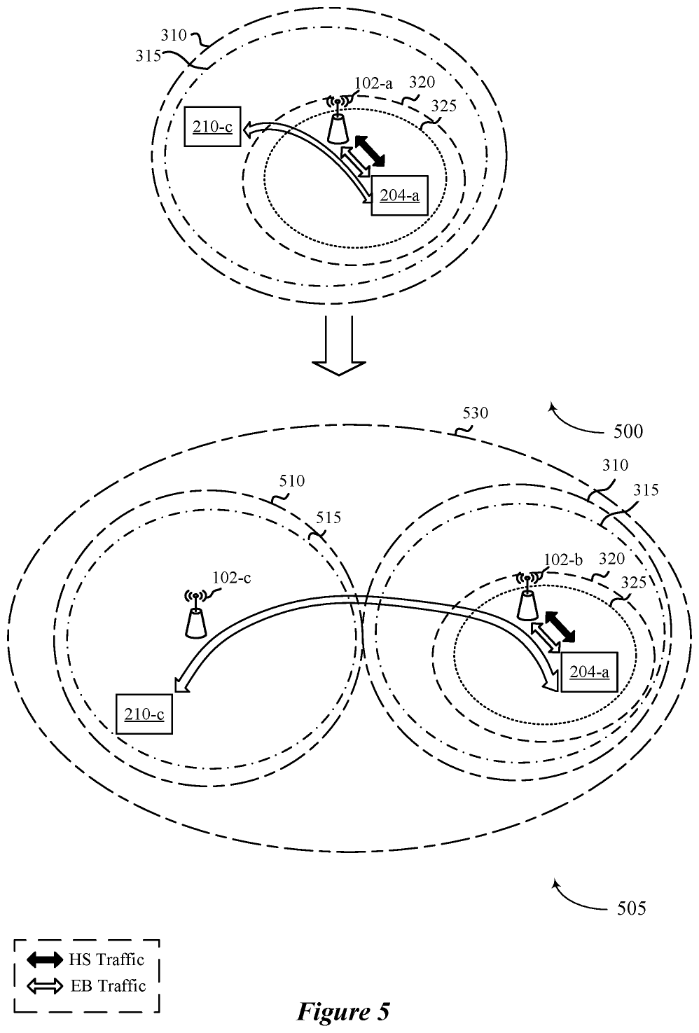

FIG. 5 illustrates an example in an XPAN scenario of a transition between a personal audio device-first AP connection at a first time 500 and a personal audio device-second AP connection at a second time 505. The example XPAN scenario illustrated in FIG. 5 includes the AP 102-b, the personal wireless communication device 204-a, and the personal audio device 210-c described with reference to FIG. 3. The example XPAN scenario illustrated in FIG. 5 includes an AP 102-c, which may be an example of an AP 102 as described herein. The AP 102-b and the AP 102-c may be within a same mesh network or extended service set 530. The AP 102-c may have a 2.4G range 510 and a 5G/6G range 515. The 2.4G range 310 may be larger than the 5G/6G range 515. For example, a user of XPAN enabled earbuds (personal audio device 210-c) who left their phone (personal wireless communication device 204-a) at their desk may move from one floor or section of their office or home which is served by a first AP to a second floor or section of their office which is served by a second AP.

At the first time 500, which may correspond to the second time 305 of FIG. 3, the personal audio device 210-c is outside of the range of the personal wireless communication device 204-a (both the 2.4G range 320 and the 5G/6G range 325), and the personal wireless communication device 204-a and the personal audio device 210-c may communicate audio data via the AP 102-b. Between the first time 500 and the second time 505, a user of the personal audio device 210-c moves out of the 2.4G range 510 of the AP 102-b (which is the serving AP for the personal wireless communication device 204-a) and into the 5G/6G range 515 of the AP 102-c.

At the second time 505, the personal audio device 210-c and the personal wireless communication device 204-a may communicate audio data via the AP 102-c and the AP 102-b (the personal wireless communication device 204-a may relay audio data to the personal audio device 210-c via the AP 102-b and the AP 102-c). Accordingly, between the first time 500 and the second time 505, the personal audio device 210-c may transition from a personal audio device-first AP connection scenario to a personal audio device-second AP connection scenario.

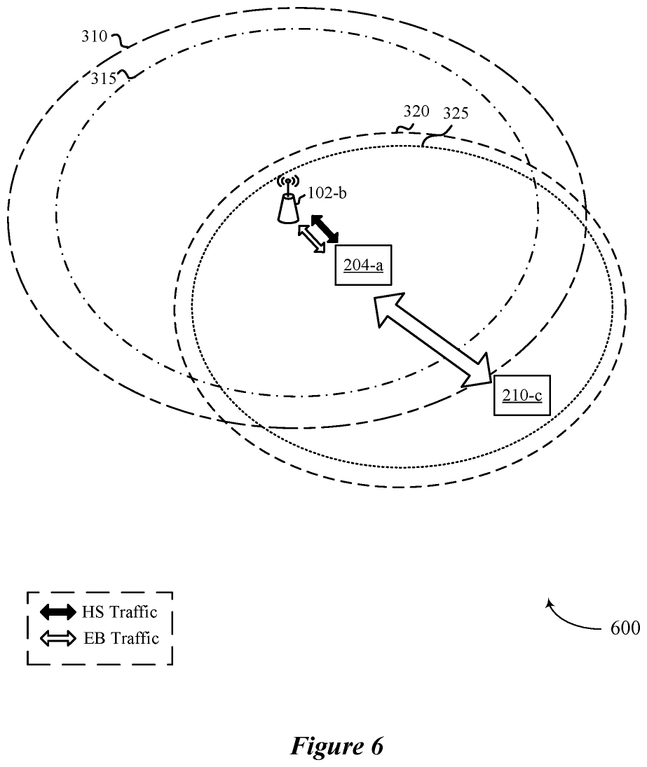

FIG. 6 illustrates an example of an XPAN scenario 600 where the personal audio device 210-c is within range of the personal wireless communication device 204-a but outside of the range of the AP 102-b serving the personal wireless communication device 204-a. The example XPAN scenario 600 includes the AP 102-b, the personal wireless communication device 204-a, and the personal audio device 210-c described with reference to FIG. 3. For example, a user of XPAN enabled earbuds (personal audio device 210-c) may leave their phone (personal wireless communication device 204-a) at their desk, which may be near a border of a range served by an AP. The user may walk a distance away from the desk such that the user leaves the rang of the AP but is still within range of the phone.

In the example XPAN scenario 600, the personal wireless communication device 204-a is near the edge of the 5G/6G range 315 and the 2.4G range 310 of the AP 102-b, and accordingly the 5G/6G range 325 and the 2.4G range 320 of the personal wireless communication device 204-a are not completely contained within the 5G/6G range 315 and the 2.4G range 310 of the AP 102-b. As shown, the personal audio device 210-c is within 5G/6G range 325 of the personal wireless communication device 204-a but outside of the 2.4G range 310 of the AP 102-b serving the personal wireless communication device 204-a. In the XPAN scenario 600, the personal wireless communication device 204-a and the personal audio device 210-c may communicate audio data (shown as EB traffic) via a direct P2P wireless communication link. The personal wireless communication device 204-a may communicate audio data for relaying onto or from the personal audio device 210-c (shown as EB traffic) and other data specific to the personal wireless communication device 204-a (shown as HS traffic) with the AP 102-b.

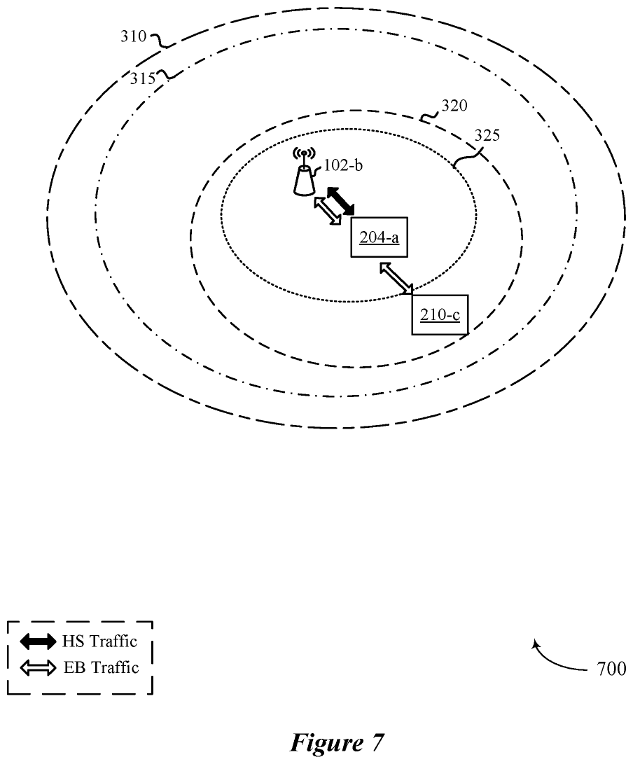

FIG. 7 illustrates an example of an XPAN scenario 700 where the personal audio device 210-c is within the 2.4G range 320 of the personal wireless communication device 204-a but outside the 5G/6G range 325 of the personal wireless communication device 204-a. The example XPAN scenario 700 includes the AP 102-b, the personal wireless communication device 204-a, and the personal audio device 210-c described with reference to FIG. 3. For example, a user of XPAN enabled earbuds (personal audio device 210-c) who left their phone (personal wireless communication device 204-a) at their desk may be at a distance from their desk which is within the 2.4G range of the phone but not within the 5G/6G range of the phone.

As shown, the personal audio device 210-c is within the 2.4G range 320 of the personal wireless communication device 204-a and is within the 5G/6G range of the AP 102-b but outside of the 5G/6G range 325 of the personal wireless communication device 204-a. In the XPAN scenario 700, the personal wireless communication device 204-a and the personal audio device 210-c may communicate audio data (shown as EB traffic) via a 2.4G direct P2P wireless communication link. The personal wireless communication device 204-a may communicate audio data for relaying onto or from the personal audio device 210-c (shown as EB traffic) and other data specific to the personal wireless communication device 204-a (shown as HS traffic) with the AP 102-b via a 5G/6G link of the AP 102-b. In some cases, rather than a 2.4G direct P2P wireless communication link, the personal wireless communication device 204-a and the personal audio device 210-c may communicate audio data (shown as EB traffic) via a Bluetooth (BT) low energy communication link. For example, the link used for communicating audio data between the personal wireless communication device 204-a and the personal audio device 210-c may be changed based on range, received signal strength indicator (RSSI) measurements, channel congestion, and/or latency considerations.

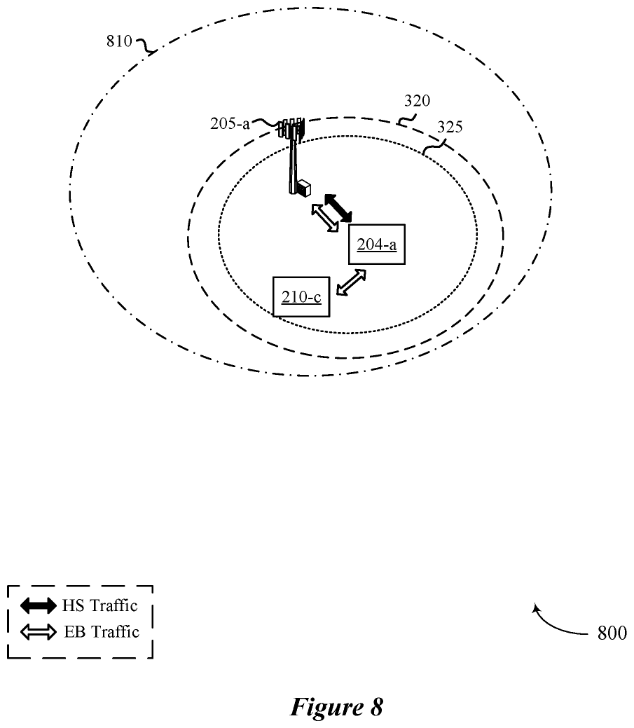

FIG. 8 illustrates an example of an XPAN scenario 800 where the personal wireless communication device 204-a is connected to a cellular base station 205-a, and the personal audio device 210-c is within range of the personal wireless communication device 204-a. The example XPAN scenario 800 includes personal wireless communication device 204-a and the personal audio device 210-c described with reference to FIG. 3. The example XPAN scenario 800 includes a base station 205-a, which may be an example of a base station 205 as described with reference to FIG. 2b. The base station 205-a may have a communications range 810. For example, a user of XPAN enabled earbuds (personal audio device 210-c) may be in a location without a WLAN and instead their phone may be connected to a cellular network.

The personal wireless communication device 204-a and the personal audio device 210-c may communicate audio data (shown as EB traffic) via a direct P2P wireless communication link. The personal wireless communication device 204-a may communicate audio data for relaying onto or from the personal audio device 210-c (shown as EB traffic) and other data specific to the personal wireless communication device 204-a (shown as HS traffic) with the base station 205-a via a communication link such as an LTE link, a Fifth Generation link, or an NR link. The XPAN scenario 800 may illustrate an example personal audio device 210-c to personal wireless communication device 204-a connection on XPAN 5G with cellular backhaul.

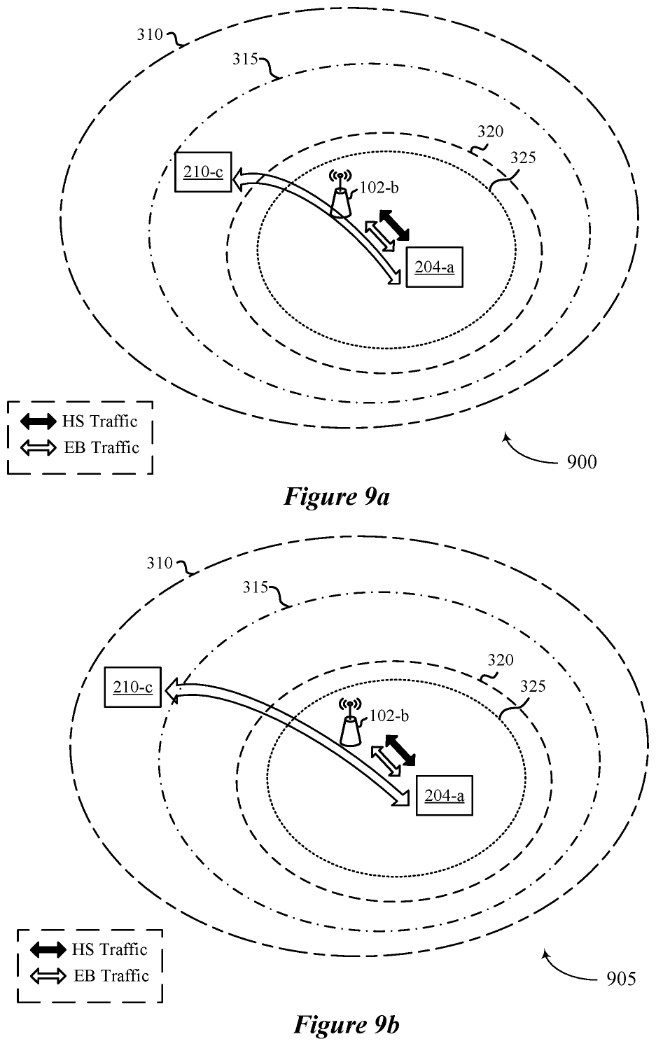

FIG. 9a illustrates an example XPAN scenario 900 where the personal audio device 210-c is within the 5G/6G range 315 of the AP 102-b but outside the 2.4G range 320 of the personal wireless communication device 204-a. The example XPAN scenario 900 includes the AP 102-b, the personal wireless communication device 204-a, and the personal audio device 210-c described with reference to FIG. 3. For example, a user of XPAN enabled earbuds (personal audio device 210-c) may leave their phone (personal wireless communication device 204-a) at their desk, and may be at a distance from their desk which is outside the 2.4G range of the phone but within the 5G/6G range of the AP serving the phone. The personal audio device 210-c and the personal wireless communication device 204-a may communicate audio data via the AP 102-b (and specifically via a 5G/6G wireless communication link between the AP 102-b and the personal audio device 210-c). The personal wireless communication device 204-a may communicate audio data for relaying onto or from the personal audio device 210-c (shown as EB traffic) and other data specific to the personal wireless communication device 204-a (shown as HS traffic) with the AP 102-b via a 5G/6G wireless communication link between the AP 102-b and the personal wireless communication device 204-a.

FIG. 9b illustrates an example XPAN scenario 905 where the personal audio device 210-c is within the 2.4G range 310 of the AP 102-a but outside the 2.4G range 320 of the personal wireless communication device 204-a and the 5G/6G range 315 of the AP 102-b. The example XPAN scenario 905 includes the AP 102-b, the personal wireless communication device 204-a, and the personal audio device 210-c described with reference to FIG. 3. For example, a user of XPAN enabled earbuds (personal audio device 210-c) may leave their phone (personal wireless communication device 204-a) at their desk, and may be at a distance from their desk which is outside the 2.4G range of the phone but within the 2.4G range of the AP serving the phone. The personal audio device 210-c and the personal wireless communication device 204-a may communicate audio data via the AP 102-b (and specifically via a 2.4G wireless communication link between the AP 102-b and the personal audio device 210-c). The personal wireless communication device 204-a may communicate audio data for relaying onto or from the personal audio device 210-c (shown as EB traffic) and other data specific to the personal wireless communication device 204-a (shown as HS traffic) with the AP 102-b via a 5G/6G wireless communication link between the AP 102-b and the personal wireless communication device 204-a.

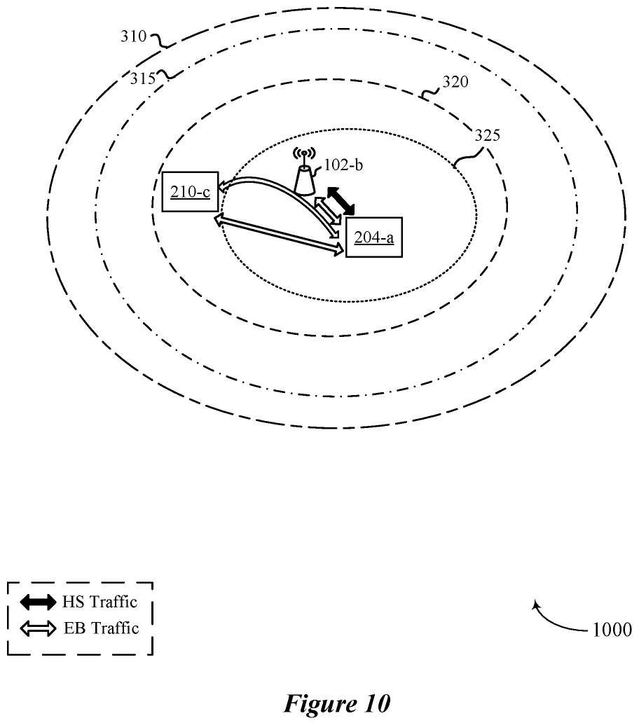

FIG. 10 illustrates an example of a illustrates an example XPAN scenario 1000 where the personal audio device 210-c is within the 2.4G range 320 of the personal wireless communication device 204-a but outside of the 5G/6G range of the personal wireless communication device 204-a. The example XPAN scenario 1000 includes the AP 102-b, the personal wireless communication device 204-a, and the personal audio device 210-c described with reference to FIG. 3. For example, a user of XPAN enabled earbuds (personal audio device 210-c) may leave their phone (personal wireless communication device 204-a) at their desk, and may be at a distance from their desk which is within the 2.4G range of the phone but not within the 5G/6G range of the phone and is also within the 5G/6G range of the AP serving the phone.

The personal wireless communication device 204-a may communicate audio data for relaying onto or from the personal audio device 210-c (shown as EB traffic) and other data specific to the personal wireless communication device 204-a (shown as HS traffic) with the AP 102-b via a 5G/6G wireless communication link between the AP 102-b and the personal wireless communication device 204-a. The personal audio device 210-c and the personal wireless communication device 204-a may either communicate audio data via the AP 102-b (and specifically via a 5G/6G wireless communication link between the AP 102-b and the personal audio device 210-c) or via a 2.4G P2P link between the personal audio device 210-c and the personal wireless communication device 204-a depending on channel quality and power consumption considerations. For example, the 5G/6G connection with the AP 102-a may involve higher power consumption than the 2.4G P2P connection with the personal wireless communication device 204-a.

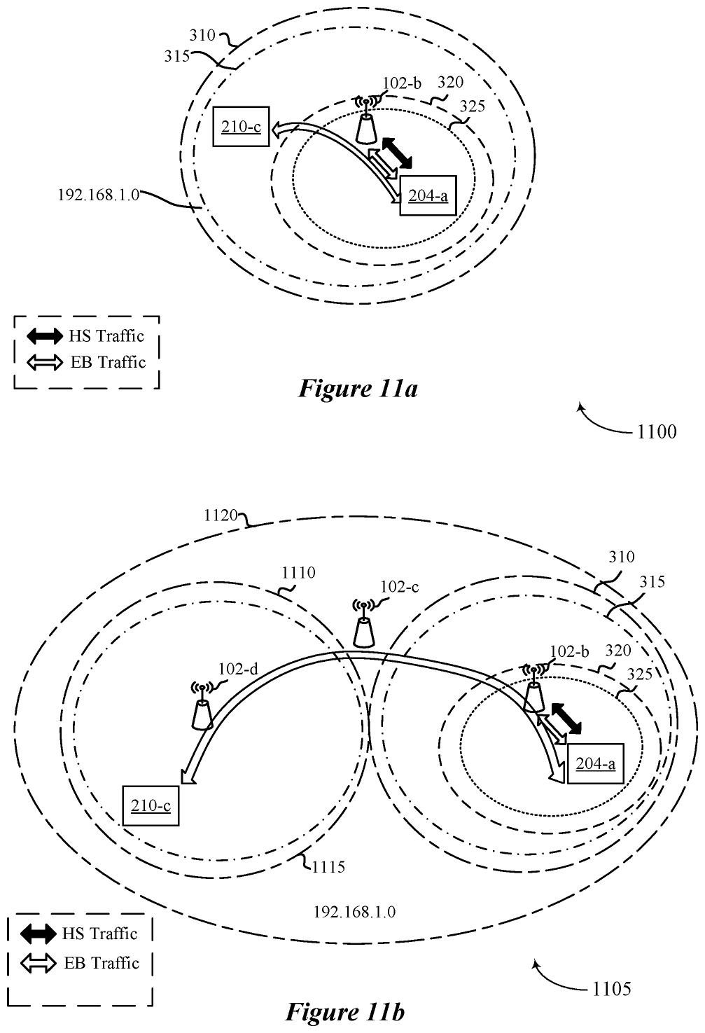

FIG. 11a illustrates an example of an XPAN scenario 1100 where a personal wireless communication device 204-a relays audio data (such as a voice call or an offline stream) through a same basic service set (BSS) to the personal audio device 210-c. The example XPAN scenario 1100 includes the AP 102-b, the personal wireless communication device 204-a, and the personal audio device 210-c described with reference to FIG. 3. The AP 102-b may serve a same L2/L3 network. For example, the AP 102-b may provide a BSS to the region 310/315. For example, a user of XPAN enabled earbuds (personal audio device 210-c) may leave their phone (personal wireless communication device 204-a) at their desk, and may be at a distance from their desk which is outside the 2.4G range of the phone. The XPAN enabled earbuds may be connected to an AP with the same BSS and the AP to which the phone is connected.

The personal audio device 210-c and the personal wireless communication device 204-a may communicate audio data via the AP 102-b (through the same BSS). The personal wireless communication device 204-a may communicate audio data for relaying onto or from the personal audio device 210-c (shown as EB traffic) and other data specific to the personal wireless communication device 204-a (shown as HS traffic) with the AP 102-b via a 5G/6G wireless communication link between the AP 102-b and the personal wireless communication device 204-a.

FIG. 11b illustrates an example of an XPAN scenario 1105 where a personal wireless communication device 204-a relays audio data (such as a voice call or an offline stream) through a ESS to the personal audio device 210-c, where the personal wireless communication device 204-a and the personal audio device 210-c are in a same L2/L3 network (such as in a home mesh network scenario). The example XPAN scenario 1105 includes the AP 102-b, the personal wireless communication device 204-a, and the personal audio device 210-c described with reference to FIG. 3. The example XPAN scenario 1105 includes an AP 102-c and an AP 102-d, which may be examples of APs 102 as described herein. The AP 102-b and the AP 102-d may serve a same L2/L3 network. For example, the AP 102-b may provide a BSS to the region 310/315 and the AP 102-d may provide a BSS to the region 1110/1115. The ESS may serve a region 1120. For example, a user of XPAN enabled earbuds (personal audio device 210-c) may leave their phone (personal wireless communication device 204-a) at their desk, and may be at a distance from their desk which is outside the 2.4G range of the phone. The XPAN enabled earbuds may be connected to an AP that is within the same mesh network as the AP to which the phone is connected.

The personal audio device 210-c and the personal wireless communication device 204-a may communicate audio data via the AP 102-b, the AP 102-c, and the AP 102-d (the personal wireless communication device 204-a may relay voice calls or offline streams through the same ESS to the personal audio device 210-c in a different BSS). The personal wireless communication device 204-a may communicate audio data for relaying onto or from the personal audio device 210-c (shown as EB traffic) and other data specific to the personal wireless communication device 204-a (shown as HS traffic) with the AP 102-b via a 5G/6G wireless communication link between the AP 102-b and the personal wireless communication device 204-a.

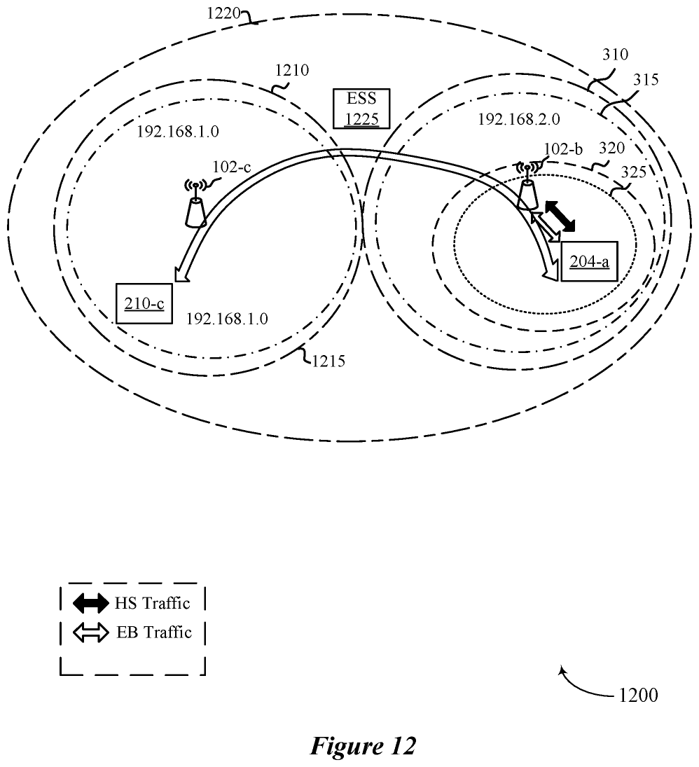

FIG. 12 illustrates an example of an XPAN scenario 1200 where a personal wireless communication device 204-a relays audio data (such as a voice call or an offline stream) through a ESS to the personal audio device 210-c where the personal wireless communication device 204-a and the personal audio device 210-c are in different L2/L3 networks (such as in an office building scenario). The example XPAN scenario 1200 includes the AP 102-b, the personal wireless communication device 204-a, and the personal audio device 210-c described with reference to FIG. 3. The example XPAN scenario 1200 includes an AP 102-c, which may be an example of an AP 102 as described herein. The AP 102-b and the AP 102-c may serve different L2/L3 networks. For example, the AP 102-b may provide a BSS to the region 310/315 and the AP 102-c may provide a BSS to the region 1210/1215. The ESS 1225 may serve a region 1220. For example, a user of XPAN enabled earbuds (personal audio device 210-c) may leave their phone (personal wireless communication device 204-a) at their desk, and may be at a distance from their desk which is outside the 2.4G range of the phone. The XPAN enabled earbuds may be connected to an AP that is different L1 or L2 network but the same ESS 1225 as the AP to which the phone is connected.

The personal audio device 210-c and the personal wireless communication device 204-a may communicate audio data via the AP 102-b and the AP 102-c (the personal wireless communication device 204-a may relay voice calls or offline streams through the same ESS 1225 to the personal audio device 210-c in a different BSS). The personal wireless communication device 204-a may communicate audio data for relaying onto or from the personal audio device 210-c (shown as EB traffic) and other data specific to the personal wireless communication device 204-a (shown as HS traffic) with the AP 102-b via a 5G/6G wireless communication link between the AP 102-b and the personal wireless communication device 204-a.

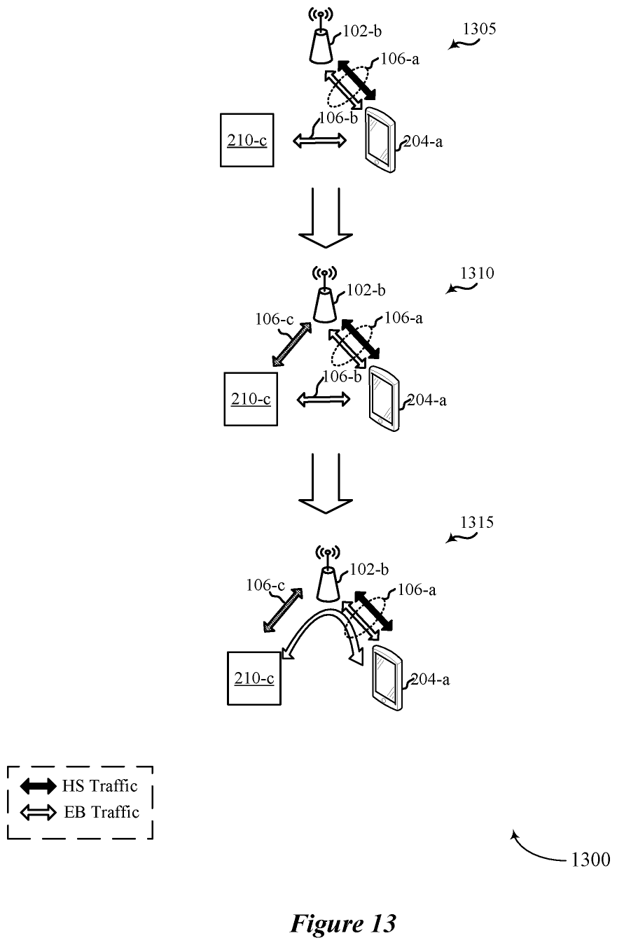

FIG. 13 illustrates an example of a transition in an XPAN scenario 1300 between a P2P wireless connection and a personal audio device-AP connection. The XPAN scenario 1300 includes the AP 102-b, the personal wireless communication device 204-a, and the personal audio device 210-c described with reference to FIG. 3. As the transition illustrated in the XPAN scenario 1300 establishes a connection between the personal audio device 210-c and the AP 102-b before breaking the P2P connection between the personal audio device 210-c and the personal wireless communication device 204-a, the transition illustrated in the XPAN scenario 1300 may reduce latency and packet loss as compared to a transition from a P2P connection to an AP connection in which the connection to the AP is not established prior to breaking the P2P connection.

At 1305, the personal wireless communication device 204-a communicates audio data for relaying onto or from the personal audio device 210-c (shown as EB traffic) and other data specific to the personal wireless communication device 204-a (shown as HS traffic) with the AP 102-b via a communication link 106-a. At 1305, the personal wireless communication device 204-a communicates audio data (shown as EB traffic) via a direct P2P wireless communication link 106-b.

The personal audio device 210-c monitors the link quality of the P2P wireless communication link 106-b. If the P2P wireless communication link 106-b drops below a threshold (LQ_{AssocAP}) the personal audio device 210-c may request the most recent channel scan results from the personal wireless communication device 204-a. In response, the personal wireless communication device 204-a may share the most recent scan results with the BSS identifier (BSSID) of the associated AP (the AP 102-b), the channel of the AP 102-b, and capabilities of the AP 102-b. In some examples, if the most recent scan results are older than a threshold, the personal wireless communication device 204-a may perform a channel scan in response to the request from the personal audio device 210-c, and the personal wireless communication device 204-a may share the results of the newly performed channel scan with the personal audio device 210-c. The personal audio device 210-c may calculate a utility function for the P2P connection versus APs in the vicinity of the personal audio device 210-c.

At 1310, if the personal audio device 210-c determines that a connection to the AP 102-b provides a better utility function, then the personal audio device 210-c begins an association/authentication or connection process with the AP 102-b. In some examples, the association/authentication or connection process may involve a security key exchange or dynamic host configuration protocol (DHCP) server negotiation with the candidate AP (for example, the AP 102-b). The personal audio device 210-c obtains an IP address from the AP 102-b, and shares the IP address and/or MAC address with the personal wireless communication device 204-a. Accordingly, the personal audio device 210-c establishes a wireless communication link 106-c with the AP 102-b, and has dual connectivity via the wireless communication link 106-c and the wireless communication link 106-b. The personal wireless communication device 204-a may look up the MAC address of the personal audio device 210-c using the address resolution protocol (ARP), and the personal wireless communication device 204-a may switch the BT control path for communications with the personal audio device 210-c over transmission control protocol (TCP). In some examples, the personal audio device 210-c may share the IP addresses and MAC addresses of the personal audio device 210-c with the personal wireless communication device 204-a.

If the link quality of the P2P wireless communication link 106-b drops below a second threshold (LQ_{roamAP}), the personal audio device 210-c may transmit a roaming indication or a roaming request to the personal wireless communication device 204-a. In response to the roaming indication or roaming request, the personal wireless communication device 204-a may increase audio latency to handle latency across the network, may reduce the audio bit rate, and/or may increase audio latency to handle end to end latency across the network.

At 1315, the personal wireless communication device 204-a switches audio data from ethernet to User Datagram Protocol (UDP), and the personal wireless communication device 204-a transfers audio data to the personal audio device 210-c via the AP 102-b (via the wireless communication link 106-a and the wireless communication link 106-c). In some examples, in response to the roaming indication, the personal wireless communication device 204-a may switch BT control from Bluetooth Low Energy (BLE) to TCP over the AP 102-b. In some examples, in response to the roaming indication, the personal wireless communication device 204-a and the personal audio device may disassociate/break the P2P wireless communication link 106-b and the personal wireless communication device 204-a may forward data to the personal audio device 210-c through the AP 102-b using the IP and MAC addresses of the personal audio device 210-c.

In some examples, the personal audio device 210-c may initiate the transition. For example, the personal audio device 210-c may monitor the average link quality of the P2P wireless communication link 106-b from downlink transmissions (such as, RSSI, packet error rate (PER), number of retries, congestion level, or a combination thereof). As described herein, if the link quality of the P2P wireless communication link 106-b drops below the first threshold (LQ_{AssocAP}) the personal audio device 210-c may start scanning procedures for neighboring APs. In some examples, the personal wireless communication device 204-a may share scan results with the personal audio device 210-c and/or may perform a scan on behalf of the personal audio device 210-c, and the personal audio device 210-c may use the shared scan results or may perform a scan if no AP 102 is available in the shared list. For example, the personal wireless communication device 204-a may forward scan results to the personal audio device 210-c, for example if the personal wireless communication device 204-a and the personal audio device 210-c are within a threshold physical proximity of each other (in which case channel scan results at the personal wireless communication device 204-a would be similar to channel scan results at the personal audio device 210-c) together with a timestamp for when the channel scan results were obtained. For example, the personal wireless communication device 204-a may forward the channel scan results in a vendor specific action frame. In a home scenario, the personal wireless communication device 204-a may forward the BSSID of the serving AP 102-b and the home channel of the serving AP 102-b to the personal audio device 210-c. In some examples, the personal audio device 210-c may attempt to connect with one of the most recently used APs 102 in the list received from the personal wireless communication device 204-a.

In some examples, the personal audio device 210-c may request the personal wireless communication device 204-a to perform the scan on behalf of the personal audio device 210-c through a vendor specific action frame. For example, scanning may be done on an as-needed basis to reduce power consumption at the personal audio device 210-c. In some examples, personal audio device 210-c scanning may be limited to a subset of channels to reduce power consumption at the personal audio device 210-c. In some examples, a higher weight may be given to the AP that the personal wireless communication device 204-a is directly connected to (the AP 102-b).

In some examples, if an AP with a better RSSI is found (better than the RSSI of the P2P wireless communication link 106-b), the personal audio device 210-c may check if it is better to roam to the AP with the better RSSI or to stay connected on the P2P wireless communication link 106-b using a utility function. The RSSI may be calculated from beacons or probe responses (transmitted by APs 102 in response to probe requests transmitted by the personal audio device 210-c). The utility function may be based on the difference in RSSI, 2.4 G vs 5G/6G channels, and/or a bias factor toward the direct P2P connection to the personal wireless communication device 204-a for power saving considerations (since most APs do not support/enable target wake time (TWT)) and the end to end latency of the direct P2P connection as opposed to the multi-point connection via an AP. For example, the utility function may select the wireless communication link with a higher RSSI while accounting for biases. In some examples, where there are multiple APs 102 (such as in a mesh network), the utility function may involve a bias factor towards the AP 102 to which the personal wireless communication device 204-a is connected in order to reduce latency associated with communication via multiple APs 102. In some examples, if the personal audio device 210-c determines that the connection to the AP 102 would be better using the utility function, the personal audio device 210-c starts the roaming procedure to the AP 102. The AP 102 may be the serving AP 102-b for the personal wireless communication device 204-a or may be a different AP 102.

As described herein, the personal audio device 210-c may establish a connection with the AP 102-b (such as via an association/authentication procedure). The personal audio device 210-c may maintain the connection to the AP 102-b via listening to delivery traffic indication map (DTIM) beacons and ensuring not to exceed the BSS max idle period communicated by the AP 102-b in an association response. In some examples, if the AP 102-b is on a different channel that the P2P wireless communication link 106-b (the wireless communication link 106-c uses a different channel than the P2P wireless communication link 106-b), then the personal audio device 210-c may regularly switch channels to maintain the connection with the AP 102-b and the P2P connection with the personal wireless communication device 204-a. In some examples, the personal wireless communication device 204-a may switch the channel of the P2P wireless communication link 106-b to be the same as the infra channel (the wireless communication link 106-a) to reduce the overhead of frequent channel switching from the personal audio device 210-c. The personal wireless communication device 204-a may send a channel switch announcement (CSA) to the personal audio device 210-c in response to initiating switching the channel of the P2P wireless communication link 106-b to be the same as the infra channel, and the personal audio device 210-c may accordingly switch the P2P wireless communication link 106-b to be the same as the infra channel. In some cases, if the AP 102-b is on a same channel as the P2P wireless communication link 106-b (the wireless communication link 106-c uses a same channel as the P2P wireless communication link 106-b), channel contention may occur between the wireless communication link 106-c and the P2P wireless communication link 106-b.

As described herein, in some examples, during the authentication/association process, the personal audio device 210-c obtains an IP address from the AP 102-b and shares the IP address with the personal wireless communication device 204-a. For example, the IP address from the personal audio device 210-c (or for both devices in the case of two earbuds) may be shared with the personal wireless communication device 204-a via a vendor specific action frame. In some examples (for example, in the case of two earbuds), where there are two personal audio devices 210, the primary personal audio device 210 (for example, the personal audio device 210-a) may share the BSSID of the target AP with the secondary personal audio device 210 (for example, the personal audio device 210-b) to ensure that the two personal audio devices 210 do not connect to two different APs. The primary personal audio device 210-a may then share the IP and MAC addresses of both personal audio devices 210 with the personal wireless communication device 204-a. At 1310, as described herein, the personal audio device 210-c is connected to the AP 102-b and the personal wireless communication device 204-a, via the wireless communication link 106-c and the P2P wireless communication link 106-b, respectively (dual personal audio device 210-c connection enables seamless transition).

As described herein, if the link quality of the P2P wireless communication link 106-b drops below a second threshold (LQ_{roamAP}), the personal audio device 210-c transmits an indication to the personal wireless communication device 204-a that the personal audio device 210-c will roam to the AP 102-b. LQ_{roamAP}≤LQ_{assocAP}, where LQ_{roamAP} and LQ_{assocAP} may be programmable link quality metric thresholds. LQ_{roamAP} may be selected to at least guarantee the personal audio device 210-c can reliably send the roaming indication to the personal wireless communication device 204-a. In some examples, the personal audio device 210-a may implement a hysteresis check if the connection to the AP 102-a still provides a higher utility than a BLE/XPAN P2P link and may transmit a roaming request to XPAN over AP to the personal wireless communication device 204-a accordingly.

The personal wireless communication device 204-a may use the indicated IP address for the personal audio device 210-c and MAC addresses to continue data transfer through the AP 102-b to the personal audio device 210-c. In some examples, the MAC address of the personal audio device 210-c may be known to the personal wireless communication device 204-a from prior communication. If not available in the personal wireless communication device 204-a MAC addresses cache, the personal wireless communication device 204-a may use an ARP request with the obtained IP address of the personal audio device 210-c to inquire about the MAC address of the personal audio device 210-c. The personal audio device 210-c may continue to monitor the link quality of the wireless communication link 106-c at 1315.

In some examples, the personal wireless communication device 204-a may assist in the monitoring of the link quality of the P2P wireless communication link 106-b. For example, at the 1305, the personal audio device 210-c may monitor the link quality of the P2P wireless communication link 106-b to/from the personal wireless communication device 204-a and regularly share the monitoring information with the personal wireless communication device 204-a via vendor specific action frames or over a Bluetooth link. The personal wireless communication device 204-a may also monitor uplink link quality, for example the personal wireless communication device 204-a may monitor the quality of uplink transmissions over the P2P wireless communication link 106-b. If the link quality of the P2P wireless communication link 106-b drops below the first threshold (LQ_{AssocAP}), the personal wireless communication device 204-a may transmit a roaming suggestion to the personal audio device 210-c. The personal wireless communication device 204-a, in response to the link quality of the P2P wireless communication link 106-b dropping below the first threshold (LQ_{AssocAP}), may perform a scan (or use recent scan results) and share the scan results with the BSSID of the associated AP 102-b, the channel of the AP 102-b, and capabilities of the AP 102-b, with the personal audio device 210-c. The personal audio device 210-c may then determine the utility of a connection with the AP 102-b versus the P2P wireless communication link 106-b, and proceed to 1310/1315 as described herein.

The personal wireless communication device 204-a assisted transition is similar to the personal audio device 210-c initiated transition, except that in the personal wireless communication device 204-a assisted transition, the personal wireless communication device 204-a may monitor the average link quality from uplink transmissions (such as based on RSSI, PER, number or retries, congestion level, or a combination thereof), and the personal wireless communication device 204-a may also receive periodic reports about downlink quality from the personal audio device 210-c (such as via vendor specific action frames). Additionally, or alternatively, in the personal wireless communication device 204-a assisted transition, the personal wireless communication device 204-a may transmit an indication to the personal audio device 210-c when the link quality of the P2P wireless communication link 106-b drops below the first threshold (LQ_{AssocAP}) to suggest roaming, and optionally the personal wireless communication device 204-a may indicate the BSSID of the associated AP 102-b, the channel of the AP 102-b, and capabilities of the AP 102-b. For example, the roaming indication and the indication of the AP BSSID may be transmitted via a vendor specific action frame. For example, if the personal audio device 210-c is within a close physical proximity of the personal wireless communication device 204-a, the AP 102-b serving the personal wireless communication device 204-a may be a good candidate AP for the personal audio device 210-c. In some examples, the personal wireless communication device 204-a may scan for neighboring APs 102 and may share the scan results with the personal audio device 210-c.

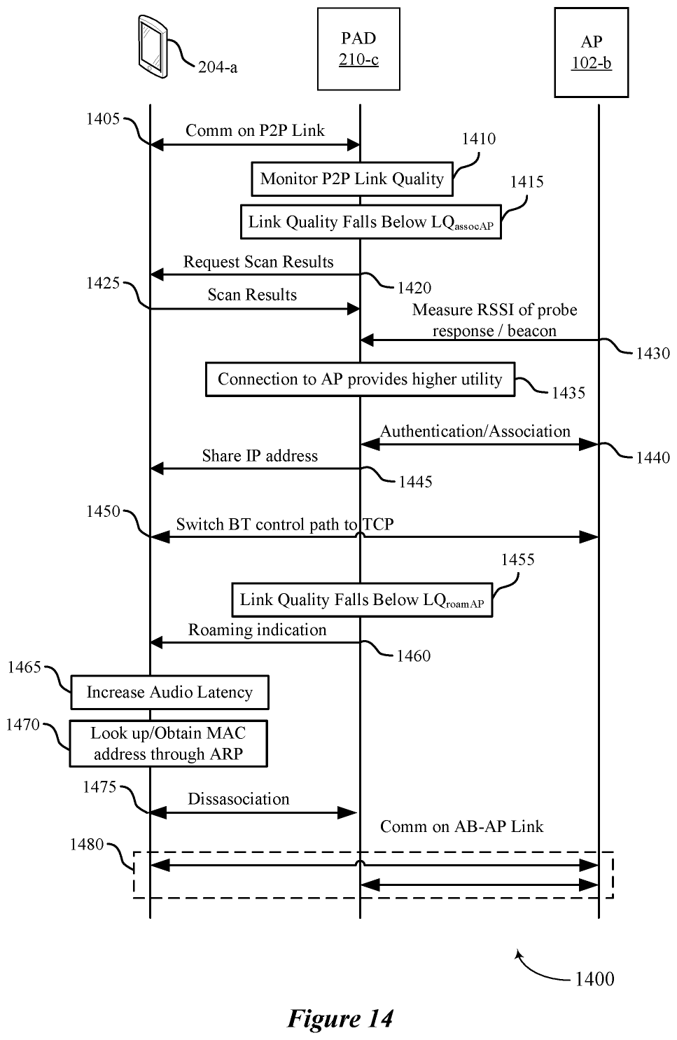

FIG. 14 illustrates an example of a process flow 1400 of a transition in an XPAN scenario between a P2P wireless connection and a personal audio device-AP connection. The process flow 1400 includes the AP 102-b, the personal wireless communication device 204-a, and the personal audio device 210-c described with reference to FIG. 3. In the following description of the process flow 1400, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 1400, and other operations may be added to the process flow 1400. As the transition illustrated in the process flow 1400 establishes a connection between the personal audio device 210-c and the AP 102-b before breaking the P2P connection between the personal audio device 210-c and the personal wireless communication device 204-a, the transition illustrated in the process flow 1400 may reduce latency and packet loss as compared to a transition from a P2P connection to an AP connection in which the connection to the AP is not established prior to breaking the P2P connection.

At 1405, the personal audio device 210-c may communicate with the personal wireless communication device 204-a via a P2P wireless communication link (such as the P2P wireless communication link 106-b of FIG. 13). At 1410, the personal audio device 210-c may monitor the link quality of the P2P wireless communication link. At 1415, the personal audio device 210-c may determine that the link quality of the P2P wireless communication link falls below the threshold LQ_{AssocAP}.

In some examples, at 1420 and in response to the determination that the link quality of the P2P wireless communication link falls below the threshold LQ_{AssocAP}, the personal audio device 210-c may transmit a request to the personal wireless communication device 204-a for the most recent channel scan results. Then at 1425, the personal wireless communication device 204-a may transmit the most recent channel scan results to the personal audio device 210-c. In an alternative example, at 1430 and in response to the determination that the link quality of the P2P wireless communication link falls below the threshold LQ_{AssocAP}, the personal audio device 210-c may measure the RSSI of a probe response or beacon from the AP 102-b.

At 1435, based on the channel scan results or the measured RSSI of the probe response/beacon, the personal audio device 210-c may determine that a connection to the AP 102-b provides a higher utility (based on a utility function as described herein) than the P2P wireless communication link. In some examples, if there is a second personal audio device (such as a second earbud), the personal audio device 210-c may share the target AP 102-b with the second personal audio device.

At 1440, the personal audio device 210-c may perform an association/authentication procedure with the AP 102-b. In some examples, the personal audio device 210-c may exchange security keys with the AP 102-b. At 1445, the personal audio device 210-c may share, with the personal wireless communication device 204-a, an IP address for the personal audio device 210-c received during the association/authentication procedure. At 1450, the personal wireless communication device 204-a may switch the BT control path for communications with the personal audio device 210-c over TCP.

At 1455, the personal audio device 210-c may determine that the link quality of the P2P wireless communication link 106-b drops below a second threshold (LQ_{roamAP}). At 1460, in response to the link quality of the P2P wireless communication link 106-b dropping below the second threshold (LQ_{roamAP}), the personal audio device 210-c may transmit a roaming indication to the personal wireless communication device 204-a. At 1465, in response to the roaming indication, the personal wireless communication device 204-a may increase audio latency. At 1470, in response to the roaming indication, the personal wireless communication device 204-a may look up the MAC address of the personal audio device 210-c or may obtain the MAC address of the personal audio device 210-c through ARP. In some examples, in response to the roaming indication, the personal wireless communication device 204-a may switch audio data from ethernet to UDP.

In some examples, at 1475, in response to the roaming indication, the personal wireless communication device 204-a and the personal audio device may disassociate/break the P2P wireless communication link (the P2P wireless communication link 106-b of FIG. 13).

At 1480, the personal wireless communication device 204-a and the personal audio device may communicate via the AP 102-b (via the wireless communication link 106-a and the wireless communication link 106-c of FIG. 13). For example, the personal wireless communication device 204-a may encapsulate audio data in UDP packets.

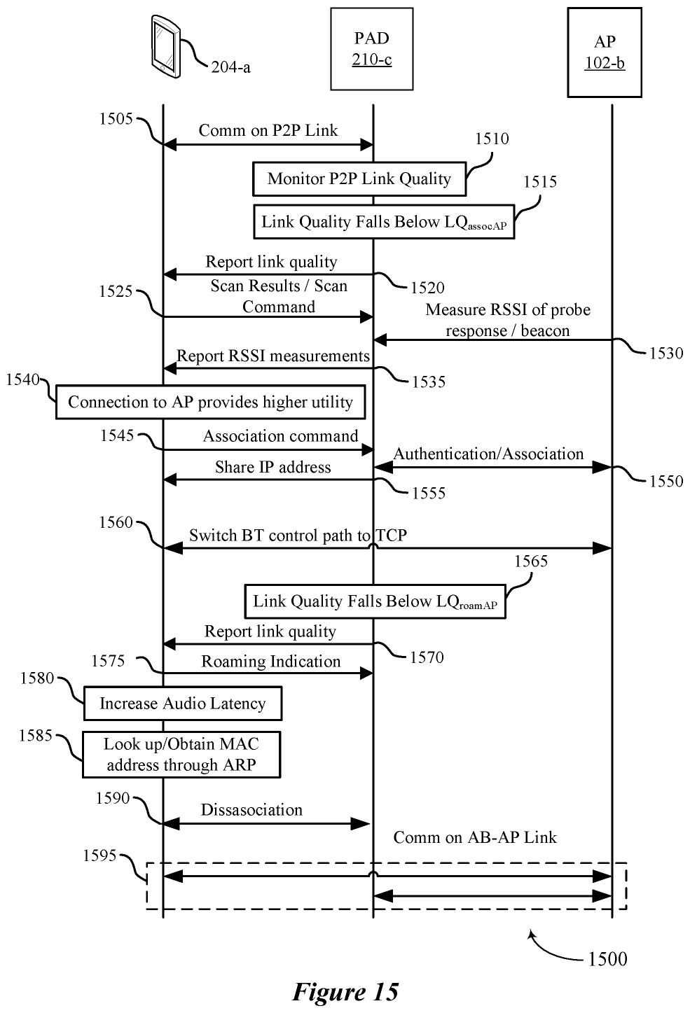

FIG. 15 illustrates an example of a process flow 1500 of a transition in an XPAN scenario between a P2P wireless connection at a first time and a personal audio device-AP connection, where the personal wireless communication device assists in the initiation of the transition. The process flow 1500 includes the AP 102-b, the personal wireless communication device 204-a, and the personal audio device 210-c described with reference to FIG. 3. In the following description of the process flow 1500, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 1500, and other operations may be added to the process flow 1500. As the transition illustrated in the process flow 1500 establishes a connection between the personal audio device 210-c and the AP 102-b before breaking the P2P connection between the personal audio device 210-c and the personal wireless communication device 204-a, the transition illustrated in the process flow 1500 may reduce latency and packet loss as compared to a transition from a P2P connection to an AP connection in which the connection to the AP is not established prior to breaking the P2P connection. Additionally, as the personal wireless communication device 204-a assists in the initiation of the transition, less processing may be performed at the personal audio device 210-c, which may reduce latency as the personal wireless communication device 204-a may have more processing power than the personal audio device 210-c and/or may reduce power consumption at the personal audio device 210-c.

At 1505, the personal audio device 210-c may communicate with the personal wireless communication device 204-a via a P2P wireless communication link (such as the P2P wireless communication link 106-b of FIG. 13). At 1510, the personal audio device 210-c may monitor the link quality of the P2P wireless communication link. At 1515, the personal audio device 210-c may determine that the link quality of the P2P wireless communication link falls below the threshold LQ_{AssocAP}.

At 1520, the personal audio device 210-c may transmit an indication of the link quality statistics of the P2P wireless communication link to the personal wireless communication device 204-a. At 1525, the personal wireless communication device 204-a may transmit either an indication of channel scan results at the personal wireless communication device 204-a or channel scan command to the personal audio device 210-c. At 1530, in response to a channel scan command, the personal audio device 210-c may measure the RSSI of a probe response or beacon from the AP 102-b. At 1535, the personal audio device 210-c may transmit the RSSI measurements to the personal wireless communication device 204-a. At 1540, the personal wireless communication device 204-a may determine that a connection to the AP 102-b provides a higher utility (based on a utility function as described herein) than the P2P wireless communication link. At 1545, in response to the determination that the connection to the AP 102-b provides a higher utility than the P2P wireless communication link, the personal wireless communication device 204-a transmits an association command to the personal audio device 210-c.

At 1550, the personal audio device 210-c may perform an association/authentication procedure with the AP 102-b. In some examples, the personal audio device 210-c may exchange security keys with the AP 102-b. At 1555, the personal audio device 210-c may share, with the personal wireless communication device 204-a, an IP address for the personal audio device 210-c received during the association/authentication procedure. At 1560, the personal wireless communication device 204-a may switch the BT control path for communications with the personal audio device 210-c over TCP.

At 1565, the personal audio device 210-c may determine that the link quality of the P2P wireless communication link 106-b drops below a second threshold (LQ_{roamAP}). At 1570, in response to the link quality of the P2P wireless communication link 106-b dropping below the second threshold (LQ_{roamAP}), the personal audio device 210-c may transmit an indication of the link quality dropping below the second threshold (LQ_{roamAP}) to the personal wireless communication device 204-a. In response, at 1575, the personal wireless communication device 204-a may transmit a roaming suggestion to the personal audio device 210-c. At 1580, in response to the roaming suggestion, the personal wireless communication device 204-a may increase audio latency. At 1585, in response to the roaming suggestion, the personal wireless communication device 204-a may look up the MAC address of the personal audio device 210-c or may obtain the MAC address of the personal audio device 210-c through ARP. In some examples, in response to the roaming suggestion, the personal wireless communication device 204-a may switch audio data from ethernet to UDP.

In some examples, at 1590, in response to the roaming suggestion, the personal wireless communication device 204-a and the personal audio device may disassociate/break the P2P wireless communication link (the P2P wireless communication link 106-b of FIG. 13).

At 1595, the personal wireless communication device 204-a and the personal audio device may communicate via the AP 102-b (via the wireless communication link 106-a and the wireless communication link 106-c of FIG. 13). For example, the personal wireless communication device 204-a may encapsulate audio data in UDP packets.

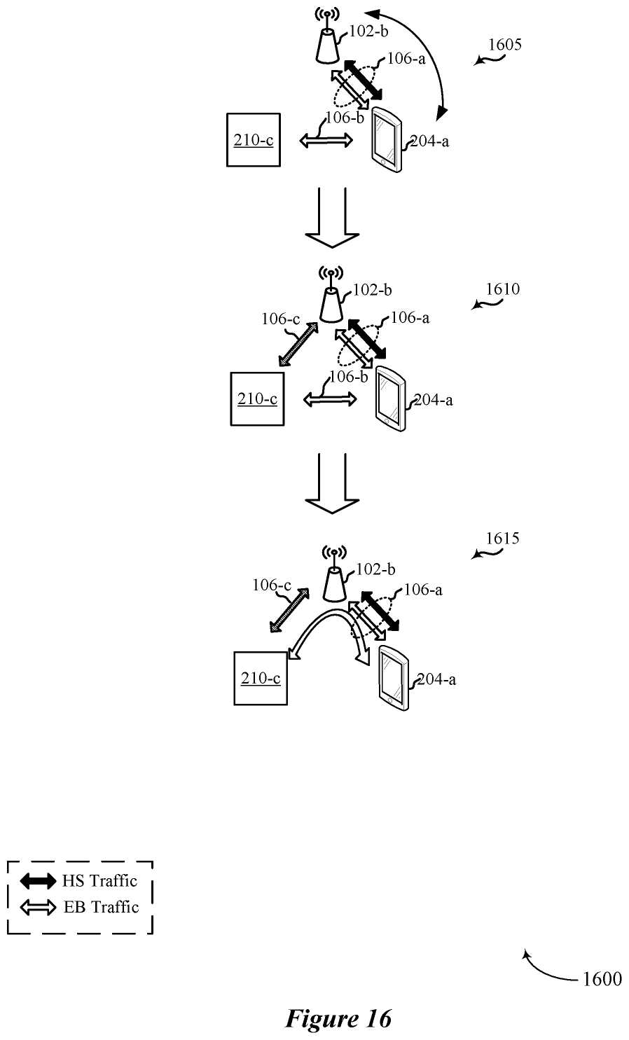

FIG. 16 illustrates an example of a transition in an XPAN scenario 1600 between a P2P wireless connection and a personal audio device-AP connection where the personal wireless communication device 204-a performs an association procedure with the AP 102-b for the personal audio device 210-c. The XPAN scenario 1600 includes the AP 102-b, the personal wireless communication device 204-a, and the personal audio device 210-c described with reference to FIG. 3. As the transition illustrated in the XPAN scenario 1600 establishes a connection between the personal audio device 210-c and the AP 102-b before breaking the P2P connection between the personal audio device 210-c and the personal wireless communication device 204-a, the transition illustrated in the XPAN scenario 1600 may reduce latency and packet loss as compared to a transition from a P2P connection to an AP connection in which the connection to the AP is not established prior to breaking the P2P connection. Additionally, as the personal wireless communication device 204-a establishes the AP connection for the personal audio device 210-c, less processing may be performed at the personal audio device 210-c, which may reduce latency as the personal wireless communication device 204-a may have more processing power than the personal audio device 210-c and/or may reduce power consumption at the personal audio device 210-c.

At 1605, the personal wireless communication device 204-a communicates audio data for relaying onto or from the personal audio device 210-c (shown as EB traffic) and other data specific to the personal wireless communication device 204-a (shown as HS traffic) with the AP 102-b via a communication link 106-b. At 1605, the personal wireless communication device 204-a communicates audio data (shown as EB traffic) via a direct P2P wireless communication link 106-b. The personal wireless communication device 204-a fakes or imitates an association with the AP 102-b using the MAC address for the personal audio device 210-c and the capabilities of the personal audio device 210-c (or two MAC addresses for two earbuds). For example, the personal wireless communication device 204-a may imitate the TA/RA addresses of the personal audio device 210-c. The personal wireless communication device 204-a shares the IP address with the personal audio device 210-c.

At 1610, the personal wireless communication device 204-a may listen to packets destined to the MAC address of the personal wireless communication device 204-a or the MAC address of the personal audio device 210-c. The personal audio device 210-c may monitor the link quality of the P2P wireless communication link 106-b and regularly share the link quality information with the personal wireless communication device 204-a via vendor specific action frames. The personal audio device 210-c may have dual connectivity at 1610 (via the P2P wireless communication link 106-b and the wireless communication link 106-c established by the personal wireless communication device 204-a faking the association with the AP 102-c using the MAC address of the personal audio device 210-c. The personal wireless communication device 204-a may also monitor the link quality of the P2P wireless communication link 106-b via uplink transmissions. If the personal wireless communication device 204-a determines that the link quality of the P2P wireless communication link 106-b drops below a first threshold (LQ_{AssocAP}), the personal wireless communication device 204-a may transmit a roaming indication to the personal audio device 210-c. In some examples, the personal wireless communication device 204-a may perform a channel scan (or use recent channel scan results) and share the channel scan results with the personal audio device 210-c. In some cases, the personal wireless communication device 204-a may share the BSSID of the associated AP (the AP 102-b), the channel of the AP 102-b, and capabilities of the AP 102-b. The personal audio device 210-c may calculate a utility function for the P2P connection versus APs in the vicinity of the personal audio device 210-c.

If the link quality of the P2P wireless communication link 106-b drops below a second threshold (LQ_{roamAP}), the personal audio device 210-c may transmit a roaming indication to the personal wireless communication device 204-a. In response to the roaming indication, the personal wireless communication device 204-a may increase audio latency to handle latency across the network.

At 1615, the personal wireless communication device 204-a switches audio data from ethernet to UDP, and the personal wireless communication device 204-a transfers audio data to the personal audio device 210-c via the AP 102-b (via the wireless communication link 106-a and the wireless communication link 106-c). In some examples, in response to the roaming indication, the personal wireless communication device 204-a and the personal audio device may disassociate/break the P2P wireless communication link 106-b and the personal wireless communication device 204-a may forward data to the personal audio device 210-c through the AP 102-b using the IP and MAC addresses of the personal audio device 210-c.

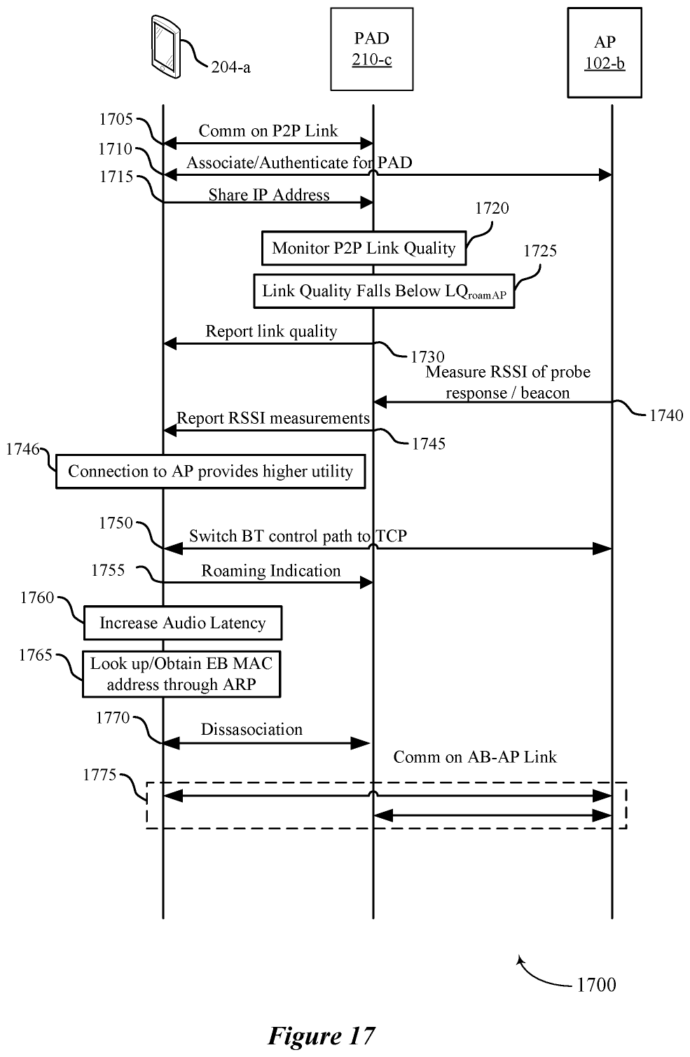

FIG. 17 illustrates an example of a process flow 1700 of a transition in an XPAN scenario between a P2P wireless connection and a personal audio device-AP connection where the personal wireless communication device 204-a performs an association procedure with the AP 102-b for the personal audio device 210-c. The process flow 1700 includes the AP 102-b, the personal wireless communication device 204-a, and the personal audio device 210-c described with reference to FIG. 3. In the following description of the process flow 1700, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 1700, and other operations may be added to the process flow 1700. As the transition illustrated in the process flow 1700 establishes a connection between the personal audio device 210-c and the AP 102-b before breaking the P2P connection between the personal audio device 210-c and the personal wireless communication device 204-a, the transition illustrated in the process flow 1700 may reduce latency and packet loss as compared to a transition from a P2P connection to an AP connection in which the connection to the AP is not established prior to breaking the P2P connection. Additionally, as the personal wireless communication device 204-a establishes the AP connection for the personal audio device 210-c, less processing may be performed at the personal audio device 210-c, which may reduce latency as the personal wireless communication device 204-a may have more processing power than the personal audio device 210-c and/or may reduce power consumption at the personal audio device 210-c.

At 1705, the personal audio device 210-c may communicate with the personal wireless communication device 204-a via a P2P wireless communication link (such as the P2P wireless communication link 106-b of FIG. 13).

At 1710, the personal wireless communication device 204-a may perform an authentication/association procedure with the AP 102-b for the personal audio device 210-c. In some examples, the personal wireless communication device 204-a may exchange security keys with the AP 102-b for the personal audio device 210-c. At 1715, the personal wireless communication device 204-a may share the IP address for the personal audio device 210-c received during the authentication/association procedure at 1710.

At 1720, the personal audio device 210-c may monitor the link quality of the P2P wireless communication link. At 1725, the personal audio device 210-c may determine that the link quality of the P2P wireless communication link falls below the threshold LQ_{AssocAP}.

At 1730, the personal audio device 210-c may transmit an indication of the link quality statistics of the P2P wireless communication link to the personal wireless communication device 204-a. At 1740, the personal audio device 210-c may measure the RSSI of a probe response or beacon from the AP 102-b. At 1745, the personal audio device 210-c may transmit the RSSI measurements to the personal wireless communication device 204-a.

At 1746, the personal wireless communication device 204-a may determine that a connection to the AP 102-b provides a higher utility (based on a utility function as described herein) than the P2P wireless communication link. At 1750, the personal wireless communication device 204-a may switch the BT control path for communications with the personal audio device 210-c over TCP. At 1755, in response to the determination that the connection to the AP 102-b provides a higher utility than the P2P wireless communication link, the personal wireless communication device 204-a transmits a roaming indication to the personal audio device 210-c.

A 1760, in response to the roaming indication, the personal wireless communication device 204-a may increase audio latency. At 1765, in response to the roaming indication, the personal wireless communication device 204-a may look up the MAC address of the personal audio device 210-c or may obtain the MAC address of the personal audio device 210-c through ARP. In some examples, in response to the roaming indication, the personal wireless communication device 204-a may switch audio data from ethernet to UDP.

In some examples, at 1770, in response to the roaming indication, the personal wireless communication device 204-a and the personal audio device may disassociate/break the P2P wireless communication link (the P2P wireless communication link 106-b of FIG. 13).

At 1775, the personal wireless communication device 204-a and the personal audio device may communicate via the AP 102-b (via the wireless communication link 106-a and the wireless communication link 106-c of FIG. 16). For example, the personal wireless communication device 204-a may encapsulate audio data in UDP packets.

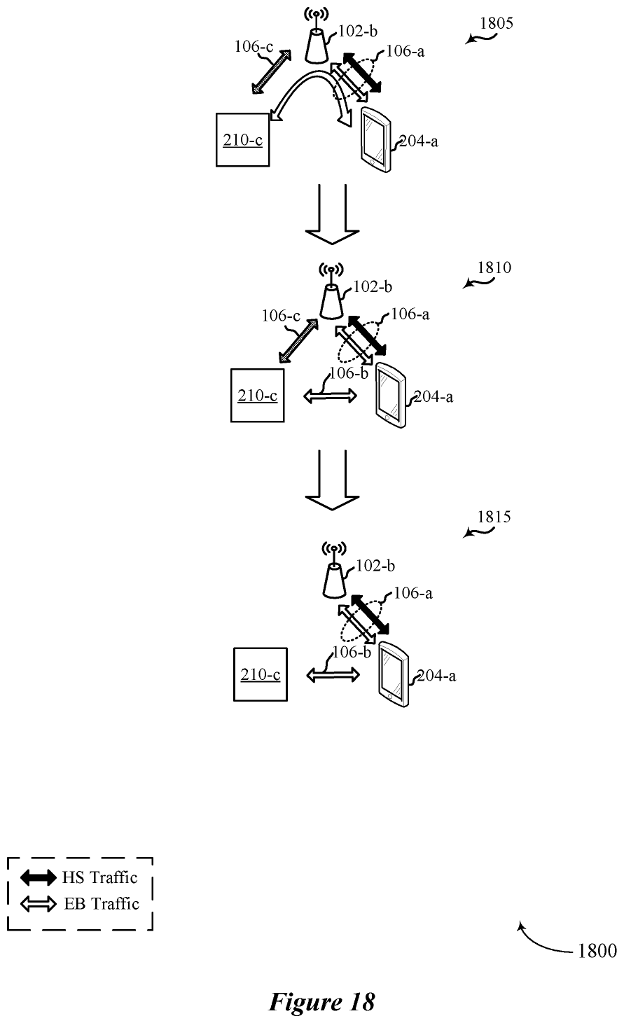

FIG. 18 illustrates an example of a transition in an XPAN scenario 1800 between a personal audio device-AP connection and a P2P wireless connection. The XPAN scenario 1800 includes the AP 102-b, the personal wireless communication device 204-a, and the personal audio device 210-c described with reference to FIG. 3. As the transition illustrated in the XPAN scenario 1800 establishes a P2P connection between the personal audio device 210-c and the personal wireless communication device 204-a before breaking the connection between the personal audio device 210-c and the AP 102-b, the transition illustrated in the XPAN scenario 1800 may reduce latency and packet loss as compared to a transition from a personal audio device-AP connection to P2P connection in which the P2P connection is not established prior to breaking the personal audio device-AP connection.

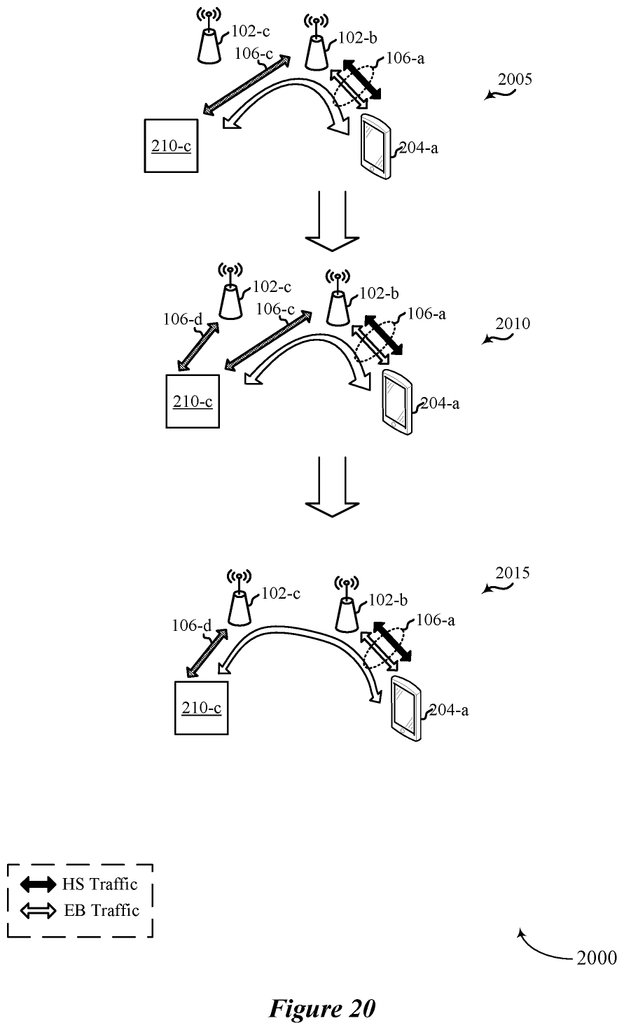

When the personal audio device 210-c is connected to an AP 102-b and the link quality degrades as the user is moving away from the serving AP 102-b two potential scenarios may arise. In a first scenario, shown in FIGS. 5 and 20, the personal audio device 210-c may move into the coverage of another AP 102 within the same network of the current AP 102-b/personal wireless communication device 204-a. For example, the other AP 102 may be another mesh node or a range extender in a home mesh network, or another BSS in the same ESS. In the second scenario, shown in FIGS. 4 and 18, the user may be moving back into the coverage of the personal wireless communication device 204-a. One solution may be that when the personal audio device 210-c moves back into the coverage of the personal wireless communication device 204-a, and both are in a reasonable range of the serving AP 102-b, the personal audio device 210-c may stay connected to the serving AP 102-b, though doing so may result in higher power consumption as compared to connecting directly to the personal wireless communication device 204-a. The second solution may be to switch back to the direct P2P wireless communication link with the personal wireless communication device 204-a.

In some examples, for example as shown in FIGS. 13 and 16, once the personal audio device 210-c is outside of the direct coverage of the personal wireless communication device 204-a, the personal wireless communication device 204-a may terminate the soft AP (SAP) link that was used for the XPAN P2P wireless communication link with the personal audio device 210-c, and the personal wireless communication device 204-a may stop beaconing on that channel. In some examples, the personal audio device 210-c may start the connection to the AP 102-b directly outside the range of the personal wireless communication device 204-a (such as by initiating a call through a voice assistance command from a distance).

To obtain RSSI at the personal audio device 210-c from the personal wireless communication device 204-a, in some examples, if a previous P2P wireless communication link 106-b with the personal wireless communication device 204-a was established, the personal wireless communication device 204-a may maintain the SAP link for DTIM beaconing on the same channel for the duration of the XPAN session for the personal audio device 210-c. The personal wireless communication device 204-a may reduce the periodicity of DTIM beaconing to save power/concurrency time. In some examples, if the link quality of the P2P wireless communication link 106-b exceeds a link quality threshold (such as based on the DTIM beaconing), the personal audio device 210-c may switch to the channel on which the personal wireless communication device 204-a is transmitting the DTIM beacons (the prior SAP channel). In some examples, if the link quality of the wireless communication link 106-c with the AP 102-b falls below a link quality threshold, the personal audio device 210-c may switch to the channel on which the personal wireless communication device 204-a is transmitting the DTIM beacons (the prior SAP channel), if the link quality of the P2P wireless communication link 106-b exceeds a link quality threshold (such as based on the DTIM beaconing).

In some examples, to obtain RSSI at the personal audio device 210-c from the personal wireless communication device 204-a, the personal audio device 210-c may transmit an indication to the personal wireless communication device 204-a via the AP 102-b that the link quality of the wireless communication link 106-c with the AP 102-b has fallen below a threshold and that the personal audio device 210-c is evaluating a direct connection to the personal wireless communication device 204-a. In some examples, the indication may be sent using an uplink Vendor-Specific Action Frame to the personal wireless communication device 204-a through the AP 102-b, TCP control link, or in a Real-time Transport Protocol (RTP) header. The personal wireless communication device 204-a may communicate, to the personal audio device 210-c over Wi-Fi through the AP 102-b, scheduling information for beacons, such as a specific channel on which the personal wireless communication device 204-a is intending to transmit beacons (if the SAP link was terminated) and a time/periodicity of when the beacons will be transmitted, and/or a TBTT of the next beacon. The personal audio device 210-c may listen to the beacons on the indicated channel to measure the current RSSI of the P2P wireless communication link 106-b. Alternatively, the personal wireless communication device 204-a may indicate to the personal audio device 210-c a specific channel and a listen schedule, and the personal audio device 210-c may transmit a probe request on that channel. In response to the probe request, the personal wireless communication device 204-a may transmit a probe response to the personal audio device 210-c.

In some examples, to obtain RSSI at the personal audio device 210-c from the personal wireless communication device 204-a, the personal audio device 210-c may check if the personal audio device 210-c is in BT coverage of the personal wireless communication device 204-a, and if so, the personal audio device 210-c may send a proprietary indication over BT to indicate the intent of the personal audio device 210-c to roam back to the P2P wireless communication link 106-b. The personal wireless communication device 204-a may communicate over BT to the personal audio device 210-c an indication of a specific channel on which the personal wireless communication device 204-a is intending to send beacons (if the SAP link was terminated) and a time/periodicity of when the beacons will be sent. The personal audio device 210-c may listen to the beacons on the indicated channel to measure the current RSSI of the P2P wireless communication link 106-b.

As shown in FIG. 18, at 1805, the personal audio device 210-c may communicate with the personal wireless communication device 204-a via the AP 102-b (via the wireless communication link 106-c between the personal audio device 210-c and the AP 102-b and the wireless communication link 106-a between the AP 102-b and the personal wireless communication device 204-a). The personal audio device 210-c may monitor the link quality of the wireless communication link 106-c. If the link quality of the wireless communication link 106-c drops below a first threshold (LQ_{assocAP}) the personal audio device 210-c may transmit a roaming indication to the personal wireless communication device 204-a through Wi-Fi via the AP 102-b or through BT if in BT range of the personal wireless communication device 204-a. The personal audio device 210-c may measure RSSI of a beacon or probe response from the personal wireless communication device 204-a on an SAP channel. The personal audio device 210-c may calculate a utility function for the direct P2P wireless connection based on the RSSI of the beacon or probe response versus the wireless communication link 106-c.

At 1810, if roaming to the P2P wireless connection provides a better utility function, then the personal audio device 210-c may perform an association/authentication procedure with the personal wireless communication device 204-a to establish the P2P wireless communication link 106-b. At 1810, the personal audio device 210-c may be connected to both the personal wireless communication device 204-a via the P2P wireless communication link 106-b and the AP 102-b via the wireless communication link 106-c. If the link quality of the wireless communication link 106-c falls below a second threshold (LQ_{roamHS}), the personal audio device 210-c may deauthenticate/disassociate with the AP 102-b. Accordingly, at 1815, the personal audio device 210-c has a single connection, the P2P wireless communication link 106-b, and the personal wireless communication device 204-a transfers data on the SAP link (the P2P wireless communication link 106-b) directly to the personal audio device 210-c.

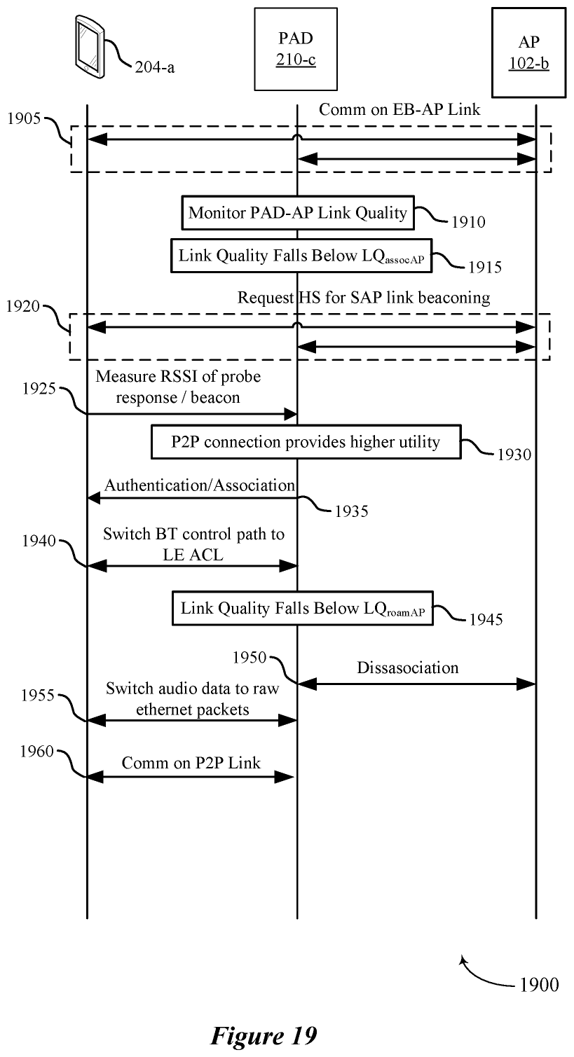

FIG. 19 illustrates an example of a process flow 1900 of a transition in an XPAN scenario between a personal audio device-AP connection and a P2P wireless connection. The process flow 1900 includes the AP 102-b, the personal wireless communication device 204-a, and the personal audio device 210-c described with reference to FIG. 3. In the following description of the process flow 1900, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 1900, and other operations may be added to the process flow 1900. As the transition illustrated in the process flow 1900 establishes a P2P connection between the personal audio device 210-c and the personal wireless communication device 204-a before breaking the connection between the personal audio device 210-c and the AP 102-b, the transition illustrated in the process flow 1900 may reduce latency and packet loss as compared to a transition from a personal audio device-AP connection to P2P connection in which the P2P connection is not established prior to breaking the personal audio device-AP connection.

At 1905, the personal wireless communication device 204-a and the personal audio device 210-c may communicate via the AP 102-b (via the wireless communication link 106-a and the wireless communication link 106-c of FIG. 18). For example, the personal wireless communication device 204-a may encapsulate audio data in UDP packets. At 1910, the personal audio device 210-c may monitor the link quality of the wireless communication link between the personal audio device 210-c and the AP 102-b (the wireless communication link 106-c of FIG. 18). At 1915, the personal audio device 210-c may determine that the link quality of the wireless communication link between the personal audio device 210-c and the AP 102-b link drops below a first threshold (LQ_{assocAP}).

In response to the link quality of the wireless communication link between the personal audio device 210-c and the AP 102-b link dropping below the first threshold (LQ_{assocAP}), at 1920, if the personal wireless communication device 204-a stopped beacons over the SAP link, the personal audio device 210-c transmits a request to the personal wireless communication device 204-a (via Wi-Fi through the AP 102-b or via BT) for beaconing or transmits a probe request. At 1925, the personal audio device 210-c measures the RSSI of the beacon or probe response transmitted by the personal wireless communication device 204-a on the SAP link. At 1930, the personal audio device 210-c determines that the direct P2P connection to the personal wireless communication device 204-a provides a higher utility than the connection through the AP 102-b via the wireless communication link between the personal audio device 210-c and the AP 102-b. In scenarios where there are two personal audio devices (such as two earbuds), the primary personal audio device 210-c may share the determination that the direct P2P connection to the personal wireless communication device 204-a provides a higher utility than the connection through the AP 102-b via the wireless communication link between the personal audio device 210-c and the AP 102-b.

In response to the determination at 1930, at 1935, the personal audio device 210-c performs an association procedure with the personal wireless communication device 204-a. At 1940, the personal wireless communication device 204-a switches the BT control path to low energy (LE) Asynchronous Connection-oriented Logical transport (ACL).

At 1945, the personal audio device 210-c may determine that the link quality of the wireless communication link between the personal audio device 210-c and the AP 102-b link drops below a second threshold (LQ_{roamHS}). In response to the link quality of the wireless communication link between the personal audio device 210-c and the AP 102-b link dropping below the second threshold (LQ_{roamHS}), at 1950, the personal audio device 210-c may disassociate from/deauthenticate with AP 102-b.

At 1955, the personal wireless communication device 204-a may switch audio data to raw ethernet packets. At 1960, the personal audio device 210-c may communicate with the personal wireless communication device 204-a via the P2P wireless communication link (such as the P2P wireless communication link 106-b of FIG. 18).

FIG. 20 illustrates an example of a transition in an XPAN scenario 2000 between a personal audio device-first AP connection and a personal audio device-second AP connection. The XPAN scenario 2000 includes the AP 102-b, the personal wireless communication device 204-a, and the personal audio device 210-c described with reference to FIG. 3. The XPAN scenario 2000 further includes an AP 102-c, which may be an example of an AP 102 as described herein. As the transition illustrated in the XPAN scenario 2000 establishes a connection between the personal audio device 210-c and the second AP 102-c before breaking the connection between the personal audio device 210-c and the AP 102-b, the transition illustrated in the XPAN scenario 2000 may reduce latency and packet loss as compared to a transitions between APs in which a connection to a new AP is not made until a connection to a current AP is broken.

At 2005, the personal audio device 210-c may communicate with the personal wireless communication device 204-a via the AP 102-b (via the wireless communication link 106-c between the personal audio device 210-c and the AP 102-b and the wireless communication link 106-a between the AP 102-b and the personal wireless communication device 204-a). The personal audio device 210-c may monitor the link quality of the wireless communication link 106-c. If the link quality of the wireless communication link 106-c drops below a first threshold (LQ_{assocAP}) the personal audio device 210-c may transmit a roaming indication to the personal wireless communication device 204-a through Wi-Fi via the AP 102-b or through BT if in BT range of the personal wireless communication device 204-a. The personal audio device 210-c may measure RSSI of a beacon or probe response from the personal wireless communication device 204-a on an SAP channel. The personal audio device 210-c may calculate a utility function for the direct P2P wireless connection based on the RSSI of the beacon or probe response versus the wireless communication link 106-c.

If roaming to the P2P wireless connection does not provide a better utility function, then the personal audio device 210-c may begin scanning for other APs. In some cases, the personal audio device 210-c may limit scanning to a set of channels to control power consumption at the personal audio device 210-c. The set of channels may be obtained from previous recent scans by the personal audio device 210-c or may be regularly communicated from the personal wireless communication device 204-a (noting that channel scan results at the personal wireless communication device 204-a may be different than channel scan results at the personal audio device 210-c). If roaming to another AP 102-c provides a better utility function than the wireless communication link 106-c, then the personal audio device 210-c performs an association/authentication procedure with the other AP 102-c.

Accordingly, at 2010, the personal audio device 210-c receives an IP address from the AP 102-c and establishes a wireless communication link 106-d with the AP 102-c. The personal audio device 210-c shares the IP address for the personal audio device 210-c for the wireless communication link 106-d with the personal wireless communication device 204-a via the AP 102-b (via the wireless communication link 106-c between the personal audio device 210-c and the AP 102-b and the wireless communication link 106-a between the AP 102-b and the personal wireless communication device 204-a). For example, the IP address may be shared via a vendor-specific action frame. At 2010, the personal audio device 210-c is connected to the AP 102-c via the wireless communication link 106-d and the AP 102-b via the wireless communication link 106-c. If the link quality of the wireless communication link 106-c falls below a second threshold falls below a second threshold (LQ_{roamHS}), the personal audio device 210-c may transmit a roaming indication to personal wireless communication device 204-a via the AP 102-b (via the wireless communication link 106-c between the personal audio device 210-c and the AP 102-b and the wireless communication link 106-a between the AP 102-b and the personal wireless communication device 204-a) and may deauthenticate/disassociate with the AP 102-b.

Accordingly, at 2015, the personal audio device 210-c may have a single connection (the wireless communication link 106-d with the AP 102-c), and the personal audio device 210-c may communicate with the personal wireless communication device 204-a through the AP 102-c (via the wireless communication link 106-d, a wireless communication link between the AP 102-c and the AP 102-b, and the wireless communication link 106-a). For example, the network may route packets from the personal wireless communication device 204-a through the multiple hops to the personal audio device 210-c. In some examples, precedence may be given to roaming to the personal wireless communication device 204-a to avoid increased latency associated with multiple hops, and power saving enabled by TWT of the P2P XPAN link. In some examples, the same precedence may be given to roaming to the personal wireless communication device 204-a or another AP 102.

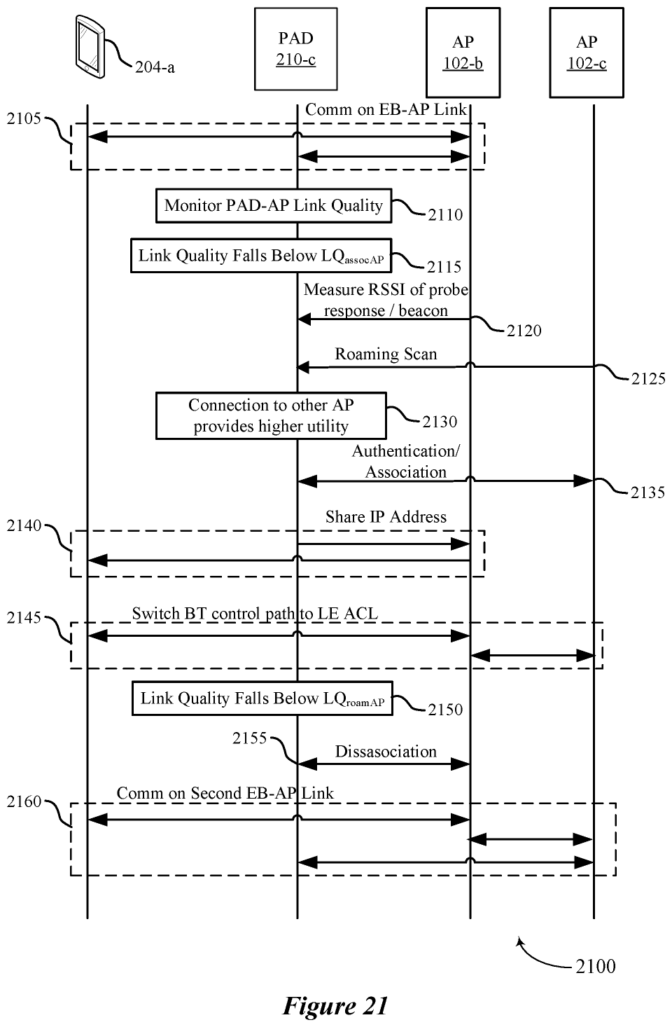

FIG. 21 illustrates an example of a process flow 2100 of a transition between a personal audio device-first AP connection and a personal audio device-second AP connection. The process flow 2100 includes the AP 102-b, the personal wireless communication device 204-a, and the personal audio device 210-c described with reference to FIG. 3. The process flow 2100 further includes an AP 102-c, which may be an example of an AP 102 as described herein. In the following description of the process flow 2100, the operations between the AP 102-b, the AP 102-c, the personal wireless communication device 204-a, and the personal audio device 210-c may be transmitted in a different order than the example order shown, or the operations performed by the AP 102-b, the AP 1-2-c, the personal wireless communication device 204-a, and the personal audio device 210-c may be performed in different orders or at different times. Some operations may also be omitted from the process flow 2100, and other operations may be added to the process flow 2100. As the transition illustrated in the process flow 2100 establishes a connection between the personal audio device 210-c and the second AP 102-c before breaking the connection between the personal audio device 210-c and the AP 102-b, the transition illustrated in the process flow 2100 may reduce latency and packet loss as compared to a transitions between APs in which a connection to a new AP is not made until a connection to a current AP is broken.

At 2105, the personal wireless communication device 204-a and the personal audio device 210-c may communicate via the AP 102-b (via the wireless communication link 106-a and the wireless communication link 106-c of FIG. 20). For example, the personal wireless communication device 204-a may encapsulate audio data in UDP packets. At 2110, the personal audio device 210-c may monitor the link quality of the wireless communication link between the personal audio device 210-c and the AP 102-b (the wireless communication link 106-c of FIG. 20). At 2115, the personal audio device 210-c may determine that the link quality of the wireless communication link between the personal audio device 210-c and the AP 102-b link drops below a first threshold (LQ_{assocAP}).

At 2120, the personal audio device 210-c may measure the RSSI of a probe response or beacon from the AP 102-b. At 2125, the personal audio device 210-c may perform a roaming scan on a set of channels (for a set of APs including the AP 102-c). For example, the personal audio device 210-c may measure the respective RSSIs for the set of channels. At 2130, the personal audio device 210-c may determine that connection to the AP 102-c provides a higher utility function than connection to the AP 102-b. In scenarios where there are two personal audio devices (such as two earbuds), the primary personal audio device 210-c may share the determination that connection to the AP 102-c provides a higher utility function than connection to the AP 102-b.

At 2135, in response to the determination at 2130, the personal audio device 210-c may perform an authentication/association procedure with the AP 102-c. Accordingly, the personal audio device 210-c receives an IP address from the AP 102-c and establishes a wireless communication link with the AP 102-c. At 2140, the personal audio device 210-c shares the IP address for the personal audio device 210-c for the wireless communication link between the personal audio device 210-c and the AP 102-c with the personal wireless communication device 204-a via the AP 102-b (via the wireless communication link between the personal audio device 210-c and the AP 102-b and the wireless communication link between the AP 102-b and the personal wireless communication device 204-a).

At 2145, the personal wireless communication device 204-a switches the BT control path to LE ACL. At 2150, the personal audio device 210-c determines that the link quality of the wireless communication link between the personal audio device 210-c and the AP 102-b link drops below a second threshold (LQ_{roamHS}). In response to the link quality of the wireless communication link between the personal audio device 210-c and the AP 102-b link dropping below the second threshold (LQ_{roamHS}), at 2155, the personal audio device 210-c may disassociate from/deauthenticate with AP 102-b.

Accordingly, at 2160, the personal audio device 210-c may have a single connection (the wireless communication link with the AP 102-c), and the personal audio device 210-c may communicate with the personal wireless communication device 204-a through the AP 102-c via multiple hops.

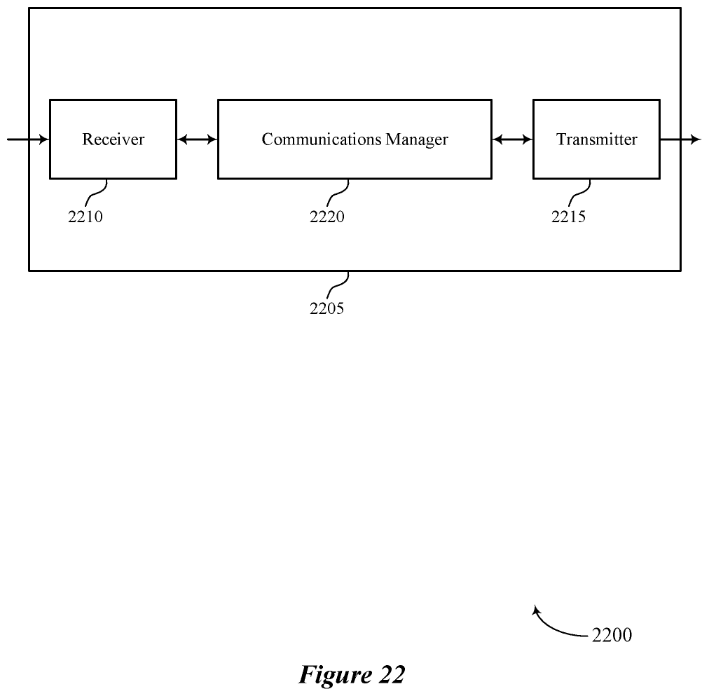

FIG. 22 illustrates a block diagram 2200 of a device 2205 that supports seamless transitions for XPAN coverage in accordance with one or more aspects of the present disclosure. The device 2205 may be an example of aspects of an STA as described herein (such as a personal wireless communication device 204 or a personal audio device 210 as described herein). The device 2205 may include a receiver 2210, a transmitter 2215, and a communications manager 2220. The device 2205 may also include a processor. Each of these components may be in communication with one another (such as via one or more buses).

The receiver 2210 may provide a means for receiving information such as packets, user data, control information, or any combination thereof associated with various information channels (such as control channels, data channels, information channels related to seamless transitions for XPAN coverage). Information may be passed on to other components of the device 2205. The receiver 2210 may utilize a single antenna or a set of multiple antennas.

The transmitter 2215 may provide a means for transmitting signals generated by other components of the device 2205. For example, the transmitter 2215 may transmit information such as packets, user data, control information, or any combination thereof associated with various information channels (such as control channels, data channels, information channels related to seamless transitions for XPAN coverage). In some examples, the transmitter 2215 may be co-located with a receiver 2210 in a transceiver module. The transmitter 2215 may utilize a single antenna or a set of multiple antennas.

The communications manager 2220, the receiver 2210, the transmitter 2215, or various combinations thereof or various components thereof may be examples of means for performing various aspects of seamless transitions for XPAN coverage as described herein. For example, the communications manager 2220, the receiver 2210, the transmitter 2215, or various combinations or components thereof may support a method for performing one or more of the functions described herein.

In some examples, the communications manager 2220, the receiver 2210, the transmitter 2215, or various combinations or components thereof may be implemented in hardware (such as in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (such as by executing, by the processor, instructions stored in the memory).

Additionally, or alternatively, in some examples, the communications manager 2220, the receiver 2210, the transmitter 2215, or various combinations or components thereof may be implemented in code (such as communications management software or firmware) executed by a processor. If implemented in code executed by a processor, the functions of the communications manager 2220, the receiver 2210, the transmitter 2215, or various combinations or components thereof may be performed by a general-purpose processor, a DSP, a CPU, an ASIC, an FPGA, a microcontroller, or any combination of these or other programmable logic devices (such as configured as or otherwise supporting a means for performing the functions described in the present disclosure).

In some examples, the communications manager 2220 may be configured to perform various operations (such as receiving, obtaining, monitoring, outputting, transmitting) using or otherwise in cooperation with the receiver 2210, the transmitter 2215, or both. For example, the communications manager 2220 may receive information from the receiver 2210, send information to the transmitter 2215, or be integrated in combination with the receiver 2210, the transmitter 2215, or both to obtain information, output information, or perform various other operations as described herein.

The communications manager 2220 may support wireless communications at a first wireless communication device in accordance with examples as disclosed herein. For example, the communications manager 2220 may be configured as or otherwise support a means for receiving, while in communication with a second wireless communication device on a P2P wireless communication link and from an AP associated with the second wireless communication device, an IP address for the first wireless communication device for a second wireless communication link between the first wireless communication device and the AP. The communications manager 2220 may be configured as or otherwise support a means for responsive to a first link quality of the P2P wireless communication link falling below a first threshold, communicating a roaming indication with the second wireless communication device on the P2P wireless communication link. The communications manager 2220 may be configured as or otherwise support a means for responsive to the roaming indication, communicating data with the second wireless communication device via the second wireless communication link, and the AP.

Additionally, or alternatively, the communications manager 2220 may support wireless communications at a second wireless communication device in accordance with examples as disclosed herein. For example, the communications manager 2220 may be configured as or otherwise support a means for receiving, while in communication with a first wireless communication device on a P2P wireless communication link, and while in communication with an AP on a third wireless communication link, an IP address from the first wireless communication device for the first wireless communication device for a second wireless communication link between the first wireless communication device and the AP. The communications manager 2220 may be configured as or otherwise support a means for responsive to a first link quality of the P2P wireless communication link between the first wireless communication device and the second wireless communication device falling below a first threshold, communicating a roaming indication with the first wireless communication device on the P2P wireless communication link. The communications manager 2220 may be configured as or otherwise support a means for responsive to the roaming indication, communicating data with the first wireless communication device via the third wireless communication link and the AP using the IP address for the first wireless communication device.

Additionally, or alternatively, the communications manager 2220 may support wireless communications at a first wireless communication device in accordance with examples as disclosed herein. For example, the communications manager 2220 may be configured as or otherwise support a means for receiving, while in communication with a second wireless communication device on a P2P wireless communication link and from the second wireless communication device, an indication of an IP address for the first wireless communication device for a second wireless communication link between the first wireless communication device and an AP associated with the second wireless communication device. The communications manager 2220 may be configured as or otherwise support a means for responsive to a first link quality of the P2P wireless communication link falling below a first threshold, communicating a roaming indication with the second wireless communication device on the P2P wireless communication link. The communications manager 2220 may be configured as or otherwise support a means for responsive to the roaming indication, communicating data with the second wireless communication device via the second wireless communication link, and the AP.

Additionally, or alternatively, the communications manager 2220 may support wireless communications at a second wireless communication device in accordance with examples as disclosed herein. For example, the communications manager 2220 may be configured as or otherwise support a means for performing, while in communication with a first wireless communication device on a P2P wireless communication link, and while in communication with an AP on a third wireless communication link, an association procedure with an AP using a MAC address for the first wireless communication device to receive an IP address for the first wireless communication device for a second wireless communication link between the first wireless communication device and the AP. The communications manager 2220 may be configured as or otherwise support a means for transmitting, to the first wireless communication device on the P2P wireless communication link, the IP address. The communications manager 2220 may be configured as or otherwise support a means for responsive to a link quality of a P2P wireless communication link between the first wireless communication device and the second wireless communication device falling below a first threshold, communicating a roaming indication with the first wireless communication device on the P2P wireless communication link. The communications manager 2220 may be configured as or otherwise support a means for responsive to the roaming indication, communicating data with the first wireless communication device via the third wireless communication link and the AP using the IP address for the first wireless communication device.

Additionally, or alternatively, the communications manager 2220 may support wireless communications at a first wireless communication device in accordance with examples as disclosed herein. For example, the communications manager 2220 may be configured as or otherwise support a means for receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link. The communications manager 2220 may be configured as or otherwise support a means for responsive to a first link quality of the P2P wireless communication link satisfying a first threshold, the first link quality detected using the beacon or the probe response, performing an association procedure with the second wireless communication device for the P2P wireless communication link. The communications manager 2220 may be configured as or otherwise support a means for transmitting, in response to the association procedure, a disassociation message to the AP for the second wireless communication link. The communications manager 2220 may be configured as or otherwise support a means for communicating data with the second wireless communication device on the P2P wireless communication link.

Additionally, or alternatively, the communications manager 2220 may support wireless communications at a second wireless communication device in accordance with examples as disclosed herein. For example, the communications manager 2220 may be configured as or otherwise support a means for transmitting, while in communication with a first wireless communication device via a third wireless communication link between the second wireless communication device and an AP and via the AP and a second wireless communication link between the first wireless communication device and the AP, a beacon or a probe response on a P2P wireless communication link. The communications manager 2220 may be configured as or otherwise support a means for responsive to a link quality of the P2P wireless communication link satisfying a threshold, performing an association procedure with the first wireless communication device for the P2P wireless communication link. The communications manager 2220 may be configured as or otherwise support a means for communicating data with the first wireless communication device on the P2P wireless communication link.

Additionally, or alternatively, the communications manager 2220 may support wireless communications at a first wireless communication device in accordance with examples as disclosed herein. For example, the communications manager 2220 may be configured as or otherwise support a means for responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link. The communications manager 2220 may be configured as or otherwise support a means for responsive to a second link quality of the second wireless communication link being higher than the first link quality, performing an association procedure with the second AP to receive an IP address for the first wireless communication device for the second wireless communication link. The communications manager 2220 may be configured as or otherwise support a means for transmitting, in response to the association procedure and to the second wireless communication device, an indication of the IP address via the first wireless communication link and the first AP. The communications manager 2220 may be configured as or otherwise support a means for transmitting, in response to transmission of the IP address, a disassociation message to the first AP for the first wireless communication link. The communications manager 2220 may be configured as or otherwise support a means for responsive to transmission of the disassociation message, communicating data with the second wireless communication device via the second wireless communication link, and the second AP.

Additionally, or alternatively, the communications manager 2220 may support wireless communications at a second wireless communication device in accordance with examples as disclosed herein. For example, the communications manager 2220 may be configured as or otherwise support a means for receiving, while in communication with a first wireless communication device via a first access point and a first wireless communication link between the first wireless communication device and the first access point and using a first internet protocol address for the first wireless communication device for the first wireless communication link, an indication of a second internet protocol address for the first wireless communication device for a second wireless communication link between the first wireless communication device and a second access point, the indication of the second internet protocol address being received via the first access point and the first wireless communication link. The communications manager 2220 may be configured as or otherwise support a means for receiving, from the first wireless device via the first access point and the first wireless communication link, a roaming indication. The communications manager 2220 may be configured as or otherwise support a means for responsive to the roaming indication, communicating data with the first wireless communication device via the second wireless communication link and the second access point using the second internet protocol address.

By including or configuring the communications manager 2220 in accordance with examples as described herein, the device 2205 (such as a processor controlling or otherwise coupled with the receiver 2210, the transmitter 2215, the communications manager 2220, or a combination thereof) may support techniques for reduced power consumption and more efficient utilization of communication resources.

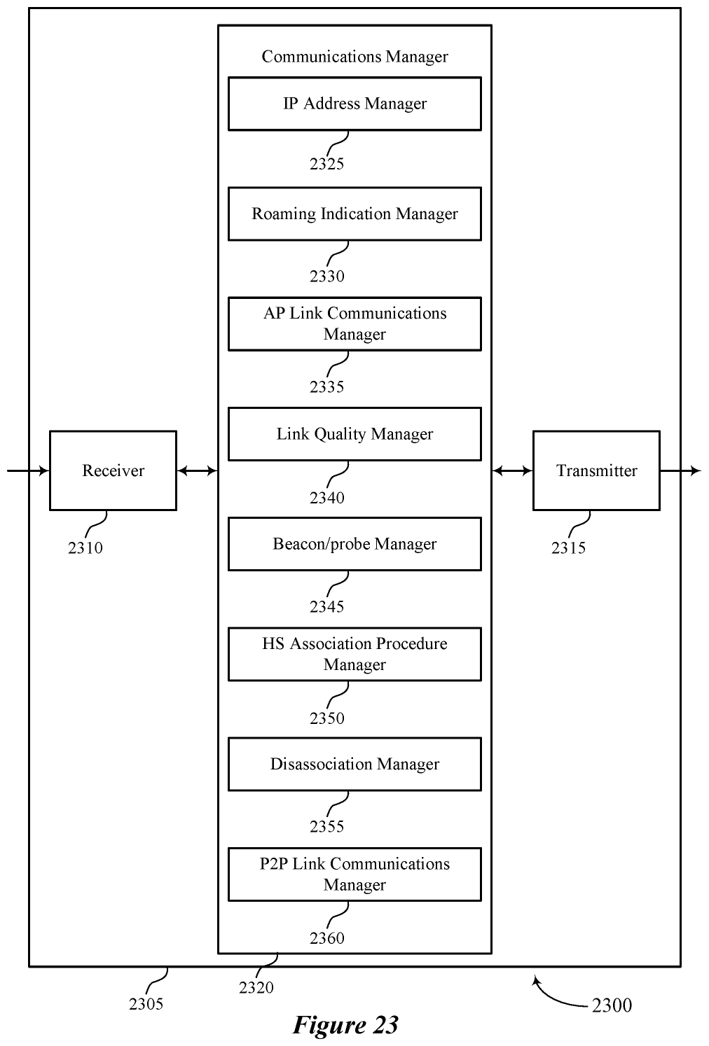

FIG. 23 illustrates a block diagram 2300 of a device 2305 that supports seamless transitions for XPAN coverage in accordance with one or more aspects of the present disclosure. The device 2305 may be an example of aspects of a device 2205 or an STA 104 as described herein (such as a personal wireless communication device 204 or a personal audio device 210 as described herein). The device 2305 may include a receiver 2310, a transmitter 2315, and a communications manager 2320. The device 2305 may also include a processor. Each of these components may be in communication with one another (such as via one or more buses).

The receiver 2310 may provide a means for receiving information such as packets, user data, control information, or any combination thereof associated with various information channels (such as control channels, data channels, information channels related to seamless transitions for XPAN coverage). Information may be passed on to other components of the device 2305. The receiver 2310 may utilize a single antenna or a set of multiple antennas.

The transmitter 2315 may provide a means for transmitting signals generated by other components of the device 2305. For example, the transmitter 2315 may transmit information such as packets, user data, control information, or any combination thereof associated with various information channels (such as control channels, data channels, information channels related to seamless transitions for XPAN coverage). In some examples, the transmitter 2315 may be co-located with a receiver 2310 in a transceiver module. The transmitter 2315 may utilize a single antenna or a set of multiple antennas.

The device 2305, or various components thereof, may be an example of means for performing various aspects of seamless transitions for XPAN coverage as described herein. For example, the communications manager 2320 may include an IP address manager 2325, a roaming indication manager 2330, an AP link communications manager 2335, a link quality manager 2340, a beacon/probe manager 2345, an HS association procedure manager 2350, a disassociation manager 2355, a P2P link communications manager 2360, or any combination thereof. The communications manager 2320 may be an example of aspects of a communications manager 2220 as described herein. In some examples, the communications manager 2320, or various components thereof, may be configured to perform various operations (such as receiving, obtaining, monitoring, outputting, transmitting) using or otherwise in cooperation with the receiver 2310, the transmitter 2315, or both. For example, the communications manager 2320 may receive information from the receiver 2310, send information to the transmitter 2315, or be integrated in combination with the receiver 2310, the transmitter 2315, or both to obtain information, output information, or perform various other operations as described herein.

The communications manager 2320 may support wireless communications at a first wireless communication device in accordance with examples as disclosed herein. The IP address manager 2325 may be configured as or otherwise support a means for receiving, while in communication with a second wireless communication device on a P2P wireless communication link and from an AP associated with the second wireless communication device, an IP address for the first wireless communication device for a second wireless communication link between the first wireless communication device and the AP. The roaming indication manager 2330 may be configured as or otherwise support a means for responsive to a first link quality of the P2P wireless communication link falling below a first threshold, communicating a roaming indication with the second wireless communication device on the P2P wireless communication link. The AP link communications manager 2335 may be configured as or otherwise support a means for responsive to the roaming indication, communicating data with the second wireless communication device via the second wireless communication link, and the AP.

Additionally, or alternatively, the communications manager 2320 may support wireless communications at a second wireless communication device in accordance with examples as disclosed herein. The IP address manager 2325 may be configured as or otherwise support a means for receiving, while in communication with a first wireless communication device on a P2P wireless communication link, and while in communication with an AP on a third wireless communication link, an IP address from the first wireless communication device for the first wireless communication device for a second wireless communication link between the first wireless communication device and the AP. The link quality manager 2340 may be configured as or otherwise support a means for responsive to a first link quality of the P2P wireless communication link between the first wireless communication device and the second wireless communication device falling below a first threshold, communicating a roaming indication with the first wireless communication device on the P2P wireless communication link. The AP link communications manager 2335 may be configured as or otherwise support a means for responsive to the roaming indication, communicating data with the first wireless communication device via the third wireless communication link and the AP using the IP address for the first wireless communication device.

Additionally, or alternatively, the communications manager 2320 may support wireless communications at a first wireless communication device in accordance with examples as disclosed herein. The IP address manager 2325 may be configured as or otherwise support a means for receiving, while in communication with a second wireless communication device on a P2P wireless communication link and from the second wireless communication device, an indication of an IP address for the first wireless communication device for a second wireless communication link between the first wireless communication device and an AP associated with the second wireless communication device. The roaming indication manager 2330 may be configured as or otherwise support a means for responsive to a first link quality of the P2P wireless communication link falling below a first threshold, communicating a roaming indication with the second wireless communication device on the P2P wireless communication link. The AP link communications manager 2335 may be configured as or otherwise support a means for responsive to the roaming indication, communicating data with the second wireless communication device via the second wireless communication link, and the AP.

Additionally, or alternatively, the communications manager 2320 may support wireless communications at a second wireless communication device in accordance with examples as disclosed herein. The IP address manager 2325 may be configured as or otherwise support a means for performing, while in communication with a first wireless communication device on a P2P wireless communication link, and while in communication with an AP on a third wireless communication link, an association procedure with an AP using a MAC address for the first wireless communication device to receive an IP address for the first wireless communication device for a second wireless communication link between the first wireless communication device and the AP. The IP address manager 2325 may be configured as or otherwise support a means for transmitting, to the first wireless communication device on the P2P wireless communication link, the IP address. The roaming indication manager 2330 may be configured as or otherwise support a means for responsive to a link quality of a P2P wireless communication link between the first wireless communication device and the second wireless communication device falling below a first threshold, communicating a roaming indication with the first wireless communication device on the P2P wireless communication link. The AP link communications manager 2335 may be configured as or otherwise support a means for responsive to the roaming indication, communicating data with the first wireless communication device via the third wireless communication link and the AP using the IP address for the first wireless communication device.

Additionally, or alternatively, the communications manager 2320 may support wireless communications at a first wireless communication device in accordance with examples as disclosed herein. The beacon/probe manager 2345 may be configured as or otherwise support a means for receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link. The HS association procedure manager 2350 may be configured as or otherwise support a means for responsive to a first link quality of the P2P wireless communication link satisfying a first threshold, the first link quality detected using the beacon or the probe response, performing an association procedure with the second wireless communication device for the P2P wireless communication link. The disassociation manager 2355 may be configured as or otherwise support a means for transmitting, in response to the association procedure, a disassociation message to the AP for the second wireless communication link. The P2P link communications manager 2360 may be configured as or otherwise support a means for communicating data with the second wireless communication device on the P2P wireless communication link.

Additionally, or alternatively, the communications manager 2320 may support wireless communications at a second wireless communication device in accordance with examples as disclosed herein. The beacon/probe manager 2345 may be configured as or otherwise support a means for transmitting, while in communication with a first wireless communication device via a third wireless communication link between the second wireless communication device and an AP and via the AP and a second wireless communication link between the first wireless communication device and the AP, a beacon or a probe response on a P2P wireless communication link. The link quality manager 2340 may be configured as or otherwise support a means for responsive to a link quality of the P2P wireless communication link satisfying a threshold, performing an association procedure with the first wireless communication device for the P2P wireless communication link. The P2P link communications manager 2360 may be configured as or otherwise support a means for communicating data with the first wireless communication device on the P2P wireless communication link.

Additionally, or alternatively, the communications manager 2320 may support wireless communications at a first wireless communication device in accordance with examples as disclosed herein. The beacon/probe manager 2345 may be configured as or otherwise support a means for responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link. The IP address manager 2325 may be configured as or otherwise support a means for responsive to a second link quality of the second wireless communication link being higher than the first link quality, performing an association procedure with the second AP to receive an IP address for the first wireless communication device for the second wireless communication link. The IP address manager 2325 may be configured as or otherwise support a means for transmitting, in response to the association procedure and to the second wireless communication device, an indication of the IP address via the first wireless communication link and the first AP. The disassociation manager 2355 may be configured as or otherwise support a means for transmitting, in response to transmission of the IP address, a disassociation message to the first AP for the first wireless communication link. The AP link communications manager 2335 may be configured as or otherwise support a means for responsive to transmission of the disassociation message, communicating data with the second wireless communication device via the second wireless communication link, and the second AP.

Additionally, or alternatively, the communications manager 2320 may support wireless communications at a second wireless communication device in accordance with examples as disclosed herein. The IP address manager 2325 may be configured as or otherwise support a means for receiving, while in communication with a first wireless communication device via a first access point and a first wireless communication link between the first wireless communication device and the first access point and using a first internet protocol address for the first wireless communication device for the first wireless communication link, an indication of a second internet protocol address for the first wireless communication device for a second wireless communication link between the first wireless communication device and a second access point, the indication of the second internet protocol address being received via the first access point and the first wireless communication link. The roaming indication manager 2330 may be configured as or otherwise support a means for receiving, from the first wireless device via the first access point and the first wireless communication link, a roaming indication. The AP link communications manager 2335 may be configured as or otherwise support a means for responsive to the roaming indication, communicating data with the first wireless communication device via the second wireless communication link and the second access point using the second internet protocol address.

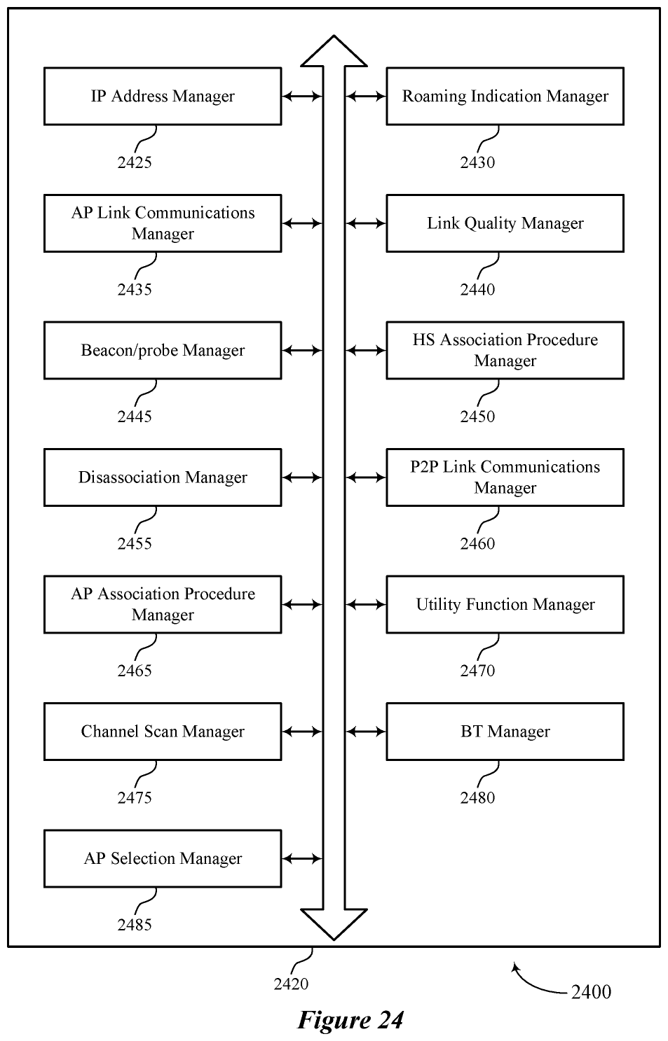

FIG. 24 illustrates a block diagram 2400 of a communications manager 2420 that supports seamless transitions for XPAN coverage in accordance with one or more aspects of the present disclosure. The communications manager 2420 may be an example of aspects of a communications manager 2220, a communications manager 2320, or both, as described herein. The communications manager 2420, or various components thereof, may be an example of means for performing various aspects of seamless transitions for XPAN coverage as described herein. For example, the communications manager 2420 may include an IP address manager 2425, a roaming indication manager 2430, an AP link communications manager 2435, a link quality manager 2440, a beacon/probe manager 2445, an HS association procedure manager 2450, a disassociation manager 2455, a P2P link communications manager 2460, an AP association procedure manager 2465, a utility function manager 2470, a channel scan manager 2475, a BT manager 2480, an AP selection manager 2485, or any combination thereof. Each of these components may communicate, directly or indirectly, with one another (such as via one or more buses).

The communications manager 2420 may support wireless communications at a first wireless communication device in accordance with examples as disclosed herein. The IP address manager 2425 may be configured as or otherwise support a means for receiving, while in communication with a second wireless communication device on a P2P wireless communication link and from an AP associated with the second wireless communication device, an IP address for the first wireless communication device for a second wireless communication link between the first wireless communication device and the AP. The roaming indication manager 2430 may be configured as or otherwise support a means for responsive to a first link quality of the P2P wireless communication link falling below a first threshold, communicating a roaming indication with the second wireless communication device on the P2P wireless communication link. The AP link communications manager 2435 may be configured as or otherwise support a means for responsive to the roaming indication, communicating data with the second wireless communication device via the second wireless communication link, and the AP.

In some examples, the AP association procedure manager 2465 may be configured as or otherwise support a means for responsive to the first link quality dropping below a second threshold, performing an association procedure with the AP to receive the IP address.

In some examples, the link quality manager 2440 may be configured as or otherwise support a means for receiving, from the second wireless communication device on the P2P wireless communication link, a message indicating that the first link quality dropped below the second threshold.

In some examples, the AP selection manager 2485 may be configured as or otherwise support a means for receiving, with the message, an indication of a serving AP for the second wireless communication device.

In some examples, the channel scan manager 2475 may be configured as or otherwise support a means for responsive to the first link quality dropping below the second threshold, transmitting, to the second wireless communication device on the P2P wireless communication link, a request for channel scan results associated with the second wireless communication link. In some examples, the channel scan manager 2475 may be configured as or otherwise support a means for receiving, from the second wireless communication device on the P2P wireless communication link in response to the request, a channel scan result associated with the second wireless communication link. In some examples, the AP association procedure manager 2465 may be configured as or otherwise support a means for responsive to the channel scan result indicating a second link quality of the second wireless communication link satisfies a third threshold, performing the association procedure with the AP to receive the IP address.

In some examples, the channel scan manager 2475 may be configured as or otherwise support a means for receiving, from the second wireless communication device on the P2P wireless communication link in response to the request, a set of channel scan results for a set of wireless communication links corresponding to a set of APs, the set of APs including the AP. In some examples, the AP selection manager 2485 may be configured as or otherwise support a means for selecting the AP from the set of APs in response to the set of channel scan results.

In some examples, the beacon/probe manager 2445 may be configured as or otherwise support a means for responsive to the first link quality dropping below the second threshold, receiving a beacon from the AP on the second wireless communication link. In some examples, the link quality manager 2440 may be configured as or otherwise support a means for determining a second link quality of the second wireless communication link using the beacon. In some examples, the AP association procedure manager 2465 may be configured as or otherwise support a means for responsive to the second link quality satisfying a third threshold, performing the association procedure with the AP to receive the IP address.

In some examples, the beacon/probe manager 2445 may be configured as or otherwise support a means for responsive to the first link quality dropping below the second threshold, transmitting a probe request to the AP. In some examples, the beacon/probe manager 2445 may be configured as or otherwise support a means for responsive to the probe request, receiving, from the AP, a probe response. In some examples, the link quality manager 2440 may be configured as or otherwise support a means for determining a second link quality of the second wireless communication link using the probe response. In some examples, the AP association procedure manager 2465 may be configured as or otherwise support a means for responsive to the second link quality satisfying a third threshold, performing the association procedure with the AP to receive the IP address.

In some examples, the IP address manager 2425 may be configured as or otherwise support a means for transmitting an indication of the IP address or a MAC address of the first wireless communication device to the second wireless communication device on the P2P wireless communication link.

In some examples, the BT manager 2480 may be configured as or otherwise support a means for responsive to the first link quality dropping below the second threshold, transmitting, to a third wireless communication device on a Bluetooth wireless communication link between the first wireless communication device and the third wireless communication device, an indication of the access point.

In some examples, the disassociation manager 2455 may be configured as or otherwise support a means for communicating, with the second wireless communication device on the P2P wireless communication link, a disassociation message in response to the roaming indication.

In some examples, the utility function manager 2470 may be configured as or otherwise support a means for determining, in accordance with a utility function, that a second link quality of the second wireless communication link is better than the first link quality. In some examples, the AP association procedure manager 2465 may be configured as or otherwise support a means for performing an association procedure with the AP to receive the IP address in response to the determination that the second link quality is better than the first link quality.

In some examples, the utility function includes at least one of a channel type for each of the P2P wireless communication link and the second wireless communication link, a received signal strength indicator value for each of the P2P wireless communication link and the second wireless communication link, and a bias factor for the P2P wireless communication link.

In some examples, the P2P link communications manager 2460 may be configured as or otherwise support a means for switching a channel of the P2P wireless communication link to a same channel as the second wireless communication link in response to the association procedure.

Additionally, or alternatively, the communications manager 2420 may support wireless communications at a second wireless communication device in accordance with examples as disclosed herein. In some examples, the IP address manager 2425 may be configured as or otherwise support a means for receiving, while in communication with a first wireless communication device on a P2P wireless communication link, and while in communication with an AP on a third wireless communication link, an IP address from the first wireless communication device for the first wireless communication device for a second wireless communication link between the first wireless communication device and the AP. The link quality manager 2440 may be configured as or otherwise support a means for responsive to a first link quality of the P2P wireless communication link between the first wireless communication device and the second wireless communication device falling below a first threshold, communicating a roaming indication with the first wireless communication device on the P2P wireless communication link. In some examples, the AP link communications manager 2435 may be configured as or otherwise support a means for responsive to the roaming indication, communicating data with the first wireless communication device via the third wireless communication link and the AP using the IP address for the first wireless communication device.

In some examples, the link quality manager 2440 may be configured as or otherwise support a means for transmitting, to the first wireless communication device on the P2P wireless communication link, a message indicating that the first link quality dropped below a second threshold, reception of the IP address being responsive to the message.

In some examples, the AP selection manager 2485 may be configured as or otherwise support a means for transmitting, with the message, an indication of a serving AP for the second wireless communication device.

In some examples, the channel scan manager 2475 may be configured as or otherwise support a means for responsive to the first link quality dropping below a second threshold, receiving, from the first wireless communication device on the P2P wireless communication link, a request for channel scan results associated with the second wireless communication link. In some examples, the channel scan manager 2475 may be configured as or otherwise support a means for transmitting, to the first wireless communication device on the P2P wireless communication link in response to the request, a channel scan result associated with the second wireless communication link, reception of the IP address being responsive to the channel scan result indicating a second link quality of the second wireless communication link satisfies a third threshold.

In some examples, the channel scan manager 2475 may be configured as or otherwise support a means for transmitting, to the first wireless communication device on the P2P wireless communication link in response to the request, a set of channel scan results for a set of wireless communication links corresponding to a set of APs, the set of APs including the AP.

In some examples, the disassociation manager 2455 may be configured as or otherwise support a means for communicating, with the first wireless communication device on the P2P wireless communication link, a disassociation message in response to the roaming indication.

In some examples, the P2P link communications manager 2460 may be configured as or otherwise support a means for switching a channel of the P2P wireless communication link to a same channel as the second wireless communication link in response reception of the IP address.

Additionally, or alternatively, the communications manager 2420 may support wireless communications at a first wireless communication device in accordance with examples as disclosed herein. In some examples, the IP address manager 2425 may be configured as or otherwise support a means for receiving, while in communication with a second wireless communication device on a P2P wireless communication link and from the second wireless communication device, an indication of an IP address for the first wireless communication device for a second wireless communication link between the first wireless communication device and an AP associated with the second wireless communication device. In some examples, the roaming indication manager 2430 may be configured as or otherwise support a means for responsive to a first link quality of the P2P wireless communication link falling below a first threshold, communicating a roaming indication with the second wireless communication device on the P2P wireless communication link. In some examples, the AP link communications manager 2435 may be configured as or otherwise support a means for responsive to the roaming indication, communicating data with the second wireless communication device via the second wireless communication link, and the AP.

In some examples, the link quality manager 2440 may be configured as or otherwise support a means for receiving, from the second wireless communication device on the P2P wireless communication link, a message indicating that the first link quality dropped below the first threshold.

In some examples, the AP selection manager 2485 may be configured as or otherwise support a means for receiving, with the message, an indication of a serving AP for the second wireless communication device.

In some examples, the disassociation manager 2455 may be configured as or otherwise support a means for communicating, with the second wireless communication device on the P2P wireless communication link, a disassociation message in response to the roaming indication.

In some examples, the utility function manager 2470 may be configured as or otherwise support a means for determining, in accordance with a utility function, that a second link quality of the second wireless communication link is better than the first link quality, transmission of the roaming indication being responsive to the determination that the second link quality is better than the first link quality.

In some examples, the utility function includes at least one of a channel type for each of the P2P wireless communication link and the second wireless communication link, a received signal strength indicator value for each of the P2P wireless communication link and the second wireless communication link, an a bias factor for the P2P wireless communication link.

Additionally, or alternatively, the communications manager 2420 may support wireless communications at a second wireless communication device in accordance with examples as disclosed herein. In some examples, the IP address manager 2425 may be configured as or otherwise support a means for performing, while in communication with a first wireless communication device on a P2P wireless communication link, and while in communication with an AP on a third wireless communication link, an association procedure with an AP using a MAC address for the first wireless communication device to receive an IP address for the first wireless communication device for a second wireless communication link between the first wireless communication device and the AP. In some examples, the IP address manager 2425 may be configured as or otherwise support a means for transmitting, to the first wireless communication device on the P2P wireless communication link, the IP address. In some examples, the roaming indication manager 2430 may be configured as or otherwise support a means for responsive to a link quality of a P2P wireless communication link between the first wireless communication device and the second wireless communication device falling below a first threshold, communicating a roaming indication with the first wireless communication device on the P2P wireless communication link. In some examples, the AP link communications manager 2435 may be configured as or otherwise support a means for responsive to the roaming indication, communicating data with the first wireless communication device via the third wireless communication link and the AP using the IP address for the first wireless communication device.

In some examples, the link quality manager 2440 may be configured as or otherwise support a means for transmitting, to the first wireless communication device on the P2P wireless communication link, a message indicating that the first link quality dropped below the first threshold.

In some examples, the AP selection manager 2485 may be configured as or otherwise support a means for transmitting, with the message, an indication of a serving AP for the second wireless communication device.

In some examples, the disassociation manager 2455 may be configured as or otherwise support a means for communicating, with the first wireless communication device on the P2P wireless communication link, a disassociation message in response to the roaming indication.

Additionally, or alternatively, the communications manager 2420 may support wireless communications at a first wireless communication device in accordance with examples as disclosed herein. The beacon/probe manager 2445 may be configured as or otherwise support a means for receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link. The HS association procedure manager 2450 may be configured as or otherwise support a means for responsive to a first link quality of the P2P wireless communication link satisfying a first threshold, the first link quality detected using the beacon or the probe response, performing an association procedure with the second wireless communication device for the P2P wireless communication link. The disassociation manager 2455 may be configured as or otherwise support a means for transmitting, in response to the association procedure, a disassociation message to the AP for the second wireless communication link. The P2P link communications manager 2460 may be configured as or otherwise support a means for communicating data with the second wireless communication device on the P2P wireless communication link.

In some examples, the beacon/probe manager 2445 may be configured as or otherwise support a means for responsive to a second link quality of the second wireless communication link falling below a second threshold, monitoring for the beacon on the P2P wireless communication link.

In some examples, the beacon/probe manager 2445 may be configured as or otherwise support a means for responsive to a second link quality of the second wireless communication link falling below a second threshold, transmitting via the second wireless communication link and the AP, a probe request, reception of the probe response being responsive to the probe request.

In some examples, the beacon/probe manager 2445 may be configured as or otherwise support a means for periodically monitoring for beacons from the second wireless communication device while in communication with the second wireless communication device via the second wireless communication link and via the AP and the third wireless communication link, reception of the beacon responsive to the periodic monitoring.

In some examples, the link quality manager 2440 may be configured as or otherwise support a means for responsive to a second link quality of the second wireless communication link falling below a second threshold, transmitting, to the second wireless communication device via the second wireless communication link and the AP, an indication that the second link quality has dropped below the second threshold. In some examples, the beacon/probe manager 2445 may be configured as or otherwise support a means for receiving, from the second wireless communication device via the AP and the second wireless communication link in response to the indication, scheduling information for the beacon, reception of the beacon being in accordance with the scheduling information.

In some examples, the BT manager 2480 may be configured as or otherwise support a means for responsive to a second link quality of the second wireless communication link falling below a second threshold, and further responsive to a determination that the second wireless communication device is within range of a BT wireless communication link between the first wireless communication device and the second wireless communication device, transmitting, to the second wireless communication device and on the BT wireless communication link, a request to connect with the second wireless communication device. In some examples, the beacon/probe manager 2445 may be configured as or otherwise support a means for receiving, from the second wireless communication device on the BT wireless communication link, scheduling information for the beacon, reception of the beacon being in accordance with the scheduling information.

In some examples, the BT manager 2480 may be configured as or otherwise support a means for responsive to a second link quality of the second wireless communication link falling below a second threshold, and further responsive to a determination that the second wireless communication device is within range of a BT wireless communication link between the first wireless communication device and the second wireless communication device, transmitting, to the second wireless communication device and on the second wireless communication link, a probe request, reception of the probe response being responsive to the probe request.

In some examples, to support first link quality of the P2P wireless communication link satisfying the first threshold, the utility function manager 2470 may be configured as or otherwise support a means for determining, in accordance with a utility function, that the first link quality is better than a second link quality of the second wireless communication link.

In some examples, the utility function includes at least one of a channel type for each of the P2P wireless communication link and the second wireless communication link, a received signal strength indicator value for each of the P2P wireless communication link and the second wireless communication link, and a bias factor for the P2P wireless communication link.

In some examples, to support transmitting the disassociation message, the disassociation manager 2455 may be configured as or otherwise support a means for transmitting the disassociation message in response to a second link quality of the second wireless communication link falling below a second threshold.

In some examples, the BT manager 2480 may be configured as or otherwise support a means for responsive to the first link quality satisfying the first threshold, transmitting, to a third wireless communication device on a Bluetooth wireless communication link between the first wireless communication device and the third wireless communication device, an indication for the third wireless communication device to perform a second association procedure with the second wireless communication device.

Additionally, or alternatively, the communications manager 2420 may support wireless communications at a second wireless communication device in accordance with examples as disclosed herein. In some examples, the beacon/probe manager 2445 may be configured as or otherwise support a means for transmitting, while in communication with a first wireless communication device via a third wireless communication link between the second wireless communication device and an AP and via the AP and a second wireless communication link between the first wireless communication device and the AP, a beacon or a probe response on a P2P wireless communication link. In some examples, the link quality manager 2440 may be configured as or otherwise support a means for responsive to a link quality of the P2P wireless communication link satisfying a threshold, performing an association procedure with the first wireless communication device for the P2P wireless communication link. In some examples, the P2P link communications manager 2460 may be configured as or otherwise support a means for communicating data with the first wireless communication device on the P2P wireless communication link.

In some examples, the link quality manager 2440 may be configured as or otherwise support a means for responsive to a second link quality of the second wireless communication link falling below a second threshold, receiving, from the first wireless communication device via the second wireless communication link and the AP, an indication that the second link quality has dropped below the second threshold. In some examples, the beacon/probe manager 2445 may be configured as or otherwise support a means for transmitting, to the first wireless communication device via the AP and the second wireless communication link in response to the indication, scheduling information for the beacon, transmission of the beacon being in accordance with the scheduling information.

In some examples, the beacon/probe manager 2445 may be configured as or otherwise support a means for responsive to a second link quality of the second wireless communication link falling below a second threshold, receiving, via the second wireless communication link and the AP, a probe request, transmission of the probe response being responsive to the probe request.

In some examples, the BT manager 2480 may be configured as or otherwise support a means for responsive to a second link quality of the second wireless communication link falling below a second threshold, and further responsive to a determination that the second wireless communication device is within range of a BT wireless communication link between the first wireless communication device and the second wireless communication device, receiving, from the first wireless communication device and on the BT wireless communication link, a request to connect with the second wireless communication device. In some examples, the beacon/probe manager 2445 may be configured as or otherwise support a means for transmitting, to the first wireless communication device on the BT wireless communication link, scheduling information for the beacon, transmission of the beacon being in accordance with the scheduling information.

In some examples, the BT manager 2480 may be configured as or otherwise support a means for responsive to a second link quality of the second wireless communication link falling below a second threshold, and further responsive to a determination that the second wireless communication device is within range of a BT wireless communication link between the first wireless communication device and the second wireless communication device, receiving, from the first wireless communication device and on the second wireless communication link, a probe request, transmission of the probe response being responsive to the probe request.

Additionally, or alternatively, the communications manager 2420 may support wireless communications at a first wireless communication device in accordance with examples as disclosed herein. In some examples, the beacon/probe manager 2445 may be configured as or otherwise support a means for responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link. In some examples, the IP address manager 2425 may be configured as or otherwise support a means for responsive to a second link quality of the second wireless communication link being higher than the first link quality, performing an association procedure with the second AP to receive an IP address for the first wireless communication device for the second wireless communication link. In some examples, the IP address manager 2425 may be configured as or otherwise support a means for transmitting, in response to the association procedure and to the second wireless communication device, an indication of the IP address via the first wireless communication link and the first AP. In some examples, the disassociation manager 2455 may be configured as or otherwise support a means for transmitting, in response to transmission of the IP address, a disassociation message to the first AP for the first wireless communication link. In some examples, the AP link communications manager 2435 may be configured as or otherwise support a means for responsive to transmission of the disassociation message, communicating data with the second wireless communication device via the second wireless communication link, and the second AP.

In some examples, to support receiving the beacon, the beacon/probe manager 2445 may be configured as or otherwise support a means for receiving a set of beacons from a set of APs, the set of APs including the second AP and the set of beacons including the beacon.

In some examples, the AP selection manager 2485 may be configured as or otherwise support a means for selecting the second AP from the set of APs based on respective link qualities for respective wireless communication links with the set of APs determined using the set of beacons.

In some examples, the beacon/probe manager 2445 may be configured as or otherwise support a means for responsive to the first link quality of the first wireless communication link falling below the threshold, transmitting a probe request to the second AP, reception of the probe response being responsive to the probe request.

In some examples, the beacon/probe manager 2445 may be configured as or otherwise support a means for responsive to the first link quality falling below the threshold, receiving a second beacon from the second wireless communication device on a third wireless communication link, receiving the beacon being responsive to a third link quality of a wireless communication link between the first wireless communication device and the second wireless communication device determined using the second beacon being below a third threshold.

In some examples, the utility function manager 2470 may be configured as or otherwise support a means for performing the association procedure in response to a determination that the second link quality of the second wireless communication link is higher than the first link quality in accordance with a utility function.

In some examples, the utility function includes at least one of a channel type for each of the first wireless communication link and the second wireless communication link and a received signal strength indicator value for each of the first wireless communication link and the second wireless communication link.

In some examples, the BT manager 2480 may be configured as or otherwise support a means for responsive to the second link quality of the second wireless communication link being higher than the first link quality, transmitting, to a third wireless communication device on a Bluetooth wireless communication link between the first wireless communication device and the third wireless communication device, an indication for the third wireless communication device to perform a second association procedure with the second access point.

Additionally, or alternatively, the communications manager 2420 may support wireless communications at a second wireless communication device in accordance with examples as disclosed herein. In some examples, the IP address manager 2425 may be configured as or otherwise support a means for receiving, while in communication with a first wireless communication device via a first access point and a first wireless communication link between the first wireless communication device and the first access point and using a first internet protocol address for the first wireless communication device for the first wireless communication link, an indication of a second internet protocol address for the first wireless communication device for a second wireless communication link between the first wireless communication device and a second access point, the indication of the second internet protocol address being received via the first access point and the first wireless communication link. In some examples, the roaming indication manager 2430 may be configured as or otherwise support a means for receiving, from the first wireless device via the first access point and the first wireless communication link, a roaming indication. In some examples, the AP link communications manager 2435 may be configured as or otherwise support a means for responsive to the roaming indication, communicating data with the first wireless communication device via the second wireless communication link and the second access point using the second internet protocol address.

In some examples, the AP link communications manager 2435 may be configured as or otherwise support a means for receiving, from the first wireless device via the first access point and the first wireless communication link, an indication of a medium access control address for the first wireless communication device for the second wireless communication link, communication of data with the first wireless communication device via the second wireless communication link and the second access point further using the medium access control address.

In some examples, the roaming indication manager 2430 may be configured as or otherwise support a means for transmitting, to the first wireless device via the first access point and the first wireless communication link, an acknowledgment in response to the roaming indication, communication of data with the first wireless communication device via the second wireless communication link and the second access point being responsive to the acknowledgment.

In some examples, the AP link communications manager 2435 may be configured as or otherwise support a means for adjusting at least one of an audio latency or an audio bit rate in response to the roaming indication, communication of data with the first wireless communication device via the second wireless communication link and the second access point using the adjusted audio latency or the adjusted audio bit rate.

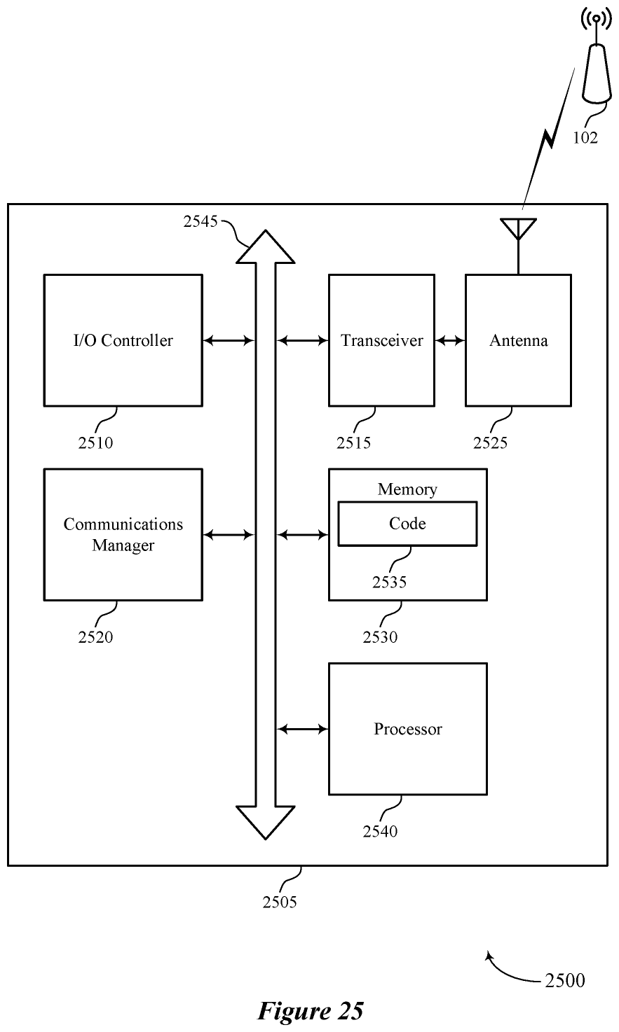

FIG. 25 illustrates a diagram of a system 2500 including a device 2505 that supports seamless transitions for XPAN coverage in accordance with one or more aspects of the present disclosure. The device 2505 may be an example of or include the components of a device 2205, a device 2305, or an STA as described herein (such as a personal wireless communication device 204 or a personal audio device 210 as described herein). The device 2505 may include components for bi-directional voice and data communications including components for transmitting and receiving communications, such as a communications manager 2520, an I/O controller 2510, a transceiver 2515, an antenna 2525, a memory 2530, code 2535, and a processor 2540. These components may be in electronic communication or otherwise coupled (such as operatively, communicatively, functionally, electronically, electrically) via one or more buses (such as a bus 2545).

The I/O controller 2510 may manage input and output signals for the device 2505. The I/O controller 2510 may also manage peripherals not integrated into the device 2505. In some cases, the I/O controller 2510 may represent a physical connection or port to an external peripheral. In some cases, the I/O controller 2510 may utilize an operating system such as iOS®, ANDROID®, MS-DOS®, MS-WINDOWS®, OS/2®, UNIX®, LINUX®, or another known operating system. In some other cases, the I/O controller 2510 may represent or interact with a modem, a keyboard, a mouse, a touchscreen, or a similar device. In some cases, the I/O controller 2510 may be implemented as part of a processor, such as the processor 2540. In some cases, a user may interact with the device 2505 via the I/O controller 2510 or via hardware components controlled by the I/O controller 2510.

In some cases, the device 2505 may include a single antenna 2525. However, in some other cases the device 2505 may have more than one antenna 2525, which may be capable of concurrently transmitting or receiving multiple wireless transmissions. The transceiver 2515 may communicate bi-directionally, via the one or more antennas 2525, wired, or wireless links as described herein. For example, the transceiver 2515 may represent a wireless transceiver and may communicate bi-directionally with another wireless transceiver. The transceiver 2515 may also include a modem to modulate the packets and provide the modulated packets to one or more antennas 2525 for transmission, and to demodulate packets received from the one or more antennas 2525. The transceiver 2515, or the transceiver 2515 and one or more antennas 2525, may be an example of a transmitter 2215, a transmitter 2315, a receiver 2210, a receiver 2310, or any combination thereof or component thereof, as described herein.

The memory 2530 may include RAM and ROM. The memory 2530 may store computer-readable, computer-executable code 2535 including instructions that, when executed by the processor 2540, cause the device 2505 to perform various functions described herein. In some cases, the memory 2530 may contain, among other things, a BIOS which may control basic hardware or software operation such as the interaction with peripheral components or devices.

The processor 2540 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, the processor 2540 may be configured to operate a memory array using a memory controller. In some other cases, a memory controller may be integrated into the processor 2540. The processor 2540 may be configured to execute computer-readable instructions stored in a memory (such as the memory 2530) to cause the device 2505 to perform various functions (such as functions or tasks supporting seamless transitions for XPAN coverage). For example, the device 2505 or a component of the device 2505 may include a processor 2540 and memory 2530 coupled with or to the processor 2540, the processor 2540 and memory 2530 configured to perform various functions described herein.

The communications manager 2520 may support wireless communications at a first wireless communication device in accordance with examples as disclosed herein. For example, the communications manager 2520 may be configured as or otherwise support a means for receiving, while in communication with a second wireless communication device on a P2P wireless communication link and from an AP associated with the second wireless communication device, an IP address for the first wireless communication device for a second wireless communication link between the first wireless communication device and the AP. The communications manager 2520 may be configured as or otherwise support a means for responsive to a first link quality of the P2P wireless communication link falling below a first threshold, communicating a roaming indication with the second wireless communication device on the P2P wireless communication link. The communications manager 2520 may be configured as or otherwise support a means for responsive to the roaming indication, communicating data with the second wireless communication device via the second wireless communication link, and the AP.

Additionally, or alternatively, the communications manager 2520 may support wireless communications at a second wireless communication device in accordance with examples as disclosed herein. For example, the communications manager 2520 may be configured as or otherwise support a means for receiving, while in communication with a first wireless communication device on a P2P wireless communication link, and while in communication with an AP on a third wireless communication link, an IP address from the first wireless communication device for the first wireless communication device for a second wireless communication link between the first wireless communication device and the AP. The communications manager 2520 may be configured as or otherwise support a means for responsive to a first link quality of the P2P wireless communication link between the first wireless communication device and the second wireless communication device falling below a first threshold, communicating a roaming indication with the first wireless communication device on the P2P wireless communication link. The communications manager 2520 may be configured as or otherwise support a means for responsive to the roaming indication, communicating data with the first wireless communication device via the third wireless communication link and the AP using the IP address for the first wireless communication device.

Additionally, or alternatively, the communications manager 2520 may support wireless communications at a first wireless communication device in accordance with examples as disclosed herein. For example, the communications manager 2520 may be configured as or otherwise support a means for receiving, while in communication with a second wireless communication device on a P2P wireless communication link and from the second wireless communication device, an indication of an IP address for the first wireless communication device for a second wireless communication link between the first wireless communication device and an AP associated with the second wireless communication device. The communications manager 2520 may be configured as or otherwise support a means for responsive to a first link quality of the P2P wireless communication link falling below a first threshold, communicating a roaming indication with the second wireless communication device on the P2P wireless communication link. The communications manager 2520 may be configured as or otherwise support a means for responsive to the roaming indication, communicating data with the second wireless communication device via the second wireless communication link, and the AP.

Additionally, or alternatively, the communications manager 2520 may support wireless communications at a second wireless communication device in accordance with examples as disclosed herein. For example, the communications manager 2520 may be configured as or otherwise support a means for performing, while in communication with a first wireless communication device on a P2P wireless communication link, and while in communication with an AP on a third wireless communication link, an association procedure with an AP using a MAC address for the first wireless communication device to receive an IP address for the first wireless communication device for a second wireless communication link between the first wireless communication device and the AP. The communications manager 2520 may be configured as or otherwise support a means for transmitting, to the first wireless communication device on the P2P wireless communication link, the IP address. The communications manager 2520 may be configured as or otherwise support a means for responsive to a link quality of a P2P wireless communication link between the first wireless communication device and the second wireless communication device falling below a first threshold, communicating a roaming indication with the first wireless communication device on the P2P wireless communication link. The communications manager 2520 may be configured as or otherwise support a means for responsive to the roaming indication, communicating data with the first wireless communication device via the third wireless communication link and the AP using the IP address for the first wireless communication device.

Additionally, or alternatively, the communications manager 2520 may support wireless communications at a first wireless communication device in accordance with examples as disclosed herein. For example, the communications manager 2520 may be configured as or otherwise support a means for receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link. The communications manager 2520 may be configured as or otherwise support a means for responsive to a first link quality of the P2P wireless communication link satisfying a first threshold, the first link quality detected using the beacon or the probe response, performing an association procedure with the second wireless communication device for the P2P wireless communication link. The communications manager 2520 may be configured as or otherwise support a means for transmitting, in response to the association procedure, a disassociation message to the AP for the second wireless communication link. The communications manager 2520 may be configured as or otherwise support a means for communicating data with the second wireless communication device on the P2P wireless communication link.

Additionally, or alternatively, the communications manager 2520 may support wireless communications at a second wireless communication device in accordance with examples as disclosed herein. For example, the communications manager 2520 may be configured as or otherwise support a means for transmitting, while in communication with a first wireless communication device via a third wireless communication link between the second wireless communication device and an AP and via the AP and a second wireless communication link between the first wireless communication device and the AP, a beacon or a probe response on a P2P wireless communication link. The communications manager 2520 may be configured as or otherwise support a means for responsive to a link quality of the P2P wireless communication link satisfying a threshold, performing an association procedure with the first wireless communication device for the P2P wireless communication link. The communications manager 2520 may be configured as or otherwise support a means for communicating data with the first wireless communication device on the P2P wireless communication link.

Additionally, or alternatively, the communications manager 2520 may support wireless communications at a first wireless communication device in accordance with examples as disclosed herein. For example, the communications manager 2520 may be configured as or otherwise support a means for responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link. The communications manager 2520 may be configured as or otherwise support a means for responsive to a second link quality of the second wireless communication link being higher than the first link quality, performing an association procedure with the second AP to receive an IP address for the first wireless communication device for the second wireless communication link. The communications manager 2520 may be configured as or otherwise support a means for transmitting, in response to the association procedure and to the second wireless communication device, an indication of the IP address via the first wireless communication link and the first AP. The communications manager 2520 may be configured as or otherwise support a means for transmitting, in response to transmission of the IP address, a disassociation message to the first AP for the first wireless communication link. The communications manager 2520 may be configured as or otherwise support a means for responsive to transmission of the disassociation message, communicating data with the second wireless communication device via the second wireless communication link, and the second AP.

By including or configuring the communications manager 2520 in accordance with examples as described herein, the device 2505 may support techniques for improved communication reliability, reduced latency, reduced power consumption, more efficient utilization of communication resources, improved coordination between devices, and longer battery life.

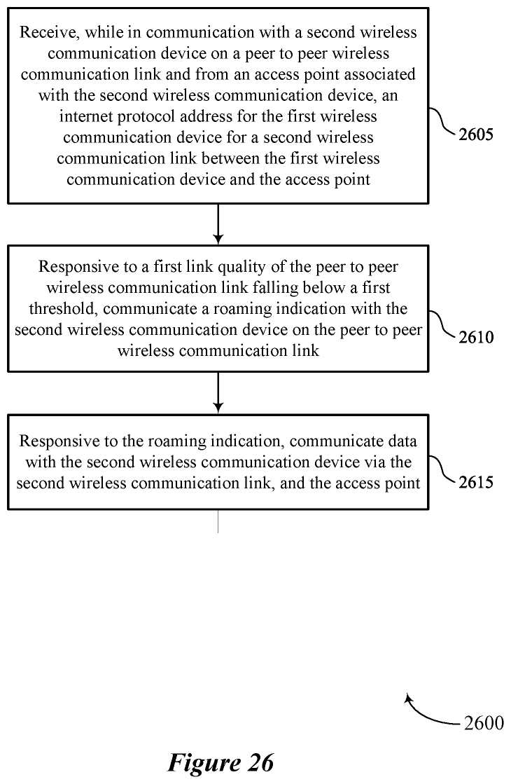

FIG. 26 illustrates a flowchart showing a method 2600 that supports seamless transitions for XPAN coverage in accordance with one or more aspects of the present disclosure. The operations of the method 2600 may be implemented by an STA or a personal audio device 210 or its components as described herein. For example, the operations of the method 2600 may be performed by an STA or a personal audio device 210 as described with reference to FIGS. 1 through 25. In some examples, an STA or a personal audio device 210 may execute a set of instructions to control the functional elements of the STA or the personal audio device 210 to perform the described functions. Additionally, or alternatively, the STA or a personal audio device 210 may perform aspects of the described functions using special-purpose hardware.

At 2605, the method may include receiving, while in communication with a second wireless communication device on a P2P wireless communication link and from an AP associated with the second wireless communication device, an IP address for the first wireless communication device for a second wireless communication link between the first wireless communication device and the AP. The operations of 2605 may be performed in accordance with examples as disclosed herein. In some examples, aspects of the operations of 2605 may be performed by an IP address manager 2425 as described with reference to FIG. 24.

At 2610, the method may include responsive to a first link quality of the P2P wireless communication link falling below a first threshold, communicating a roaming indication with the second wireless communication device on the P2P wireless communication link. The operations of 2610 may be performed in accordance with examples as disclosed herein. In some examples, aspects of the operations of 2610 may be performed by a roaming indication manager 2430 as described with reference to FIG. 24.

At 2615, the method may include responsive to the roaming indication, communicating data with the second wireless communication device via the second wireless communication link, and the AP. The operations of 2615 may be performed in accordance with examples as disclosed herein. In some examples, aspects of the operations of 2615 may be performed by an AP link communications manager 2435 as described with reference to FIG. 24.

Additionally, or alternatively, the communications manager 2520 may support wireless communications at a second wireless communication device in accordance with examples as disclosed herein. For example, the communications manager 2520 may be configured as or otherwise support a means for receiving, while in communication with a first wireless communication device via a first access point and a first wireless communication link between the first wireless communication device and the first access point and using a first internet protocol address for the first wireless communication device for the first wireless communication link, an indication of a second internet protocol address for the first wireless communication device for a second wireless communication link between the first wireless communication device and a second access point, the indication of the second internet protocol address being received via the first access point and the first wireless communication link. The communications manager 2520 may be configured as or otherwise support a means for receiving, from the first wireless device via the first access point and the first wireless communication link, a roaming indication. The communications manager 2520 may be configured as or otherwise support a means for responsive to the roaming indication, communicating data with the first wireless communication device via the second wireless communication link and the second access point using the second internet protocol address.

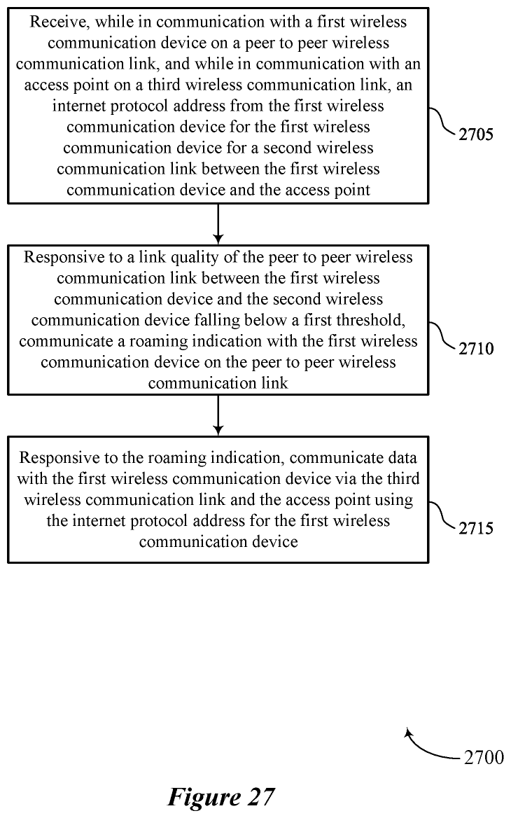

FIG. 27 illustrates a flowchart showing a method 2700 that supports seamless transitions for XPAN coverage in accordance with one or more aspects of the present disclosure. The operations of the method 2700 may be implemented by an STA or a personal wireless communication device 204 or its components as described herein. For example, the operations of the method 2700 may be performed by an STA or a personal wireless communication device 204 as described with reference to FIGS. 1 through 25. In some examples, an STA or a personal wireless communication device 204 may execute a set of instructions to control the functional elements of the STA or the personal wireless communication device 204 to perform the described functions. Additionally, or alternatively, the STA or the personal wireless communication device 204 may perform aspects of the described functions using special-purpose hardware.

At 2705, the method may include receiving, while in communication with a first wireless communication device on a P2P wireless communication link, and while in communication with an AP on a third wireless communication link, an IP address from the first wireless communication device for the first wireless communication device for a second wireless communication link between the first wireless communication device and the AP. The operations of 2705 may be performed in accordance with examples as disclosed herein. In some examples, aspects of the operations of 2705 may be performed by an IP address manager 2425 as described with reference to FIG. 24.

At 2710, the method may include responsive to a first link quality of the P2P wireless communication link between the first wireless communication device and the second wireless communication device falling below a first threshold, communicating a roaming indication with the first wireless communication device on the P2P wireless communication link. The operations of 2710 may be performed in accordance with examples as disclosed herein. In some examples, aspects of the operations of 2710 may be performed by a link quality manager 2440 as described with reference to FIG. 24.

At 2715, the method may include responsive to the roaming indication, communicating data with the first wireless communication device via the third wireless communication link and the AP using the IP address for the first wireless communication device. The operations of 2715 may be performed in accordance with examples as disclosed herein. In some examples, aspects of the operations of 2715 may be performed by an AP link communications manager 2435 as described with reference to FIG. 24.

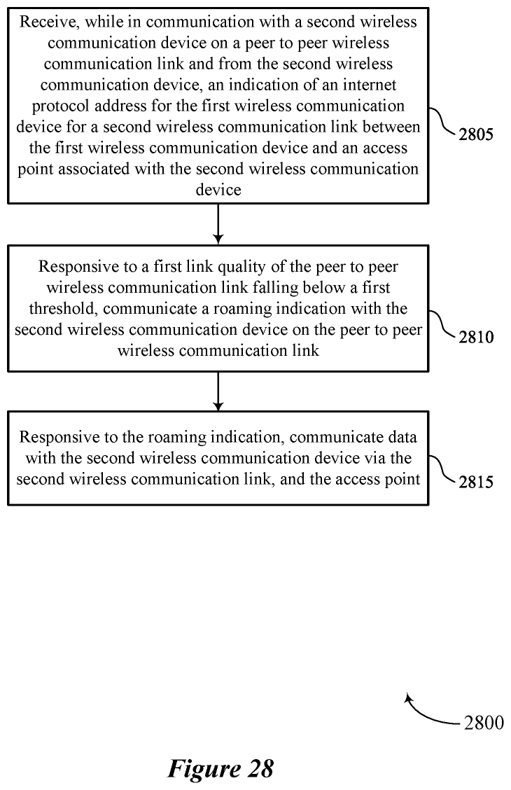

FIG. 28 illustrates a flowchart showing a method 2800 that supports seamless transitions for XPAN coverage in accordance with one or more aspects of the present disclosure. The operations of the method 2800 may be implemented by an STA or a personal audio device 210 or its components as described herein. For example, the operations of the method 2800 may be performed by an STA or a personal audio device 210 as described with reference to FIGS. 1 through 25. In some examples, an STA or a personal audio device 210 may execute a set of instructions to control the functional elements of the STA or the personal audio device 210 to perform the described functions. Additionally, or alternatively, the STA or a personal audio device 210 may perform aspects of the described functions using special-purpose hardware.

At 2805, the method may include receiving, while in communication with a second wireless communication device on a P2P wireless communication link and from the second wireless communication device, an indication of an IP address for the first wireless communication device for a second wireless communication link between the first wireless communication device and an AP associated with the second wireless communication device. The operations of 2805 may be performed in accordance with examples as disclosed herein. In some examples, aspects of the operations of 2805 may be performed by an IP address manager 2425 as described with reference to FIG. 24.

At 2810, the method may include responsive to a first link quality of the P2P wireless communication link falling below a first threshold, communicating a roaming indication with the second wireless communication device on the P2P wireless communication link. The operations of 2810 may be performed in accordance with examples as disclosed herein. In some examples, aspects of the operations of 2810 may be performed by a roaming indication manager 2430 as described with reference to FIG. 24.

At 2815, the method may include responsive to the roaming indication, communicating data with the second wireless communication device via the second wireless communication link, and the AP. The operations of 2815 may be performed in accordance with examples as disclosed herein. In some examples, aspects of the operations of 2815 may be performed by an AP link communications manager 2435 as described with reference to FIG. 24.

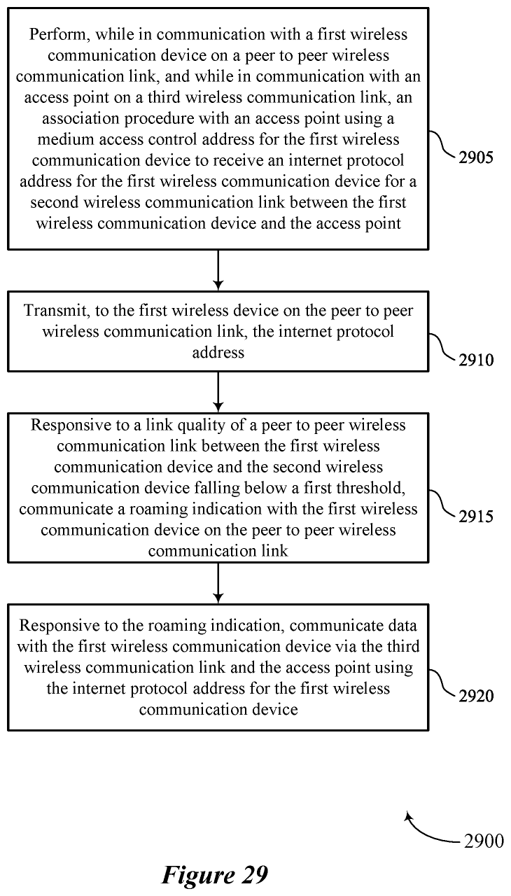

FIG. 29 illustrates a flowchart showing a method 2900 that supports seamless transitions for XPAN coverage in accordance with one or more aspects of the present disclosure. The operations of the method 2900 may be implemented by an STA or a personal wireless communication device 204 or its components as described herein. For example, the operations of the method 2900 may be performed by an STA or a personal wireless communication device 204 as described with reference to FIGS. 1 through 25. In some examples, an STA or a personal wireless communication device 204 may execute a set of instructions to control the functional elements of the STA or the personal wireless communication device 204 to perform the described functions. Additionally, or alternatively, the STA or a personal wireless communication device 204 may perform aspects of the described functions using special-purpose hardware.

At 2905, the method may include performing, while in communication with a first wireless communication device on a P2P wireless communication link, and while in communication with an AP on a third wireless communication link, an association procedure with an AP using a MAC address for the first wireless communication device to receive an IP address for the first wireless communication device for a second wireless communication link between the first wireless communication device and the AP. The operations of 2905 may be performed in accordance with examples as disclosed herein. In some examples, aspects of the operations of 2905 may be performed by an IP address manager 2425 as described with reference to FIG. 24.

At 2910, the method may include transmitting, to the first wireless communication device on the P2P wireless communication link, the IP address. The operations of 2910 may be performed in accordance with examples as disclosed herein. In some examples, aspects of the operations of 2910 may be performed by an IP address manager 2425 as described with reference to FIG. 24.

At 2915, the method may include responsive to a link quality of a P2P wireless communication link between the first wireless communication device and the second wireless communication device falling below a first threshold, communicating a roaming indication with the first wireless communication device on the P2P wireless communication link. The operations of 2915 may be performed in accordance with examples as disclosed herein. In some examples, aspects of the operations of 2915 may be performed by a roaming indication manager 2430 as described with reference to FIG. 24.

At 2920, the method may include responsive to the roaming indication, communicating data with the first wireless communication device via the third wireless communication link and the AP using the IP address for the first wireless communication device. The operations of 2920 may be performed in accordance with examples as disclosed herein. In some examples, aspects of the operations of 2920 may be performed by an AP link communications manager 2435 as described with reference to FIG. 24.

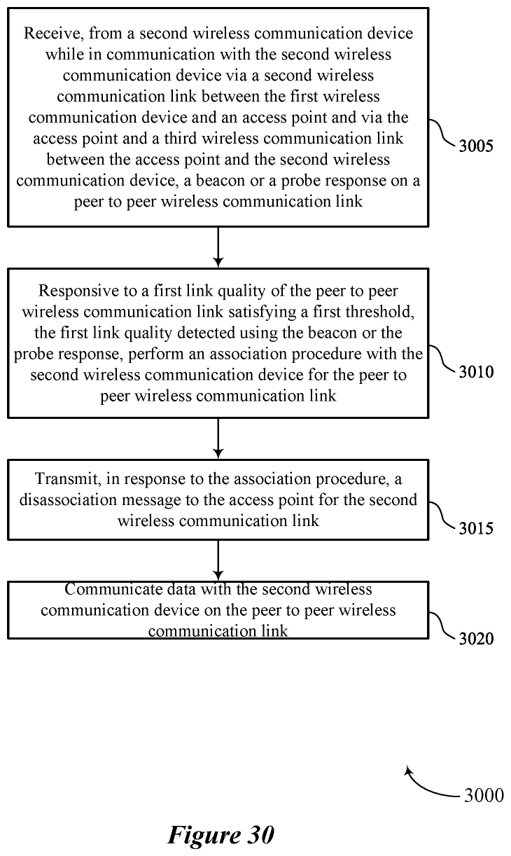

FIG. 30 illustrates a flowchart showing a method 3000 that supports seamless transitions for XPAN coverage in accordance with one or more aspects of the present disclosure. The operations of the method 3000 may be implemented by an STA or a personal audio device 210 or its components as described herein. For example, the operations of the method 3000 may be performed by an STA or a personal audio device 210 as described with reference to FIGS. 1 through 25. In some examples, an STA or a personal audio device 210 may execute a set of instructions to control the functional elements of the STA or the personal audio device 210 to perform the described functions. Additionally, or alternatively, the STA or a personal audio device 210 may perform aspects of the described functions using special-purpose hardware.

At 3005, the method may include receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link. The operations of 3005 may be performed in accordance with examples as disclosed herein. In some examples, aspects of the operations of 3005 may be performed by a beacon/probe manager 2445 as described with reference to FIG. 24.

At 3010, the method may include responsive to a first link quality of the P2P wireless communication link satisfying a first threshold, the first link quality detected using the beacon or the probe response, performing an association procedure with the second wireless communication device for the P2P wireless communication link. The operations of 3010 may be performed in accordance with examples as disclosed herein. In some examples, aspects of the operations of 3010 may be performed by an HS association procedure manager 2450 as described with reference to FIG. 24.

At 3015, the method may include transmitting, in response to the association procedure, a disassociation message to the AP for the second wireless communication link. The operations of 3015 may be performed in accordance with examples as disclosed herein. In some examples, aspects of the operations of 3015 may be performed by a disassociation manager 2455 as described with reference to FIG. 24.

At 3020, the method may include communicating data with the second wireless communication device on the P2P wireless communication link. The operations of 3020 may be performed in accordance with examples as disclosed herein. In some examples, aspects of the operations of 3020 may be performed by a P2P link communications manager 2460 as described with reference to FIG. 24.

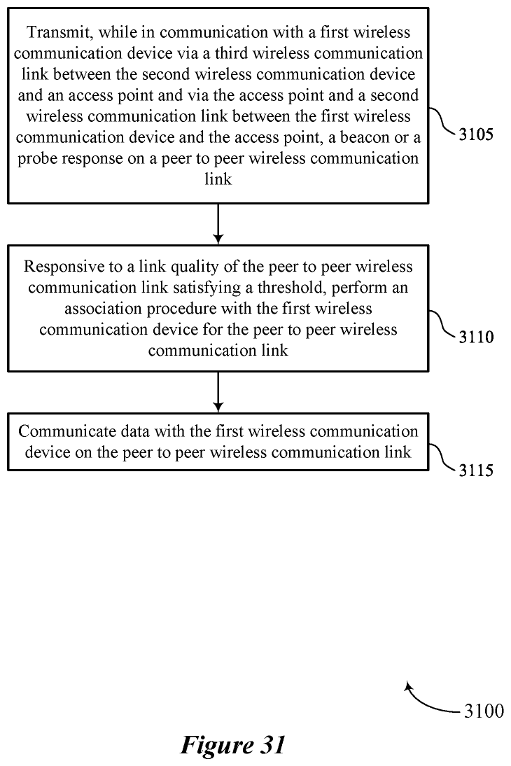

FIG. 31 illustrates a flowchart showing a method 3100 that supports seamless transitions for XPAN coverage in accordance with one or more aspects of the present disclosure. The operations of the method 3100 may be implemented by an STA or a personal wireless communication device 204 or its components as described herein. For example, the operations of the method 3100 may be performed by an STA or a personal wireless communication device 204 as described with reference to FIGS. 1 through 25. In some examples, an STA or a personal wireless communication device 204 may execute a set of instructions to control the functional elements of the STA or the personal wireless communication device 204 to perform the described functions. Additionally, or alternatively, the STA or a personal wireless communication device 204 may perform aspects of the described functions using special-purpose hardware.

At 3105, the method may include transmitting, while in communication with a first wireless communication device via a third wireless communication link between the second wireless communication device and an AP and via the AP and a second wireless communication link between the first wireless communication device and the AP, a beacon or a probe response on a P2P wireless communication link. The operations of 3105 may be performed in accordance with examples as disclosed herein. In some examples, aspects of the operations of 3105 may be performed by a beacon/probe manager 2445 as described with reference to FIG. 24.

At 3110, the method may include responsive to a link quality of the P2P wireless communication link satisfying a threshold, performing an association procedure with the first wireless communication device for the P2P wireless communication link. The operations of 3110 may be performed in accordance with examples as disclosed herein. In some examples, aspects of the operations of 3110 may be performed by a link quality manager 2440 as described with reference to FIG. 24.

At 3115, the method may include communicating data with the first wireless communication device on the P2P wireless communication link. The operations of 3115 may be performed in accordance with examples as disclosed herein. In some examples, aspects of the operations of 3115 may be performed by a P2P link communications manager 2460 as described with reference to FIG. 24.

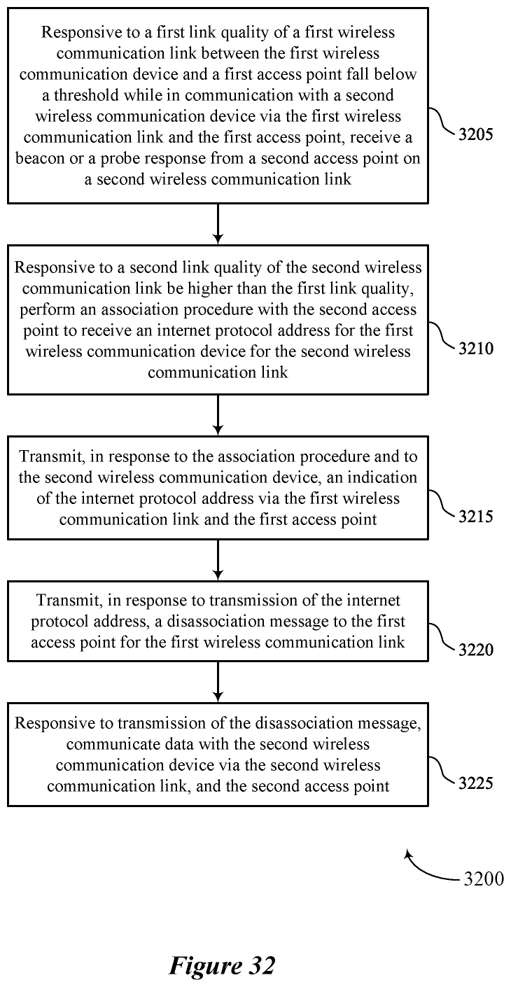

FIG. 32 illustrates a flowchart showing a method 3200 that supports seamless transitions for XPAN in accordance with one or more aspects of the present disclosure. The operations of the method 3200 may be implemented by an STA or a personal audio device 210 or its components as described herein. For example, the operations of the method 3200 may be performed by an STA or a personal audio device 210 as described with reference to FIGS. 1 through 25. In some examples, an STA or a personal audio device 210 may execute a set of instructions to control the functional elements of the STA or the personal audio device 210 to perform the described functions. Additionally, or alternatively, the STA or a personal audio device 210 may perform aspects of the described functions using special-purpose hardware.

At 3205, the method may include responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link. The operations of 3205 may be performed in accordance with examples as disclosed herein. In some examples, aspects of the operations of 3205 may be performed by a beacon/probe manager 2445 as described with reference to FIG. 24.

At 3210, the method may include responsive to a second link quality of the second wireless communication link being higher than the first link quality, performing an association procedure with the second AP to receive an IP address for the first wireless communication device for the second wireless communication link. The operations of 3210 may be performed in accordance with examples as disclosed herein. In some examples, aspects of the operations of 3210 may be performed by an IP address manager 2425 as described with reference to FIG. 24.

At 3215, the method may include transmitting, in response to the association procedure and to the second wireless communication device, an indication of the IP address via the first wireless communication link and the first AP. The operations of 3215 may be performed in accordance with examples as disclosed herein. In some examples, aspects of the operations of 3215 may be performed by an IP address manager 2425 as described with reference to FIG. 24.

At 3220, the method may include transmitting, in response to transmission of the IP address, a disassociation message to the first AP for the first wireless communication link. The operations of 3220 may be performed in accordance with examples as disclosed herein. In some examples, aspects of the operations of 3220 may be performed by a disassociation manager 2455 as described with reference to FIG. 24.

At 3225, the method may include responsive to transmission of the disassociation message, communicating data with the second wireless communication device via the second wireless communication link, and the second AP. The operations of 3225 may be performed in accordance with examples as disclosed herein. In some examples, aspects of the operations of 3225 may be performed by an AP link communications manager 2435 as described with reference to FIG. 24.

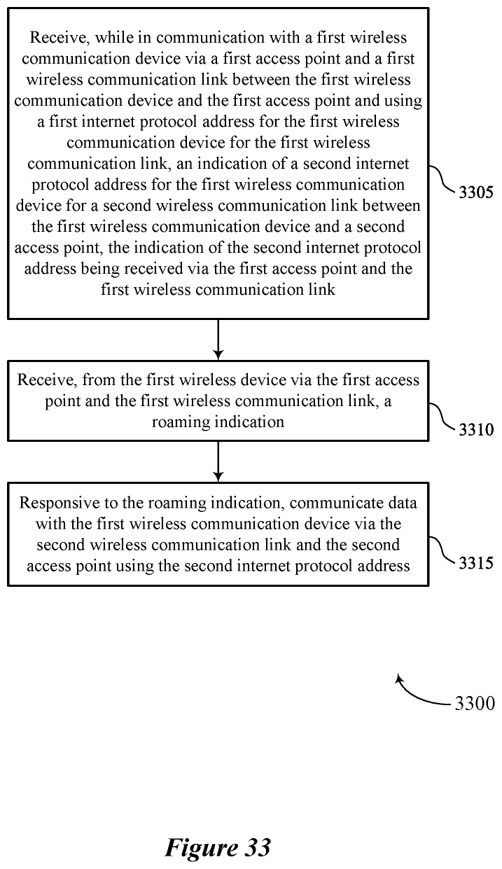

FIG. 33 illustrates a flowchart showing a method 3300 that supports seamless transitions for XPAN whole home/building coverage in accordance with one or more aspects of the present disclosure. The operations of the method 3300 may be implemented by an STA or its components as described herein. For example, the operations of the method 3300 may be performed by an STA as described with reference to FIGS. 1 through 25. In some examples, an STA may execute a set of instructions to control the functional elements of the STA to perform the described functions. Additionally, or alternatively, the STA may perform aspects of the described functions using special-purpose hardware.

At 3305, the method may include receiving, while in communication with a first wireless communication device via a first access point and a first wireless communication link between the first wireless communication device and the first access point and using a first internet protocol address for the first wireless communication device for the first wireless communication link, an indication of a second internet protocol address for the first wireless communication device for a second wireless communication link between the first wireless communication device and a second access point, the indication of the second internet protocol address being received via the first access point and the first wireless communication link. The operations of 3305 may be performed in accordance with examples as disclosed herein. In some examples, aspects of the operations of 3305 may be performed by an IP address manager 2425 as described with reference to FIG. 24.

At 3310, the method may include receiving, from the first wireless device via the first access point and the first wireless communication link, a roaming indication. The operations of 3310 may be performed in accordance with examples as disclosed herein. In some examples, aspects of the operations of 3310 may be performed by a roaming indication manager 2430 as described with reference to FIG. 24.

At 3315, the method may include responsive to the roaming indication, communicating data with the first wireless communication device via the second wireless communication link and the second access point using the second internet protocol address. The operations of 3315 may be performed in accordance with examples as disclosed herein. In some examples, aspects of the operations of 3315 may be performed by an AP link communications manager 2435 as described with reference to FIG. 24.

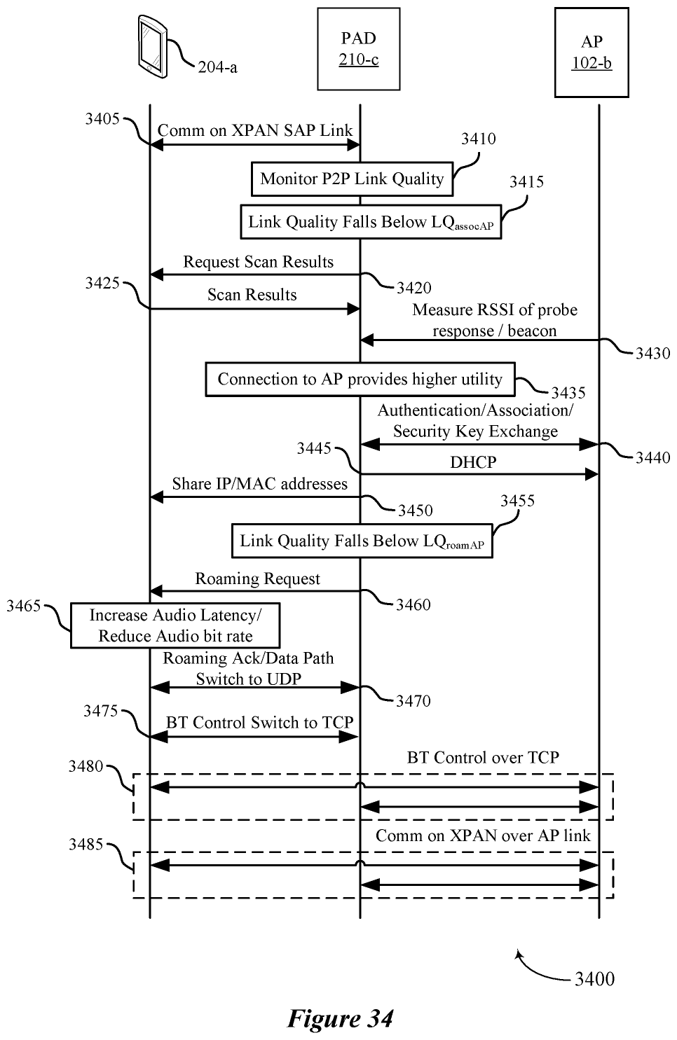

FIG. 34 illustrates an example of a process flow 3400 of a transition in an XPAN scenario between a P2P wireless connection and a personal audio device-AP connection similarly to the process flow 1400 of FIG. 14. The process flow 3400 includes the AP 102-b, the personal wireless communication device 204-a, and the personal audio device 210-c described with reference to FIG. 3. In the following description of the process flow 3400, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 3400, and other operations may be added to the process flow 3400. As the transition illustrated in the process flow 3400 establishes a connection between the personal audio device 210-c and the AP 102-b before breaking the P2P connection between the personal audio device 210-c and the personal wireless communication device 204-a, the transition illustrated in the process flow 3400 may reduce latency and packet loss as compared to a transition from a P2P connection to an AP connection in which the connection to the AP is not established prior to breaking the P2P connection.

At 3405, the personal audio device 210-c may communicate with the personal wireless communication device 204-a via an XPAN SAP wireless communication link (such as the P2P wireless communication link 106-b of FIG. 13). At 3410, the personal audio device 210-c may monitor the link quality of the P2P wireless communication link. At 3415, the personal audio device 210-c may determine that the link quality of the P2P wireless communication link falls below the threshold LQ_{AssocAP}.

In some examples, at 3420 and in response to the determination that the link quality of the XPAN SAP link (the P2P wireless communication link) falls below the threshold LQ_{AssocAP}, the personal audio device 210-c may transmit a request to the personal wireless communication device 204-a for the most recent channel scan results. The request at 3420 may be transmitted via XPAN control over BLE (for example, the bearer for the request may be XPAN control over BLE). Then at 3425, the personal wireless communication device 204-a may transmit the most recent channel scan results to the personal audio device 210-c. The signal that indicates the recent channel scan results at 3425 may be transmitted via XPAN control over BLE (for example, the bearer for the request may be XPAN control over BLE). In some examples, the personal wireless communication device 204-a may indicate with the scan results at 3425 the serving BSSID, the channel of the serving AP 102-b, and/or capabilities of the serving AP 102-b. In some examples, the personal wireless communication device 204-a may perform a channel scan if no recent scan results are available.

In an alternative example, at 3430 and in response to the determination that the link quality of the P2P wireless communication link falls below the threshold LQ_{AssocAP}, the personal audio device 210-c may measure the RSSI of a probe response or beacon from the AP 102-b. In some examples, (for example, where there are two paired earbuds), a second personal audio device 210 may also perform RSSI measurements. The bearer for the probe or beacon response may be management packets over Wi-Fi.

At 3435, based on the channel scan results or the measured RSSI of the probe response/beacon, the personal audio device 210-c may determine that a connection to the AP 102-b provides a higher utility (based on a utility function as described herein) than the P2P wireless communication link. In some examples, the utility function may bias towards the AP 102-b that serves the personal wireless communication device 204-a over other APs 102. In some examples, where there are two paired personal audio devices 210 (for example, in the case of paired earbuds), the personal audio device 210-c may synchronize with the other personal audio device 210 on the target AP 102-b.

At 3440, the personal audio device 210-c may perform an authentication procedure, an association procedure, and/or a security key exchange procedure with the AP 102-b. At 3445, the personal audio device 210-c may perform a DHCP server negotiation with the AP 102-b. Accordingly, at 3440 and 3445, the personal audio device 210-c may connect with the AP 102-b and receive an IP and/or MAC address for communication with the AP 102-b. The bearer for the authentication procedure and the association procedure at 3440 may be management packets over Wi-Fi. The bearer for the security key exchange procedure (also referred to as extensible authentication protocol over LAN (EAPOL) 4-Way handshake) and/or the DHCP server negotiation at 3440 and 3445 may be UDP data.

At 3450, the personal audio device 210-c may share, with the personal wireless communication device 204-a, an IP address and/or a MAC address for the personal audio device 210-c received at 3440 or 3455. In some examples, where there are two paired personal audio devices 210 (for example, in the case of paired earbuds), the personal audio device 210-c may also share at 3450 the IP and/or MAC addresses of the other personal audio device 210 with the personal wireless communication device 204-a. The bearer for the signal at 3450 that shares the IP and/or MAC addresses may be XPAN control over BLE.

At 3455, the personal audio device 210-c may determine that the link quality of the XPAN SAP link (for example, the P2P wireless communication link 106-b) drops below a second threshold (LQ_{roamAP}). At 3460, in response to the link quality dropping below the second threshold (LQ_{roamAP}), the personal audio device 210-c may transmit a roaming request to the personal wireless communication device 204-a. The bearer for the roaming request at 3460 may be XPAN control over BLE. At 3465, in response to the roaming request, the personal wireless communication device 204-a may increase audio latency and/or may reduce audio bit rate for XPAN over AP.

At 3470, the personal wireless communication device 204-a may transmit a roaming acknowledgment to the personal audio device 210-c and/or may transmit a signal that indicates a data path switch to UDP. The bearer for the signal at 3470 may be XPAN control over BLE. At 3475, the personal wireless communication device 204-a may exchange a signal with the personal audio device 210-c that indicates a BT control switch to TCP. The bearer for the signal at 3475 may be XPAN control over BLE. At 3480, the personal wireless communication device 204-a may transmit a BT control over TCP to the personal audio device 210-c via the AP 102-c. The bearer for the BT control over TCP at 3480 may be XPAN Control over Wi-Fi TCP.

At 3485, the personal wireless communication device 204-a and the personal audio device may communicate via the AP 102-b via an XPAN over AP wireless communication link (for example, via the wireless communication link 106-a and the wireless communication link 106-c of FIG. 13). In some examples, the personal wireless communication device 204-a and the personal audio device may maintain the XPAN SAP link at low power, for example, for possible future reverse transitions. The bearer for the maintained XPAN SAP link at low power may be XPAN Control over Wi-Fi TCP.

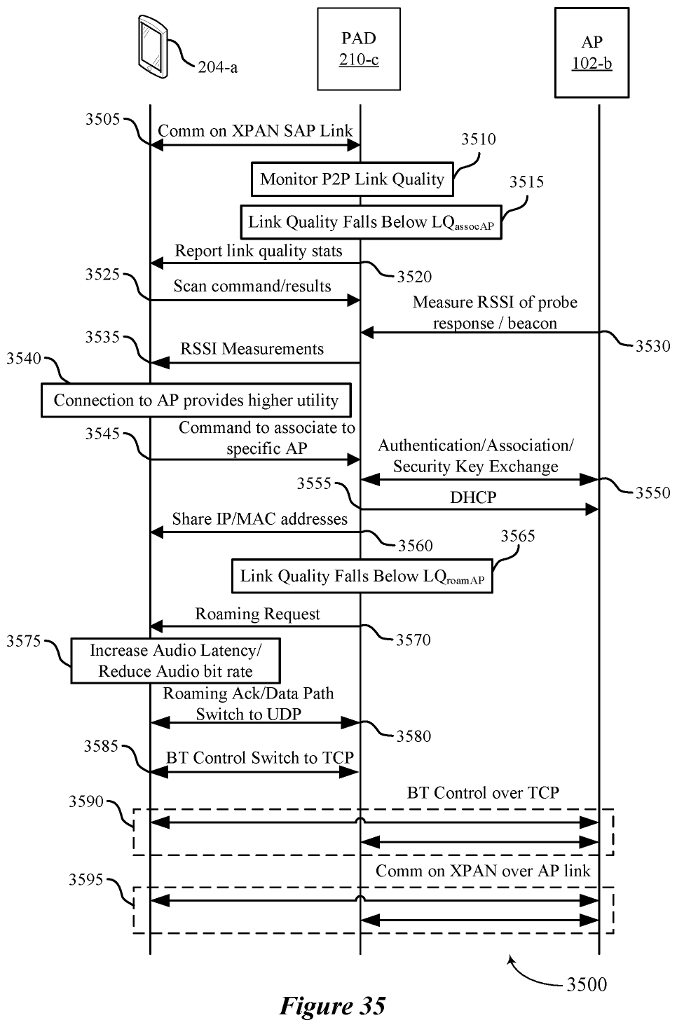

FIG. 35 illustrates an example of a process flow 3500 of a transition in an XPAN scenario between a P2P wireless connection at a first time and a personal audio device-AP connection, where the personal wireless communication device assists in the initiation of the transition, similarly to the process flow 1500 of FIG. 15. The process flow 3500 includes the AP 102-b, the personal wireless communication device 204-a, and the personal audio device 210-c described with reference to FIG. 3. In the following description of the process flow 3500, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 3500, and other operations may be added to the process flow 3500. As the transition illustrated in the process flow 3500 establishes a connection between the personal audio device 210-c and the AP 102-b before breaking the P2P connection between the personal audio device 210-c and the personal wireless communication device 204-a, the transition illustrated in the process flow 3500 may reduce latency and packet loss as compared to a transition from a P2P connection to an AP connection in which the connection to the AP is not established prior to breaking the P2P connection. Additionally, as the personal wireless communication device 204-a assists in the initiation of the transition, less processing may be performed at the personal audio device 210-c, which may reduce latency as the personal wireless communication device 204-a may have more processing power than the personal audio device 210-c and/or may reduce power consumption at the personal audio device 210-c.

At 3505, the personal audio device 210-c may communicate with the personal wireless communication device 204-a via an XPAN SAP wireless communication link (such as the P2P wireless communication link 106-b of FIG. 13). At 3510, the personal audio device 210-c may monitor the link quality of the P2P wireless communication link. At 3515, the personal audio device 210-c may determine that the link quality of the P2P wireless communication link falls below the threshold LQ_{AssocAP}.

At 3520, the personal audio device 210-c may transmit an indication of the link quality statistics of the P2P wireless communication link to the personal wireless communication device 204-a. At 3525, the personal wireless communication device 204-a may transmit either an indication of channel scan results at the personal wireless communication device 204-a or channel scan command to the personal audio device 210-c. The bearers of the signals at 3520 and 3525 may be XPAN Control over BLE. In some examples, the personal wireless communication device 204-a may indicate with the scan results at 3525 the serving BSSID, the channel of the serving AP 102-b, and/or capabilities of the serving AP 102-b.

In an alternative example, at 3530 and in response to the determination that the link quality of the P2P wireless communication link falls below the threshold LQ_{AssocAP}, the personal audio device 210-c may measure the RSSI of a probe response or beacon from the AP 102-b. In some examples, (for example, where there are two paired earbuds), a second personal audio device 210 may also perform RSSI measurements. The bearer for the probe or beacon response may management packets over Wi-Fi. At 3535, the personal audio device 210-c may transmit a signal to the personal wireless communication device 204-a that indicates the RSSI measurements measured at 1530. The bearer for the signal at 3535 may be XPAN Control over BLE.

At 3540, the personal wireless communication device 204-a may determine that a connection to the AP 102-b provides a higher utility (based on a utility function as described herein) than the XPAN SAP (for example, the P2P wireless communication link). At 3545 in response to the determination that the connection to the AP 102-b provides a higher utility than the XPAN SAP communication link, the personal wireless communication device 204-a transmits a command to the personal audio device 210-c to associate with a specific AP 102-b. The bearer for the command at 3545 may be XPAN Control over BLE.

At 3550, the personal audio device 210-c may perform an authentication procedure, an association procedure, and/or a security key exchange procedure with the AP 102-b. At 3555, the personal audio device 210-c may perform a DHCP server negotiation with the AP 102-b. Accordingly, at 3550 and 3555, the personal audio device 210-c may connect with the AP 102-b and receive an IP and/or MAC address for communication with the AP 102-b. The bearer for the authentication procedure and the association procedure at 3550 may be management packets over Wi-Fi. The bearer for the security key exchange procedure and/or the DHCP server negotiation at 3550 and 3555 may be UDP data.

At 3560, the personal audio device 210-c may share, with the personal wireless communication device 204-a, an IP address and/or a MAC address for the personal audio device 210-c received at 3550 or 3555. In some examples, where there are two paired personal audio devices 210 (for example, in the case of paired earbuds), the personal audio device 210-c may also share at 3560 the IP and/or MAC addresses of the other personal audio device 210 with the personal wireless communication device 204-a. The bearer for the signal at 3560 that shares the IP and/or MAC addresses may be XPAN control over BLE.

At 3565, the personal audio device 210-c may determine that the link quality of the XPAN SAP link (for example, the P2P wireless communication link 106-b) drops below a second threshold (LQ_{roamAP}). At 3570, in response to the link quality dropping below the second threshold (LQ_{roamAP}), the personal audio device 210-c may transmit a roaming request to the personal wireless communication device 204-a. The bearer for the roaming request at 3570 may be XPAN control over BLE. A 3575, in response to the roaming request, the personal wireless communication device 204-a may increase audio latency and/or may reduce audio bit rate for XPAN over AP.

At 3580, the personal wireless communication device 204-a may transmit a roaming acknowledgment to the personal audio device 210-c and/or may transmit a signal that indicates a data path switch to UDP. The bearer for the signal at 3580 may be XPAN control over BLE. At 3585, the personal wireless communication device 204-a may exchange a signal with the personal audio device 210-c that indicates a BT control switch to TCP. The bearer for the signal at 3585 may be XPAN control over BLE. At 3590, the personal wireless communication device 204-a may transmit a BT control over TCP to the personal audio device 210-c via the AP 102-c. The bearer for the BT control over TCP at 3590 may be XPAN Control over Wi-Fi TCP.

At 3595, the personal wireless communication device 204-a and the personal audio device may communicate via the AP 102-b via an XPAN over AP wireless communication link (for example, via the wireless communication link 106-a and the wireless communication link 106-c of FIG. 13). In some examples, the personal wireless communication device 204-a and the personal audio device may maintain the XPAN SAP link at low power, for example, for possible future reverse transitions. The bearer for the maintained XPAN SAP link at low power may be XPAN Control over Wi-Fi TCP.

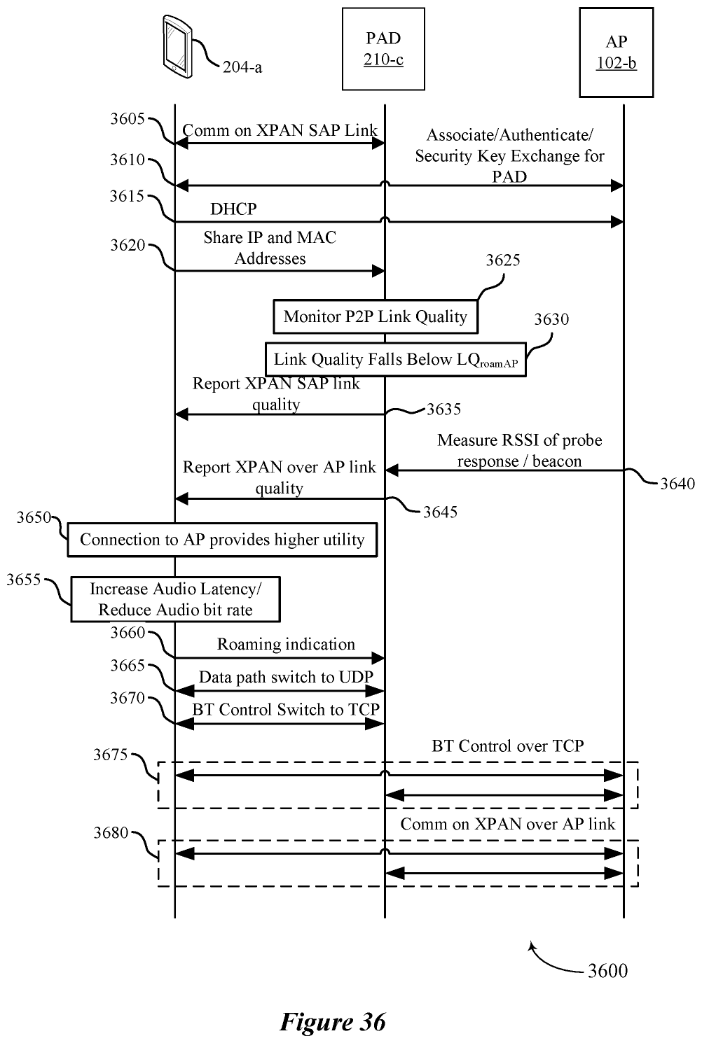

FIG. 36 illustrates an example of a process flow 3600 of a transition in an XPAN scenario between a P2P wireless connection and a personal audio device-AP connection where the personal wireless communication device 204-a performs an authentication/association procedure with the AP 102-b for the personal audio device 210-c similarly to the process flow 1700 of FIG. 17. The process flow 3600 includes the AP 102-b, the personal wireless communication device 204-a, and the personal audio device 210-c described with reference to FIG. 3. In the following description of the process flow 3600, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 3600, and other operations may be added to the process flow 3600. As the transition illustrated in the process flow 3600 establishes a connection between the personal audio device 210-c and the AP 102-b before breaking the P2P connection between the personal audio device 210-c and the personal wireless communication device 204-a, the transition illustrated in the process flow 3600 may reduce latency and packet loss as compared to a transition from a P2P connection to an AP connection in which the connection to the AP is not established prior to breaking the P2P connection. Additionally, as the personal wireless communication device 204-a establishes the AP connection for the personal audio device 210-c, less processing may be performed at the personal audio device 210-c, which may reduce latency as the personal wireless communication device 204-a may have more processing power than the personal audio device 210-c and/or may reduce power consumption at the personal audio device 210-c.

At 3605, the personal audio device 210-c may communicate with the personal wireless communication device 204-a via a XPAN SAP wireless communication link (such as the P2P wireless communication link 106-b of FIG. 13).

At 3610, the personal wireless communication device 204-a may perform an authentication procedure, an association procedure, and/or a security key exchange procedure with the AP 102-b for the personal audio device 210-c. At 3615, the personal wireless communication device 204-a may perform a DHCP server negotiation with the AP 102-b for the personal audio device 210-c. The bearer for the authentication procedure and the association procedure at 3610 may be management packets over Wi-Fi. The bearer for the security key exchange procedure and/or the DHCP server negotiation at 3610 and 3615 may be UDP Data. At 3620, the personal wireless communication device 204-a may transmit a signal that shares the IP and/or MAC addresses received at 3610 and/or 3615 with the personal audio device 210-c. The bearer for the signal at 3620 may be UDP Data, Wi-Fi Control, or management over Wi-Fi.

At 3625, the personal audio device 210-c may monitor the link quality of the XPAN SAP wireless communication link (for example, the P2P wireless communication link). At 3630, the personal audio device 210-c may determine that the link quality of the XPAN SAP wireless communication link (for example, the P2P wireless communication link) falls below the threshold LQ_{AssocAP}.

At 3635, the personal audio device 210-c may transmit a signal that indicates the link quality statistics of the XPAN SAP wireless communication link (for example, the P2P wireless communication link) to the personal wireless communication device 204-a. The bearer of the signal at 3635 may be XPAN Control over BLE.

At 3640, the personal audio device 210-c may measure the RSSI of a probe response or beacon from the AP 102-b. The bearer of the probe response or beacon at 3640 may be management packets over Wi-Fi. At 3645, the personal audio device 210-c may transmit an indication of the XPAN over AP link quality (for example the RSSI measurements) to the personal wireless communication device 204-a. The bearer of the signal at 3645 may be XPAN Control over BLE.

At 3650, the personal wireless communication device 204-a may determine that a connection to the AP 102-b provides a higher utility (based on a utility function as described herein) than the P2P wireless communication link.

At 3655, in response to the determination that the connection to the AP 102-b provides a higher utility, the personal wireless communication device 204-a may increase audio latency and/or may reduce audio bit rate for XPAN over AP.

At 3660, in response to the determination that the connection to the AP 102-b provides a higher utility, the personal wireless communication device 204-a may transmit a roaming indication to the personal audio device 210-c. The bearer for the roaming indication at 3660 may be XPAN control over BLE.

At 3665, the personal wireless communication device 204-a may transmit a signal that indicates a data path switch to UDP. The bearer for the signal at 3665 may be XPAN control over BLE. At 3670, the personal wireless communication device 204-a may exchange a signal with the personal audio device 210-c that indicates a BT control switch to TCP. The bearer for the signal at 3670 may be XPAN control over BLE. At 3675, the personal wireless communication device 204-a may transmit a BT control over TCP to the personal audio device 210-c via the AP 102-c. The bearer for the BT control over TCP at 3675 may be XPAN Control over Wi-Fi TCP.

At 3680, the personal wireless communication device 204-a and the personal audio device may communicate via the AP 102-b via an XPAN over AP wireless communication link (for example, via the wireless communication link 106-a and the wireless communication link 106 c of FIG. 13). In some examples, the personal wireless communication device 204-a and the personal audio device may maintain the XPAN SAP link at low power, for example, for possible future reverse transitions. The bearer for the maintained XPAN SAP link at low power may be XPAN Control over Wi-Fi TCP.

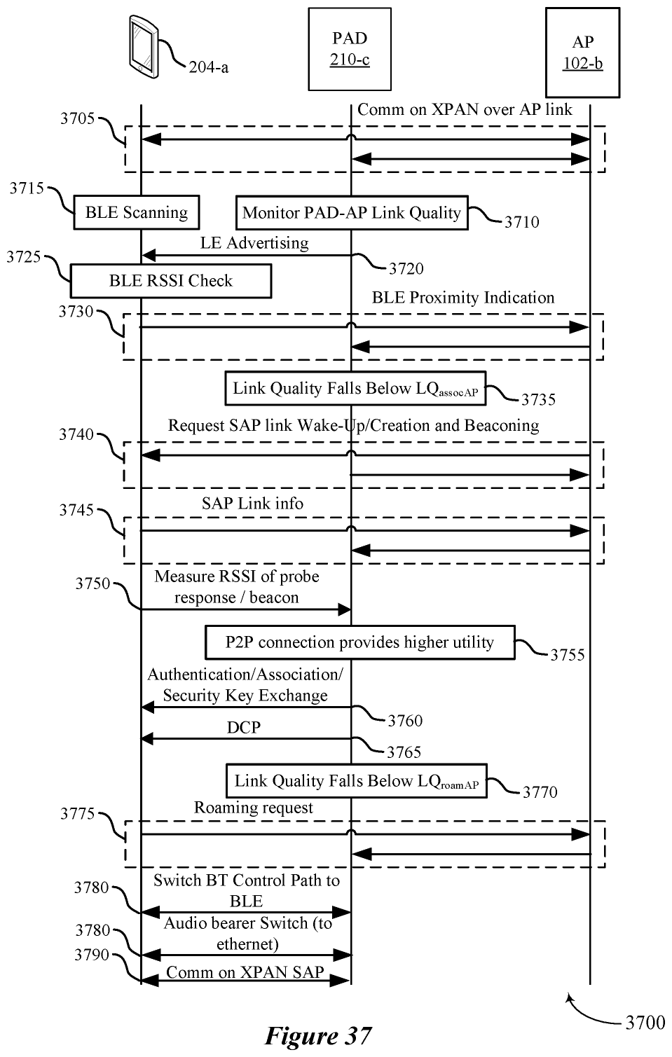

FIG. 37 illustrates an example of a process flow 3700 of a transition in an XPAN scenario between a personal audio device-AP connection and a P2P wireless connection similarly to the process flow 1900 of FIG. 19. The process flow 3700 includes the AP 102-b, the personal wireless communication device 204-a, and the personal audio device 210-c described with reference to FIG. 3. In the following description of the process flow 3700, the operations between the AP 102-b, the personal wireless communication device 204-a, and the personal audio device 210-c may be transmitted in a different order than the example order shown, or the operations performed by the AP 102-b, the personal wireless communication device 204-a, and the personal audio device 210-c may be performed in different orders or at different times. Some operations may also be omitted from the process flow 3700, and other operations may be added to the process flow 3700. As the transition illustrated in the process flow 3700 establishes a P2P connection between the personal audio device 210-c and the personal wireless communication device 204-a before breaking the connection between the personal audio device 210-c and the AP 102-b, the transition illustrated in the process flow 3700 may reduce latency and packet loss as compared to a transition from a personal audio device-AP connection to P2P connection in which the P2P connection is not established prior to breaking the personal audio device-AP connection.

At 3705, the personal wireless communication device 204-a and the personal audio device 210-c may communicate via the AP 102-b (via the wireless communication link 106-a and the wireless communication link 106-c of FIG. 18), for example, via an XPAN over AP wireless communication link. For example, the personal wireless communication device 204-a may encapsulate audio data in UDP packets.

At 3710, the personal audio device 210-c may monitor the link quality of the XPAN over AP wireless communication link between the personal audio device 210-c and the AP 102-b (for example, the wireless communication link 106-c of FIG. 18). At 3715, the personal wireless communication device 204-a may perform BLE scanning when the personal audio device 210-c is out of range. At 3720, the personal audio device 210-c may perform BLE advertising. The low energy advertising at 3720 may be performed periodically when outside of the XPAN coverage of the personal wireless communication device 204-a. The bearer of the low energy advertising at 3720 may be XPAN Control over BLE.

At 3725, the personal wireless communication device 204-a may perform a BLE RSSI check on the low energy advertising signal received at 3720. At 3730, the personal wireless communication device 204-a may transmit a BLE proximity indication to the personal audio device 210-c via the AP 102-b. The bearer of the BLE proximity indication at 3730 may be XPAN Control over Wi-Fi TCP.

At 3735, the personal audio device 210-c may determine that the link quality of the XPAN over AP wireless communication link between the personal audio device 210-c and the AP 102-b link drops below a first threshold (LQ_{assocAP}).

In response to the link quality of the XPAN over AP wireless communication link between the personal audio device 210-c and the AP 102-b link dropping below the first threshold (LQ_{assocAP}), at 3740 the personal audio device 210-c may transmit a request for XPAN SAP link wake-up or creation and beaconing. The request at 3740 may be transmitted to the personal wireless communication device 204-a via the AP 102-b. The bearer of the request at 3740 may be XPAN Control over Wi-Fi TCP. At 3745, the personal wireless communication device 204-a may transmit a signal indicating XPAN SAP link information (for example, channel or TBTT). The signal at 3745 may be transmitted to the personal audio device 210-c via the AP 102-b. The bearer of the signal at 3745 may be XPAN Control over Wi-Fi TCP.

At 3750, the personal audio device 210-c measures the RSSI of a beacon or probe response transmitted by the personal wireless communication device 204-a on the SAP link. At 3755, the personal audio device 210-c determines that the XPAN SAP wireless communication link (for example, the direct P2P connection to the personal wireless communication device 204-a) provides a higher utility than the XPAN over AP connection through the AP 102-b via the wireless communication link between the personal audio device 210-c and the AP 102-b. In scenarios where there are two personal audio devices (such as two earbuds), the primary personal audio device 210-c may share the determination that the direct P2P connection to the personal wireless communication device 204-a provides a higher utility than the connection through the AP 102-b via the wireless communication link between the personal audio device 210-c and the AP 102-b.

In response to the determination at 3755, at 3760 the personal audio device 210-c may perform an authentication procedure, an association procedure, and/or a security key exchange procedure with the personal wireless communication device 204-a. At 3765, the personal audio device 210-c may perform a DHCP server negotiation with the personal wireless communication device 204-a. Accordingly, at 3760 and 3765, the personal audio device 210-c may connect with the personal wireless communication device 204-a and receive an IP and/or MAC address for direct communication with the personal wireless communication device 204-a. The bearer for the authentication procedure and the association procedure at 3760 may be management packets over Wi-Fi. The bearer for the security key exchange procedure and/or the DHCP server negotiation at 3760 and 3765 may be UDP data.

At 3770, the personal audio device 210-c may determine that the link quality of the XPAN over AP wireless communication link between the personal audio device 210-c and the AP 102-b link drops below a second threshold (LQ_{roamHS}). In response to the link quality of the XPAN over AP wireless communication link between the personal audio device 210-c and the AP 102-b link dropping below the second threshold (LQ_{roamHS}), at 3775, the personal audio device 210-c may transmit a roaming request to the AP 102-b and/or the personal wireless communication device 204-a. The bearer of the roaming request may be XPAN Control over Wi-Fi TCP.

At 3780, the personal audio device 210-c may switch the BT control path to BLE (for example, to low energy ACL) from TCP. The bearer for the signaling to switch the BT control path to BLE may be XPAN Control over BLE. At 3785, the personal audio device 210-c may switch the audio bearer to ethernet. he bearer for the signaling to switch the audio bearer to ethernet may be XPAN Control over BLE.

At 3790, the personal audio device 210-c may communicate with the personal wireless communication device 204-a via the XPAN SAP wireless communication link (for example, a P2P wireless communication link as the P2P wireless communication link 106-b of FIG. 18).

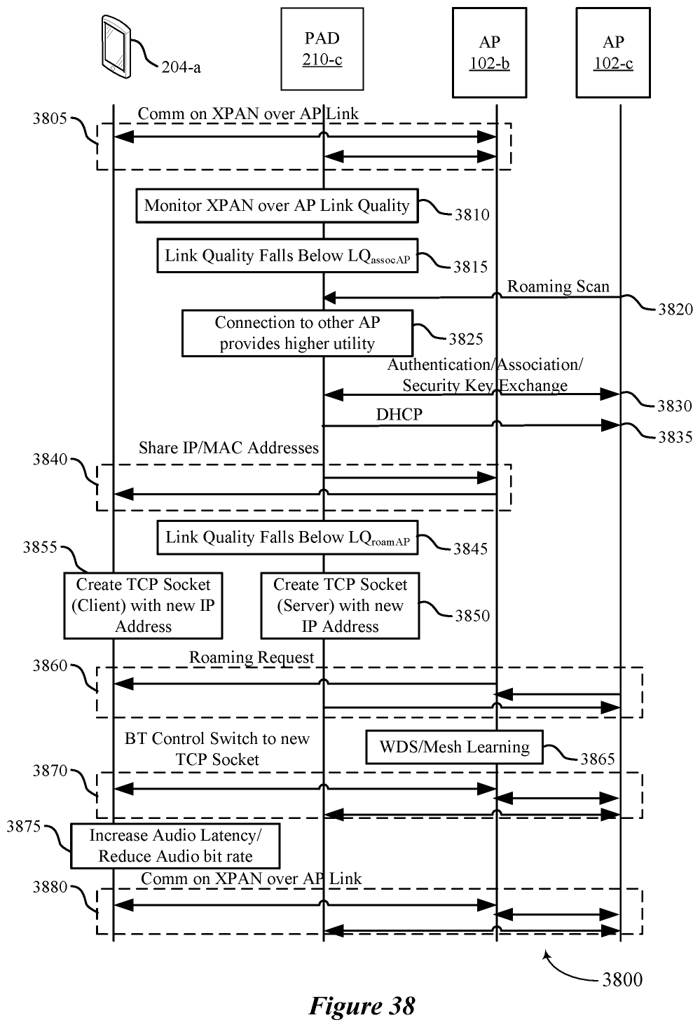

FIG. 38 illustrates an example of a process flow 3800 of a transition between a personal audio device-first AP connection and a personal audio device-second AP connection similarly to the process flow 2100 of FIG. 21. The process flow 3800 includes the AP 102-b, the personal wireless communication device 204-a, and the personal audio device 210-c described with reference to FIG. 3. The process flow 3800 further includes an AP 102-c, which may be an example of an AP 102 as described herein. In the following description of the process flow 3800, the operations between the AP 102-b, the AP 102-c, the personal wireless communication device 204-a, and the personal audio device 210-c may be transmitted in a different order than the example order shown, or the operations performed by the AP 102-b, the AP 102-c, the personal wireless communication device 204-a, and the personal audio device 210-c may be performed in different orders or at different times. Some operations may also be omitted from the process flow 3800, and other operations may be added to the process flow 3800. As the transition illustrated in the process flow 3800 establishes a connection between the personal audio device 210-c and the second AP 102-c before breaking the connection between the personal audio device 210-c and the AP 102-b, the transition illustrated in the process flow 3800 may reduce latency and packet loss as compared to a transitions between APs in which a connection to a new AP is not made until a connection to a current AP is broken.

At 3805, the personal wireless communication device 204-a and the personal audio device 210-c may communicate via an XPAN over AP wireless communication link involving the AP 102-b (via the wireless communication link 106-a and the wireless communication link 106-c of FIG. 20). For example, the personal wireless communication device 204-a may encapsulate audio data in UDP packets.

At 3810, the personal audio device 210-c may monitor the link quality of the XPAN over AP wireless communication link between the personal audio device 210-c and the AP 102-b (the wireless communication link 106-c of FIG. 20). At 3815, the personal audio device 210-c may determine that the link quality of the wireless communication link between the personal audio device 210-c and the AP 102-b link drops below a first threshold (LQ_{assocAP}) and the personal audio device 210-c is not within range of the personal wireless communication device 204-a.

At 3820, the personal audio device 210-c may perform a roaming scan on a set of channels (for a set of APs including the AP 102-c). For example, the personal audio device 210-c may measure the respective RSSIs from beacons or probe responses from the set of APs 102 for the set of channels. The bearer of the beacons or probe responses may be management packets over Wi-Fi. At 3825, the personal audio device 210-c may determine that connection to the AP 102-c provides a higher utility function than connection to the AP 102-b. In scenarios where there are two personal audio devices (such as two earbuds), the primary personal audio device 210-c may share the determination that connection to the AP 102-c provides a higher utility function than connection to the AP 102-b.

At 3830, in response to the determination at 3825, the personal audio device 210-c may c may perform an authentication procedure, an association procedure, and/or a security key exchange procedure with the AP 102-c. At 3835, the personal audio device 210-c may perform a DHCP server negotiation with the AP 102-c. Accordingly, at 3830 and 3835, the personal audio device 210-c may connect with the AP 102-c and receive an IP and/or MAC address for communication with the AP 102-b. The bearer for the authentication procedure and the association procedure at 3830 may be management packets over Wi-Fi. The bearer for the security key exchange procedure and/or the DHCP server negotiation at 3830 and 3835 may be UDP data.

At 3840, the personal audio device 210-c may transmit a signal that indicates the IP and/or MAC addresses received at 3830 and/or 3835 to the personal wireless communication device 204-a. The signal at 3840 may be transmitted via the AP 102-b (for example, via the XPAN over AP wireless communication link involving the AP 102-b (via the wireless communication link 106-a and the wireless communication link 106-c of FIG. 20)). The bearer of the signal at 3840 may be XPAN Control over Wi-Fi TCP.

At 3845, the personal audio device 210-c determines that the link quality of the XPAN over AP wireless communication link between the personal audio device 210-c and the AP 102-b link drops below a second threshold (LQ_{roamHS}). In response to the determination at 3845 the personal audio device 210-c may create a TCP socket (server) with the new IP address. At 3850, the personal wireless communication device 204-a may create a TCP socket (client) with the new IP address. At 3855, the personal audio device 210-c may create a TCP socket (server) with the new IP address.

In response to the determination at 3845, at 3860 the personal audio device 210-c may transmit a roaming request indicating the desired destination AP (the AP 102-c). The roaming request 3860 may be transmitted to the personal wireless communication device 204-a via the AP 102-c and the AP 102-b (for example, via multiple hops). The bearer of the roaming request may be XPAN Control over Wi-Fi TCP. At 3865, in response to the roaming request, the AP 102-b may perform mesh learning or wireless distribution system (WDS). WDS may refer to APs 102 in a network learning how to route a packet to/from the final destination of the packet.

At 3870, the personal audio device 210-c may switch BT control to the new TCP socket created at 3850. The bearer for the signaling to switch BT control to the new TCP socket may be XPAN Control over Wi-Fi TCP.

At 3875, the personal wireless communication device 204-a may increase audio latency, reduce audio bit rate, and/or pause traffic due to switch to the new AP (the AP 102-c), which may increase latency. The adjustments to audio latency, audio bit rate, or traffic may be use case specific.

At 3880, the personal audio device 210-c may communicate with the personal wireless communication device 204-a via the new XPAN over AP wireless communication link (through the AP 102-c and the AP 102-b via multiple hops).

The following provides an overview of aspects of the present disclosure:

Aspect 1: A method for wireless communications at a first wireless communication device, comprising: receiving, while in communication with a second wireless communication device on a P2P wireless communication link and from an AP associated with the second wireless communication device, an IP address for the first wireless communication device for a second wireless communication link between the first wireless communication device and the AP; responsive to a first link quality of the P2P wireless communication link falling below a first threshold, communicating a roaming indication with the second wireless communication device on the P2P wireless communication link; and responsive to the roaming indication, communicating data with the second wireless communication device via the second wireless communication link, and the AP.

Aspect 2: The method of aspect 1, further comprising: responsive to the first link quality dropping below a second threshold, performing an association procedure with the AP to receive the IP address.

Aspect 3: The method of aspect 2, further comprising: receiving, from the second wireless communication device on the P2P wireless communication link, a message indicating that the first link quality dropped below the second threshold.

Aspect 4: The method of aspect 3, further comprising: receiving, with the message, an indication of a serving AP for the second wireless communication device.

Aspect 5: The method of any of aspects 2 through 4, further comprising: responsive to the first link quality dropping below the second threshold, transmitting, to the second wireless communication device on the P2P wireless communication link, a request for channel scan results associated with the second wireless communication link; receiving, from the second wireless communication device on the P2P wireless communication link in response to the request, a channel scan result associated with the second wireless communication link; and responsive to the channel scan result indicating a second link quality of the second wireless communication link satisfies a third threshold, performing the association procedure with the AP to receive the IP address.

Aspect 6: The method of aspect 5, further comprising: receiving, from the second wireless communication device on the P2P wireless communication link in response to the request, a set of channel scan results for a set of wireless communication links corresponding to a set of APs, the set of APs including the AP; and selecting the AP from the set of APs in response to the set of channel scan results.

Aspect 7: The method of any of aspects 2 through 6, further comprising: responsive to the first link quality dropping below the second threshold, receiving a beacon from the AP on the second wireless communication link; determining a second link quality of the second wireless communication link using the beacon; and responsive to the second link quality satisfying a third threshold, performing the association procedure with the AP to receive the IP address.

Aspect 8: The method of any of aspects 2 through 7, further comprising: responsive to the first link quality dropping below the second threshold, transmitting a probe request to the AP; responsive to the probe request, receiving, from the AP, a probe response; determining a second link quality of the second wireless communication link using the probe response; and responsive to the second link quality satisfying a third threshold, performing the association procedure with the AP to receive the IP address.

Aspect 9: The method of any of aspects 2 through 8, further comprising: transmitting an indication of the IP address or a MAC address of the first wireless communication device to the second wireless communication device on the P2P wireless communication link.

Aspect 10: The method of any of aspects 2 through 9, further comprising: responsive to the first link quality dropping below the second threshold, transmitting, to a third wireless communication device on a BT wireless communication link between the first wireless communication device and the third wireless communication device, an indication of the AP.

Aspect 11: The method of any of aspects 1 through 10, further comprising: communicating, with the second wireless communication device on the P2P wireless communication link, a disassociation message in response to the roaming indication.

Aspect 12: The method of any of aspects 1 through 11, further comprising: determining, in accordance with a utility function, that a second link quality of the second wireless communication link is better than the first link quality; and performing an association procedure with the AP to receive the IP address in response to the determination that the second link quality is better than the first link quality.

Aspect 13: The method of aspect 12, wherein the utility function includes at least one of a channel type for each of the P2P wireless communication link and the second wireless communication link, a received signal strength indicator value for each of the P2P wireless communication link and the second wireless communication link, and a bias factor for the P2P wireless communication link.

Aspect 14: The method of any of aspects 12 through 13, further comprising: switching a channel of the P2P wireless communication link to a same channel as the second wireless communication link in response to the association procedure.

Aspect 15: A method for wireless communications at a second wireless communication device, comprising: receiving, while in communication with a first wireless communication device on a P2P wireless communication link, and while in communication with an AP on a third wireless communication link, an IP address from the first wireless communications device for the first wireless communication device for a second wireless communication link between the first wireless communication device and the AP; responsive to a link quality of the P2P wireless communication link between the first wireless communication device and the second wireless communication device falling below a first threshold, communicating a roaming indication with the first wireless communication device on the P2P wireless communication link; and responsive to the roaming indication, communicating data with the first wireless communication device via the third wireless communication link and the AP using the IP address for the first wireless communication device.

Aspect 16: The method of aspect 15, further comprising: transmitting, to the first wireless communication device on the P2P wireless communication link, a message indicating that the first link quality dropped below a second threshold, reception of the IP address being responsive to the message.

Aspect 17: The method of aspect 16, further comprising: transmitting, with the message, an indication of a serving AP for the second wireless communication device.

Aspect 18: The method of any of aspects 15 through 17, further comprising: responsive to the first link quality dropping below a second threshold, receiving, from the first wireless communication device on the P2P wireless communication link, a request for channel scan results associated with the second wireless communication link; transmitting, to the first wireless communication device on the P2P wireless communication link in response to the request, a channel scan result associated with the second wireless communication link, reception of the IP address being responsive to the channel scan result indicating a second link quality of the second wireless communication link satisfies a third threshold.

Aspect 19: The method of aspect 18, further comprising: transmitting, to the first wireless communication device on the P2P wireless communication link in response to the request, a set of channel scan results for a set of wireless communication links corresponding to a set of APs, the set of APs including the AP.

Aspect 20: The method of any of aspects 15 through 19, further comprising: communicating, with the first wireless communication device on the P2P wireless communication link, a disassociation message in response to the roaming indication.

Aspect 21: The method of any of aspects 15 through 20, further comprising: switching a channel of the P2P wireless communication link to a same channel as the second wireless communication link in response reception of the IP address.

Aspect 22: A method for wireless communications at a first wireless communication device, comprising: receiving, while in communication with a second wireless communication device on a P2P wireless communication link and from the second wireless communication device, an indication of an IP address for the first wireless communication device for a second wireless communication link between the first wireless communication device and an AP associated with the second wireless communication device; responsive to a first link quality of the P2P wireless communication link falling below a first threshold, communicating a roaming indication with the second wireless communication device on the P2P wireless communication link; and responsive to the roaming indication, communicating data with the second wireless communication device via the second wireless communication link, and the AP.

Aspect 23: The method of aspect 22, further comprising: receiving, from the second wireless communication device on the P2P wireless communication link, a message indicating that the first link quality dropped below the second threshold.

Aspect 24: The method of aspect 23, further comprising: receiving, with the message, an indication of a serving AP for the second wireless communication device.

Aspect 25: The method of any of aspects 22 through 24, further comprising: communicating, with the second wireless communication device on the P2P wireless communication link, a disassociation message in response to the roaming indication.

Aspect 26: The method of any of aspects 22 through 25, further comprising: determining, in accordance with a utility function, that a second link quality of the second wireless communication link is better than the first link quality, transmission of the roaming indication being responsive to the determination that the second link quality is better than the first link quality.

Aspect 27: The method of aspect 26, wherein the utility function includes at least one of a channel type for each of the P2P wireless communication link and the second wireless communication link, a received signal strength indicator value for each of the P2P wireless communication link and the second wireless communication link, an a bias factor for the P2P wireless communication link.

Aspect 28: A method for wireless communications at a second wireless communication device, comprising: performing, while in communication with a first wireless communication device on a P2P wireless communication link, and while in communication with an AP on a third wireless communication link, an association procedure with an AP using a MAC address for the first wireless communication device to receive an IP address for the first wireless communication device for a second wireless communication link between the first wireless communication device and the AP; transmitting, to the first wireless device on the P2P wireless communication link, the IP address; responsive to a link quality of a P2P wireless communication link between the first wireless communication device and the second wireless communication device falling below a first threshold, communicating a roaming indication with the first wireless communication device on the P2P wireless communication link; and responsive to the roaming indication, communicating data with the first wireless communication device via the third wireless communication link and the AP using the IP address for the first wireless communication device.

Aspect 29: The method of aspect 28, further comprising: transmitting, to the first wireless communication device on the P2P wireless communication link, a message indicating that the first link quality dropped below the second threshold.

Aspect 30: The method of aspect 29, further comprising: transmitting, with the message, an indication of a serving AP for the second wireless communication device.

Aspect 31: The method of any of aspects 28 through 30, further comprising: communicating, with the first wireless communication device on the P2P wireless communication link, a disassociation message in response to the roaming indication.

Aspect 32: A method for wireless communications at a first wireless communication device, comprising: receiving, from a second wireless communication device while in communication with the second wireless communication device via a second wireless communication link between the first wireless communication device and an AP and via the AP and a third wireless communication link between the AP and the second wireless communication device, a beacon or a probe response on a P2P wireless communication link; responsive to a first link quality of the P2P wireless communication link satisfying a first threshold, the first link quality detected using the beacon or the probe response, performing an association procedure with the second wireless communication device for the P2P wireless communication link; transmitting, in response to the association procedure, a disassociation message to the AP for the second wireless communication link; and communicating data with the second wireless communication device on the P2P wireless communication link.

Aspect 33: The method of aspect 32, further comprising: responsive to a second link quality of the second wireless communication link falling below a second threshold, monitoring for the beacon on the P2P wireless communication link.

Aspect 34: The method of any of aspects 32 through 33, further comprising: responsive to a second link quality of the second wireless communication link falling below a second threshold, transmitting via the second wireless communication link and the AP, a probe request, reception of the probe response being responsive to the probe request.

Aspect 35: The method of any of aspects 32 through 34, further comprising: periodically monitoring for beacons from the second wireless communication device while in communication with the second wireless communication device via the second wireless communication link and via the AP and the third wireless communication link, reception of the beacon responsive to the periodic monitoring.

Aspect 36: The method of any of aspects 32 through 35, further comprising: responsive to a second link quality of the second wireless communication link falling below a second threshold, transmitting, to the second wireless communication device via the second wireless communication link and the AP, an indication that the second link quality has dropped below the second threshold; and receiving, from the second wireless communication device via the AP and the second wireless communication link in response to the indication, scheduling information for the beacon, reception of the beacon being in accordance with the scheduling information.

Aspect 37: The method of any of aspects 32 through 36, further comprising: responsive to a second link quality of the second wireless communication link falling below a second threshold, and further responsive to a determination that the second wireless communication device is within range of a BT wireless communication link between the first wireless communication device and the second wireless communication device, transmitting, to the second wireless communication device and on the BT wireless communication link, a request to connect with the second wireless communication device; and receiving, from the second wireless communication device on the BT wireless communication link, scheduling information for the beacon, reception of the beacon being in accordance with the scheduling information.

Aspect 38: The method of any of aspects 32 through 37, further comprising: responsive to a second link quality of the second wireless communication link falling below a second threshold, and further responsive to a determination that the second wireless communication device is within range of a BT wireless communication link between the first wireless communication device and the second wireless communication device, transmitting, to the second wireless communication device and on the second wireless communication link, a probe request, reception of the probe response being responsive to the probe request.

Aspect 39: The method of any of aspects 32 through 38, wherein the first link quality of the P2P wireless communication link satisfying the first threshold comprises: determining, in accordance with a utility function, that the first link quality is better than a second link quality of the second wireless communication link.

Aspect 40: The method of aspect 39, wherein the utility function includes at least one of a channel type for each of the P2P wireless communication link and the second wireless communication link, a received signal strength indicator value for each of the P2P wireless communication link and the second wireless communication link, and a bias factor for the P2P wireless communication link.

Aspect 41: The method of any of aspects 32 through 40, wherein transmitting the disassociation message comprises: transmitting the disassociation message in response to a second link quality of the second wireless communication link falling below a second threshold.

Aspect 42: The method of any of aspects 32 through 41, further comprising: responsive to the first link quality satisfying the first threshold, transmitting, to a third wireless communication device on a BT wireless communication link between the first wireless communication device and the third wireless communication device, an indication for the third wireless communication device to perform a second association procedure with the second wireless communication device.

Aspect 43: A method for wireless communications at a second wireless communication device, comprising: transmitting, while in communication with a first wireless communication device via a third wireless communication link between the second wireless communication device and an AP and via the AP and a second wireless communication link between the first wireless communication device and the AP, a beacon or a probe response on a P2P wireless communication link; responsive to a link quality of the P2P wireless communication link satisfying a threshold, performing an association procedure with the first wireless communication device for the P2P wireless communication link; and communicating data with the first wireless communication device on the P2P wireless communication link.

Aspect 44: The method of aspect 43, further comprising: responsive to a second link quality of the second wireless communication link falling below a second threshold, receiving, from the first wireless communication device via the second wireless communication link and the AP, an indication that the second link quality has dropped below the second threshold; and transmitting, to the first wireless communication device via the AP and the second wireless communication link in response to the indication, scheduling information for the beacon, transmission of the beacon being in accordance with the scheduling information.

Aspect 45: The method of any of aspects 43 through 44, further comprising: responsive to a second link quality of the second wireless communication link falling below a second threshold, receiving, via the second wireless communication link and the AP, a probe request, transmission of the probe response being responsive to the probe request.

Aspect 46: The method of any of aspects 43 through 45, further comprising: responsive to a second link quality of the second wireless communication link falling below a second threshold, and further responsive to a determination that the second wireless communication device is within range of a BT wireless communication link between the first wireless communication device and the second wireless communication device, receiving, from the first wireless communication device and on the BT wireless communication link, a request to connect with the second wireless communication device; and transmitting, to the first wireless communication device on the BT wireless communication link, scheduling information for the beacon, transmission of the beacon being in accordance with the scheduling information.

Aspect 47: The method of any of aspects 43 through 46, further comprising: responsive to a second link quality of the second wireless communication link falling below a second threshold, and further responsive to a determination that the second wireless communication device is within range of a BT wireless communication link between the first wireless communication device and the second wireless communication device, receiving, from the first wireless communication device and on the second wireless communication link, a probe request, transmission of the probe response being responsive to the probe request.

Aspect 48: A method for wireless communications at a first wireless communication device, comprising: responsive to a first link quality of a first wireless communication link between the first wireless communication device and a first AP falling below a threshold while in communication with a second wireless communication device via the first wireless communication link and the first AP, receiving a beacon or a probe response from a second AP on a second wireless communication link; responsive to a second link quality of the second wireless communication link being higher than the first link quality, performing an association procedure with the second AP to receive an IP address for the first wireless communication device for the second wireless communication link; transmitting, in response to the association procedure and to the second wireless communication device, an indication of the IP address via the first wireless communication link and the first AP; transmitting, in response to transmission of the IP address, a disassociation message to the first AP for the first wireless communication link; and responsive to transmission of the disassociation IP message, communicating data with the second wireless communication device via the second wireless communication link, and the second AP.

Aspect 49: The method of aspect 48, wherein receiving the beacon comprises: receiving a set of beacons from a set of APs, the set of APs comprising the second AP and the set of beacons comprising the beacon.

Aspect 50: The method of aspect 49, further comprising: selecting the second AP from the set of APs based on respective link qualities for respective wireless communication links with the set of APs determined using the set of beacons.

Aspect 51: The method of any of aspects 48 through 50, further comprising: responsive to the first link quality of the first wireless communication link falling below the threshold, transmitting a probe request to the second AP, reception of the probe response being responsive to the probe request.

Aspect 52: The method of any of aspects 48 through 51, further comprising: responsive to the first link quality falling below the threshold, receiving a second beacon from the second wireless communication device on a third wireless communication link, receiving the beacon being responsive to a third link quality of a wireless communication link between the first wireless communication device and the second wireless communication device determined using the second beacon being below a third threshold.

Aspect 53: The method of any of aspects 48 through 52, further comprising: performing the association procedure in response to a determination that the second link quality of the second wireless communication link is higher than the first link quality and the third link quality in accordance with a utility function.

Aspect 54: The method of aspect 53, wherein the utility function includes at least one of a channel type for each of the first wireless communication link and the second wireless communication link and a received signal strength indicator value for each of the first wireless communication link and the second wireless communication link.

Aspect 55: The method of any of aspects 48 through 54, further comprising: responsive to the second link quality of the second wireless communication link being higher than the first link quality, transmitting, to a third wireless communication device on a BT wireless communication link between the first wireless communication device and the third wireless communication device, an indication for the third wireless communication device to perform a second association procedure with the second AP.

Aspect 56: A method for wireless communications at a second wireless communication device, comprising: receiving, while in communication with a first wireless communication device via a first AP and a first wireless communication link between the first wireless communication device and the first AP and using a first IP address for the first wireless communication device for the first wireless communication link, an indication of a second IP address for the first wireless communication device for a second wireless communication link between the first wireless communication device and a second AP, the indication of the second IP address being received via the first AP and the first wireless communication link; receiving, from the first wireless device via the first AP and the first wireless communication link, a roaming indication; and responsive to the roaming indication, communicating data with the first wireless communication device via the second wireless communication link and the second AP using the second IP address.

Aspect 57: The method of aspect 56, further comprising: receiving, from the first wireless device via the first AP and the first wireless communication link, an indication of a MAC address for the first wireless communication device for the second wireless communication link, communication of data with the first wireless communication device via the second wireless communication link and the second AP further using the MAC address.

Aspect 58: The method of any of aspects 56 through 57, further comprising: transmitting, to the first wireless device via the first AP and the first wireless communication link, an acknowledgment in response to the roaming indication, communication of data with the first wireless communication device via the second wireless communication link and the second AP being responsive to the acknowledgment.

Aspect 59: The method of any of aspects 56 through 58, further comprising: adjusting at least one of an audio latency or an audio bit rate in response to the roaming indication, communication of data with the first wireless communication device via the second wireless communication link and the second AP using the adjusted audio latency or the adjusted audio bit rate.

Aspect 60: A first wireless communication device, comprising a processing system that includes one or more processors and one or more memories coupled with the one or more processors, the processing system configured to cause the first wireless communication device to perform a method of any of aspects 1 through 14.

Aspect 61: An apparatus for wireless communications at a first wireless communication device, comprising at least one means for performing a method of any of aspects 1 through 14.

Aspect 62: A non-transitory computer-readable medium storing code for wireless communications at a first wireless communication device, the code comprising instructions executable by a processor to perform a method of any of aspects 1 through 14.

Aspect 63: A second wireless communication device, comprising a processing system that includes one or more processors and one or more memories coupled with the one or more processors, the processing system configured to cause the second wireless communication device to perform a method of any of aspects 15 through 21.

Aspect 64: An apparatus for wireless communications at a second wireless communication device, comprising at least one means for performing a method of any of aspects 15 through 21.

Aspect 65: A non-transitory computer-readable medium storing code for wireless communications at a second wireless communication device, the code comprising instructions executable by a processor to perform a method of any of aspects 15 through 21.

Aspect 66: A first wireless communication device, a processing system that includes one or more processors and one or more memories coupled with the one or more processors, the processing system configured to cause the first wireless communication device to perform a method of any of aspects 22 through 27.

Aspect 67: An apparatus for wireless communications at a first wireless communication device, comprising at least one means for performing a method of any of aspects 22 through 27.

Aspect 68: A non-transitory computer-readable medium storing code for wireless communications at a first wireless communication device, the code comprising instructions executable by a processor to perform a method of any of aspects 22 through 27.

Aspect 69: A second wireless communication device, comprising a processing system that includes one or more processors and one or more memories coupled with the one or more processors, the processing system configured to cause the second wireless communication device to perform a method of any of aspects 28 through 31.

Aspect 70: An apparatus for wireless communications at a second wireless communication device, comprising at least one means for performing a method of any of aspects 28 through 31.

Aspect 71: A non-transitory computer-readable medium storing code for wireless communications at a second wireless communication device, the code comprising instructions executable by a processor to perform a method of any of aspects 28 through 31.

Aspect 72: A first wireless communication device, comprising a processing system that includes one or more processors and one or more memories coupled with the one or more processors, the processing system configured to cause the first wireless communication device to perform a method of any of aspects 32 through 42.

Aspect 73: An apparatus for wireless communications at a first wireless communication device, comprising at least one means for performing a method of any of aspects 32 through 42.

Aspect 74: A non-transitory computer-readable medium storing code for wireless communications at a first wireless communication device, the code comprising instructions executable by a processor to perform a method of any of aspects 32 through 42.

Aspect 75: A second wireless communication device, comprising a processing system that includes one or more processors and one or more memories coupled with the one or more processors, the processing system configured to cause the second wireless communication device to perform a method of any of aspects 43 through 47.

Aspect 76: An apparatus for wireless communications at a second wireless communication device, comprising at least one means for performing a method of any of aspects 43 through 47.

Aspect 77: A non-transitory computer-readable medium storing code for wireless communications at a second wireless communication device, the code comprising instructions executable by a processor to perform a method of any of aspects 43 through 47.

Aspect 78: A first wireless communication device, comprising a processing system that includes one or more processors and one or more memories coupled with the one or more processors, the processing system configured to cause the first wireless communication device to perform a method of any of aspects 48 through 55.

Aspect 79: An apparatus for wireless communications at a first wireless communication device, comprising at least one means for performing a method of any of aspects 48 through 55.

Aspect 80: A non-transitory computer-readable medium storing code for wireless communications at a first wireless communication device, the code comprising instructions executable by a processor to perform a method of any of aspects 48 through 55.

Aspect 81: A second wireless communication device, comprising a processing system that includes one or more processors and one or more memories coupled with the one or more processors, the processing system configured to cause the second wireless communication device to perform a method of any of aspects 56 through 59.

Aspect 82: An apparatus for wireless communications at a second wireless communication device, comprising at least one means for performing a method of any of aspects 56 through 59.

Aspect 83: A non-transitory computer-readable medium storing code for wireless communications at a second wireless communication device, the code comprising instructions executable by a processor to perform a method of any of aspects 56 through 59.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
processing system that includes one or more processors and one or more memories coupled with the one or more processors, the processing system configured to cause the first wireless communication device to:
receive, while in communication with a second wireless communication device on a peer to peer wireless communication link and from an access point associated with the second wireless communication device, an internet protocol address for the first wireless communication device for a second wireless communication link between the first wireless communication device and the access point;
responsive to a first link quality of the peer to peer wireless communication link falling below a first threshold, communicate a roaming indication with the second wireless communication device on the peer to peer wireless communication link; and
responsive to the roaming indication, communicate data with the second wireless communication device via the second wireless communication link and the access point.

2. The first wireless communication device of claim 1, wherein the processing system is further configured to cause the first wireless communication device to:
responsive to the first link quality dropping below a second threshold, perform an association procedure with the access point to receive the internet protocol address.

3. The first wireless communication device of claim 2, wherein the processing system is further configured to cause the first wireless communication device to:
receive, from the second wireless communication device on the peer to peer wireless communication link, a message indicating that the first link quality dropped below the second threshold.

4. The first wireless communication device of claim 3, wherein the processing system is further configured to cause the first wireless communication device to:
receive, with the message, an indication of a serving access point for the second wireless communication device.

5. The first wireless communication device of claim 2, wherein the processing system is further configured to cause the first wireless communication device to:
responsive to the first link quality dropping below the second threshold, transmit to the second wireless communication device on the peer to peer wireless communication link, a request for channel scan results associated with the second wireless communication link;
receive, from the second wireless communication device on the peer to peer wireless communication link in response to the request, a channel scan result associated with the second wireless communication link; and
responsive to the channel scan result indicating a second link quality of the second wireless communication link satisfies a third threshold, perform the association procedure with the access point to receive the internet protocol address.

6. The first wireless communication device of claim 5, wherein the processing system is further configured to cause the first wireless communication device to:
receive, from the second wireless communication device on the peer to peer wireless communication link in response to the request, a set of channel scan results for a set of wireless communication links corresponding to a set of access points, the set of access points including the access point; and
select the access point from the set of access points in response to the set of channel scan results.

7. The first wireless communication device of claim 2, wherein the processing system is further configured to cause the first wireless communication device to:
responsive to the first link quality dropping below the second threshold, receive a beacon from the access point on the second wireless communication link;
determine a second link quality of the second wireless communication link using the beacon; and
responsive to the second link quality satisfying a third threshold, perform the association procedure with the access point to receive the internet protocol address.

8. The first wireless communication device of claim 2, wherein the processing system is further configured to cause the first wireless communication device to:
responsive to the first link quality dropping below the second threshold, transmit a probe request to the access point;
responsive to the probe request, receive, from the access point, a probe response;
determine a second link quality of the second wireless communication link using the probe response; and
responsive to the second link quality satisfy a third threshold, perform the association procedure with the access point to receive the internet protocol address.

9. The first wireless communication device of claim 2, wherein the processing system is further configured to cause the first wireless communication device to:
transmit an indication of the internet protocol address or a medium access control address of the first wireless communication device to the second wireless communication device on the peer to peer wireless communication link.

10. The first wireless communication device of claim 2, wherein the processing system is further configured to cause the first wireless communication device to:
responsive to the first link quality dropping below the second threshold, transmit, to a third wireless communication device on a Bluetooth wireless communication link between the first wireless communication device and the third wireless communication device, an indication of the access point.

11. The first wireless communication device of claim 1, wherein the processing system is further configured to cause the first wireless communication device to:
communicate, with the second wireless communication device on the peer to peer wireless communication link, a disassociation message in response to the roaming indication.

12. The first wireless communication device of claim 1, wherein the processing system is further configured to cause the first wireless communication device to:
determine, in accordance with a utility function, that a second link quality of the second wireless communication link is better than the first link quality; and
perform an association procedure with the access point to receive the internet protocol address in response to the determination that the second link quality is better than the first link quality.

13. The first wireless communication device of claim 12, wherein the utility function includes at least one of a channel type for each of the peer to peer wireless communication link and the second wireless communication link, a received signal strength indicator value for each of the peer to peer wireless communication link and the second wireless communication link, and a bias factor for the peer to peer wireless communication link.

14. The first wireless communication device of claim 12 wherein the processing system is further configured to cause the first wireless communication device to:
switch a channel of the peer to peer wireless communication link to a same channel as the second wireless communication link in response to the association procedure.

15. A second wireless communication device, comprising:
a processing system that includes one or more processors and one or more memories coupled with the one or more processors, the processing system configured to cause the second wireless communication device to:
receive, while in communication with a first wireless communication device on a peer to peer wireless communication link, and while in communication with an access point on a third wireless communication link, an internet protocol address from the first wireless communication device for the first wireless communication device for a second wireless communication link between the first wireless communication device and the access point;
responsive to a first link quality of the peer to peer wireless communication link between the first wireless communication device and the second wireless communication device falling below a first threshold, communicate a roaming indication with the first wireless communication device on the peer to peer wireless communication link; and
responsive to the roaming indication, communicate data with the first wireless communication device via the third wireless communication link and the access point using the internet protocol address for the first wireless communication device.

16. The second wireless communication device of claim 15, wherein the processing system is further configured to cause the second wireless communication device to:
transmit, to the first wireless communication device on the peer to peer wireless communication link, a message indicating that the first link quality dropped below a second threshold, reception of the internet protocol address being responsive to the message.

17. The second wireless communication device of claim 16, wherein the processing system is further configured to cause the second wireless communication device to:
transmit, with the message, an indication of a serving access point for the second wireless communication device.

18. The second wireless communication device of claim 15, wherein the processing system is further configured to cause the second wireless communication device to:
responsive to the first link quality dropping below a second threshold, receive, from the first wireless communication device on the peer to peer wireless communication link, a request for channel scan results associated with the second wireless communication link; and
transmit, to the first wireless communication device on the peer to peer wireless communication link link in response to the request, a channel scan result associated with the second wireless communication link, reception of the internet protocol address being responsive to the channel scan result indicating a second link quality of the second wireless communication link satisfies a third threshold.

19. The second wireless communication device of claim 18, wherein the processing system is further configured to cause the second wireless communication device to:
transmit, to the first wireless communication device on the peer to peer wireless communication link in response to the request, a set of channel scan results for a set of wireless communication links corresponding to a set of access points, the set of access points including the access point.

20. The second wireless communication device of claim 15, wherein the processing system is further configured to cause the second wireless communication device to:
communicate, with the first wireless communication device on the peer to peer wireless communication link, a disassociation message in response to the roaming indication.

21. The second wireless communication device of claim 15, wherein the processing system is further configured to cause the second wireless communication device to:
switch a channel of the peer to peer wireless communication link to a same channel as the second wireless communication link in response reception of the internet protocol address.

22. A method for wireless communications at a first wireless communication device, comprising:
receiving, while in communication with a second wireless communication device on a peer to peer wireless communication link and from an access point associated with the second wireless communication device, an internet protocol address for the first wireless communication device for a second wireless communication link between the first wireless communication device and the access point;
responsive to a first link quality of the peer to peer wireless communication link falling below a first threshold, communicating a roaming indication with the second wireless communication device on the peer to peer wireless communication link; and
responsive to the roaming indication, communicating data with the second wireless communication device via the second wireless communication link, and the access point.

23. The method of claim 22, further comprising:
responsive to the first link quality dropping below a second threshold, performing an association procedure with the access point to receive the internet protocol address.

24. The method of claim 23, further comprising:
receiving, from the second wireless communication device on the peer to peer wireless communication link, a message indicating that the first link quality dropped below the second threshold.

25. The method of claim 24, further comprising:
receiving, with the message, an indication of a serving access point for the second wireless communication device.

26. The method of claim 23, further comprising:
responsive to the first link quality dropping below the second threshold, transmitting, to the second wireless communication device on the peer to peer wireless communication link, a request for channel scan results associated with the second wireless communication link;
receiving, from the second wireless communication device on the peer to peer wireless communication link in response to the request, a channel scan result associated with the second wireless communication link; and
responsive to the channel scan result indicating a second link quality of the second wireless communication link satisfies a third threshold, performing the association procedure with the access point to receive the internet protocol address.

27. The method of claim 26, further comprising:
receiving, from the second wireless communication device on the peer to peer wireless communication link in response to the request, a set of channel scan results for a set of wireless communication links corresponding to a set of access points, the set of access points including the access point; and
selecting the access point from the set of access points in response to the set of channel scan results.

28. The method of claim 23, further comprising:
responsive to the first link quality dropping below the second threshold, receiving a beacon from the access point on the second wireless communication link;
determining a second link quality of the second wireless communication link using the beacon; and
responsive to the second link quality satisfying a third threshold, performing the association procedure with the access point to receive the internet protocol address.

29. The method of claim 23, further comprising:
responsive to the first link quality dropping below the second threshold, transmitting a probe request to the access point;
responsive to the probe request, receiving, from the access point, a probe response;
determining a second link quality of the second wireless communication link using the probe response; and
responsive to the second link quality satisfying a third threshold, performing the association procedure with the access point to receive the internet protocol address.

30. The method of claim 23, further comprising:
transmitting an indication of the internet protocol address or a medium access control address of the first wireless communication device to the second wireless communication device on the peer to peer wireless communication link.

31. The method of claim 23, further comprising:
responsive to the first link quality dropping below the second threshold, transmitting, to a third wireless communication device on a Bluetooth wireless communication link between the first wireless communication device and the third wireless communication device, an indication of the access point.

32. The method of claim 22, further comprising:
communicating, with the second wireless communication device on the peer to peer wireless communication link, a disassociation message in response to the roaming indication.

33. The method of claim 22, further comprising:
determining, in accordance with a utility function, that a second link quality of the second wireless communication link is better than the first link quality; and
performing an association procedure with the access point to receive the internet protocol address in response to the determination that the second link quality is better than the first link quality.

34. The method of claim 33, wherein the utility function includes at least one of a channel type for each of the peer to peer wireless communication link and the second wireless communication link, a received signal strength indicator value for each of the peer to peer wireless communication link and the second wireless communication link, and a bias factor for the peer to peer wireless communication link.

35. The method of claim 33, further comprising:
switching a channel of the peer to peer wireless communication link to a same channel as the second wireless communication link in response to the association procedure.

36. A method for wireless communications at a second wireless communication device, comprising:
receiving, while in communication with a first wireless communication device on a peer to peer wireless communication link, and while in communication with an access point on a third wireless communication link, an internet protocol address from the first wireless communications device for the first wireless communication device for a second wireless communication link between the first wireless communication device and the access point;
responsive to a first link quality of the peer to peer wireless communication link between the first wireless communication device and the second wireless communication device falling below a first threshold, communicating a roaming indication with the first wireless communication device on the peer to peer wireless communication link; and
responsive to the roaming indication, communicating data with the first wireless communication device via the third wireless communication link and the access point using the internet protocol address for the first wireless communication device.

37. The method of claim 36, further comprising:
transmitting, to the first wireless communication device on the peer to peer wireless communication link, a message indicating that the first link quality dropped below a second threshold, reception of the internet protocol address being responsive to the message.

38. The method of claim 37, further comprising:
transmitting, with the message, an indication of a serving access point for the second wireless communication device.

39. The method of claim 36, further comprising:
responsive to the first link quality dropping below a second threshold, receiving, from the first wireless communication device on the peer to peer wireless communication link, a request for channel scan results associated with the second wireless communication link; and
transmitting, to the first wireless communication device on the second wireless communication link in response to the request, a channel scan result associated with the second wireless communication link, reception of the internet protocol address being responsive to the channel scan result indicating a second link quality of the second wireless communication link satisfies a third threshold.

40. The method of claim 39, further comprising:
transmitting, to the first wireless communication device on the peer to peer wireless communication link in response to the request, a set of channel scan results for a set of wireless communication links corresponding to a set of access points, the set of access points including the access point.

41. The method of claim 36, further comprising:
communicating, with the first wireless communication device on the peer to peer wireless communication link, a disassociation message in response to the roaming indication.

42. The method of claim 36, further comprising:
switching a channel of the peer to peer wireless communication link to a same channel as the second wireless communication link in response reception of the internet protocol address.
